(19) United States
(12) Patent Application Publication
(10) Pub. No.: US 2003/0033205 A1
(43) Pub. Date: Feb. 13, 2003

(54) Method and system for facilitating fulfillment of electronic commercial transactions

(76) Inventors: D.K. Nowers, Toronto (CA); David F. Masotti, Etobicoke (CA); Earl S. Lipson, Toronto (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/756,742

(22) Filed: Jan. 10, 2001

Related U.S. Application Data
(60) Provisional application No. 60/175,239, filed on Jan. 10, 2000.
(60) Provisional application No. 60/181,323, filed on Feb. 9, 2000.

(51) Int. Cl. G06F 17/60

(52) U.S. Cl. 705/26

(57) ABSTRACT

A method of fulfilling on-line sale of products through at least one electronic storefront comprises establishing an inventory of products at a single physical location that are offered for sale through an electronic storefront of at least one Internet retailer. The inventory includes products received from a plurality of different vendors. Products from the inventory that are ordered by a customer through an electronic storefront are assembled at the physical location and are shipped to the customer to fulfill the order.

### FIELD OF THE INVENTION

The present invention relates generally to electronic commerce and in particular to a computerized method and system for facilitating fulfillment of electronic commercial transactions and to a method and system for electronic commerce between branded vendors and Internet retailers to enable branded vendors to setup, monitor and manage principal/agent relationships with multiple Internet retailers.

### BACKGROUND OF THE INVENTION

Electronic commerce on the Internet has allowed product and service providers to reach consumers over a vast geographical expanse via electronic storefronts without the “bricks and mortar” of traditional retailers. Different electronic storefronts have been considered to take advantage of this distribution channel. For example, new entrants to the retail world such as Amazon.com and Shopping.com have used the Internet to distribute products and services directly to consumers to bypass traditional retailers and take advantage of a lower cost infrastructure. Existing retailers such as Wal-Mart use electronic storefronts to supplement existing retail channels and leverage brand names. Catalogers and direct marketers, such as LLBean, use electronic storefronts to provide on-line versions of their catalogs.

Theoretically, electronic storefronts provide Internet retailers with unlimited flexibility in product and service selection, pricing, and product and service presentation. However, the lack of sophisticated fulfillment and electronic merchandising systems, makes it difficult for Internet retailers to provide a compelling value proposition to customers. In many cases, the value of products or services being purchased by on-line customers is not large enough to justify the shipping and handling costs or to attract the attention of Internet browsers.

In other cases, product fulfillment is too large a logistical challenge to overcome. Most Internet retailers have no experience in fulfillment and find the task difficult and expensive. It has been reported that the distribution costs associated with running an electronic storefront can amount to approximately 15% of total sales. To deal with fulfillment, some Internet retailers have outsourced their fulfillment requirements to third party shippers who rely on manual, unsophisticated systems to satisfy product fulfillment. Often, the end result is delayed, incorrect and/or incomplete shipments to online customers.

Some Internet retailers have completely avoided fulfillment problems by employing direct vendor shipping of products to customers. Unfortunately, this method of delivering product to on-line customers is inefficient and expensive to customers. It discourages customers from purchasing large quantities of products since customers typically receive multiple packages from multiple vendors requiring the customers to pay multiple shipping fees. In addition, customer confusion may result due to the fact that customers receive packages from the product vendor and not from the Internet retailer with whom the orders were placed. Direct vendor shipping also places a burden on vendors who typically struggle to fulfill smaller direct-to-customer orders. Most vendors have fulfillment and distribution capabilities built around the requirements of traditional retail channels and are therefore, designed to process orders for large quantities of items. These capabilities are often not equipped to handle the challenges of fulfilling electronic storefront orders, which are typically for small quantities of items. As a result, vendors are forced to use unsophisticated manual processes to fulfill electronic storefront orders.

Although catalogers and marketers have more experience dealing with fulfilling small orders received from a large number of customers, they typically offer only a limited range of products. Also, their fulfillment systems are unable to handle the complexities of quick response product fulfillment that is required to manage on-line shopping effectively.

Vendors of branded products (“branded vendors”) such as for example, Polo Ralph Lauren, Clinique etc., and retailers have a long history of conducting commerce through a wholesaler/retailer relationship. Through this relationship, branded vendors have built their brands by advertising to end customers, but have primarily generated revenue by acting as a wholesaler to retailers. Retailers have acted as aggregators of goods, and by offering many products for sale, have been able to justify investment in “bricks and mortar” to establish themselves as the primary distribution channel for almost all branded vendors.

The wholesaler/retailer relationship has been significantly influenced by antitrust and competition laws. These laws have established basic rules regarding the ability of a vendor to influence the practices of its retailers. These rules stipulate that a vendor cannot bind or control a retailer in several important ways. For example, a vendor cannot prevent a retailer from pricing the vendor's goods as the retailer chooses. The vendor also cannot prevent a retailer from promoting the vendor's goods as the retailer chooses and/or prevent the retailer from bundling the vendor's goods with other products, as seen fit by the retailer.

For reasons most likely not considered at the time these laws were passed, the laws have created an important and serious problem for vendors of quality brands. Vendors of quality brands spend significant time and money establishing the image of their brands. The manner in which their products are sold by retailers is critical to the image of the brands, yet it is something over which the vendors have limited control. After spending millions of dollars to establish the image of a brand as ‘high end’, ‘luxurious’ and ‘premium,’ a vendor can find its product heavily promoted and sold at deep discounts by its retailers. This is very damaging to the quality of a brand's reputation, and is commonly referred to as price erosion. Price erosion is particularly problematic for a vendor, because once a product has been discounted in the retail marketplace, customers will forever seek to purchase the product at a discount. This makes it virtually impossible for a vendor to re-establish the product as a quality brand, and makes high end retailers (that must command high margins to pay for expensive retail operations) uninterested in selling the product.

The mistreatment of a quality brand by a retailer has a variety of unfortunate consequences for a vendor. In addition to devaluing the brand in the view of the consumer, discounting and other promotional practices by one retailer can cause channel conflict. Channel conflict occurs when one retailer sells a product at a discount relative to other retailers who offer the same product for sale and can damage the reputation of the retailer that finds itself selling a product at a premium relative to other retailers. Channel conflict also occurs if a ‘high-end’ retailer, such as Harrods and Saks Fifth Avenue, carries a product at the same time as a discount retailer, such as Wal-Mart. Typically, the discount retailer seeks to offer its customers the lowest possible prices, and drive the highest possible sales volumes, by discounting its vendors' products. If a high-end retailer carries a product that is also carried by a discount retailer, the high-end retailer will find itself offering the same product at a considerable premium to the discount retailer. To avoid the resulting embarrassment and customer frustration, the high-end retailer often will simply drop the product immediately. Thus, the consequence of channel conflict is that the product is dropped by high-end retailers, tarnishing the brand image and reducing the sales potential for the branded vendor.

Channel conflict and price erosion are particularly serious problems for branded vendors seeking to sell their products over the Internet. Because Internet retailers have lower cost infrastructures relative to “bricks and mortar” retailers, their opportunity to discount goods is significant. Although branded vendors are interested in taking advantage of the opportunity to sell on-line, they are unwilling to take the risk that Internet retailers will discount goods and undertake other promotional practices, which would undermine the vendor's brand image, cause price erosion, and create channel conflicts with existing “bricks and mortar” retailers. Branded vendors fear that a single sale through an Internet retailer could result in channel conflicts with all of their existing “bricks and mortar” retailers, and endanger the brand equity in their businesses.

In response to this concern, some branded vendors have established their own proprietary electronic storefronts allowing customers to purchase products directly. While these electronic storefronts allow branded vendors to sell products over the Internet without exposure to the risk of channel conflict, price erosion, and other damaging promotional practices, these electronic storefronts offer limited value. Because proprietary electronic storefronts do not offer a broad product assortment, nor allow a customer to receive products from other vendors, these electronic storefronts have trouble attracting customers. To generate growth in on-line sales, branded vendors recognize that they must sell through Internet retailers or Internet community sites; however, without a solution to the channel conflict and price erosion issues, this is problematic. This situation has prevented many strong branded products from being sold over the Internet, and has limited sales of branded products that have been made available over the Internet.

In addition to the problems faced by branded vendors, Internet retailers also suffer as a result of the above-described aversion of branded vendors making their products available for sale on-line. The single most important issue faced by Internet retailers is brand access. As a result of the problems described above, Internet retailers do not have access to highly desirable branded products that are carried by their “bricks and mortar” competition, because branded vendors are reluctant to make their branded products available to Internet retailers. Without access to branded products, Internet retailers continue to be discount stores for niche products, rather than powerhouse retailers. Gaining access to branded products is therefore a top priority for Internet retailers.

The second issue faced by Internet retailers is inventory risk. Internet retailers are well aware of the cost and risk associated with buying inventory as a way of entering the electronic commerce business. Although the capital carrying cost of purchasing inventory is a problem, the largest problem relates to the seasonality of branded products. Large investments in branded products can be written off when stocks of inventory go out of fashion. It ordinarily takes a “bricks and mortar” retailer years of experience before it can predict demand accurately enough to manage inventory risk. Given the unpredictable nature of demand, the task of inventory management for an Internet retailer is almost impossible. For this reason, Internet retailers seek ways to generate electronic commerce revenues without exposure to inventory risk.

Alternatives to buying inventory exist for Internet retailers, but these alternatives have their own problems. One of the primary alternatives used by Internet retailers is the establishing of an ‘affiliate relationship’ with a branded vendor. In an affiliate relationship, an Internet retailer places a web page control such as a hyperlink on its electronic storefront that is linked to a branded vendor's proprietary electronic storefront. If a customer uses the web page control to travel to the branded vendor's electronic storefront, and makes a purchase on the vendor's electronic storefront, the branded vendor typically pays the Internet retailer a commission. This affiliate relationship effectively allows the Internet retailer to earn electronic commerce revenue without carrying inventory.

The affiliate relationship additionally solves certain problems for the branded vendor. Using the affiliate relationship, a branded vendor can set up its proprietary electronic storefront, and gain access to the customers of third parties. In the affiliate relationship, since the sale is directly between the customer and the branded vendor, the affiliate relationship gives the branded vendor complete control over the retail sales transaction, which includes the ability to manage its brand and avoid price erosion. Effectively, then, the affiliate relationship provides the branded vendor with the brand control it requires, making vendors interested and willing to sell their products through Internet retailers.

At first, the affiliate relationship would seem to solve many of the problems faced by Internet retailers and branded vendors. However, the affiliate relationship has three significant limitations. In particular, with the affiliate relationship, the customer purchases products through the branded vendor's electronic storefront, rather than through the Internet retailer's electronic storefront. Depending on the specific structure of the affiliate relationship, the customer may be moved directly to the branded vendor's electronic storefront to complete the purchase, or may stay on the Internet retailer's electronic storefront and have its purchase processed by the branded vendor's electronic storefront. In cases where the customer is moved to the branded vendor's electronic storefront to complete the purchase, the Internet retailer loses the customer from its electronic storefront, and does not secure any data on the transaction. The end result is that often repeat business goes directly to the branded vendor. Also since the Internet retailers does not secure any transaction data, the Internet retailer loses the ability to track and contact customers.

In cases where the customer stays on the Internet retailer's electronic storefront and has its purchase processed by the branded vendor's electronic storefront, the Internet retailer still does not secure any data on the transaction. As a result, the Internet retailer loses the ability to track and contact customers.

Also, while the Internet retailer's electronic storefront might have web page controls linked to many branded vendor's electronic storefronts, the customer cannot, in one transaction, purchase products from more than one branded vendor. If the customer wishes to purchase products that are ‘resident’ with different branded vendors' electronic storefronts, the customer must conduct separate transactions. In addition, if the customer purchases products through more than one branded vendor's electronic storefront, the customer receives parcels from each of those branded vendors, and incurs either through a direct charge, or through higher product prices, increased parcel delivery costs. As will be appreciated when a customer is buying goods from many different branded vendors, this can become a serious problem.

Customers are primarily interested in receiving products as cheaply and conveniently as possible. This means, effectively, that the customer wants to be able to buy the desired branded products, and receive a variety of branded products in a single package. As discussed above, many branded vendors have established their own electronic storefronts, but do not allow their goods to be sold through third party electronic storefronts. As a result, customers are typically only able to buy and receive branded products from a single branded vendor in a single package.

As will be appreciated, improvements in electronic commerce are of course desired. It is therefore an object of the present invention to provide a novel computerized method and system for facilitating fulfillment of electronic commercial transactions. It is also an object of the present invention to provide a novel method and system for electronic commerce between branded vendors and Internet retailers to enable branded vendors to setup, monitor and manage principal/agent relationships with multiple Internet retailers.

### SUMMARY OF THE INVENTION

According to one aspect of the present invention there is provided a method of fulfilling on-line sale of products through at least one electronic storefront comprising the steps of:

establishing an inventory of products at a single physical location that are offered for sale through an electronic storefront of at least one Internet retailer, said inventory including products received from a plurality of different vendors; and

assembling products from said inventory that are ordered by a customer through an electronic storefront and shipping the products of said order to said customer.

According to another aspect of the present invention there is provided a method for facilitating electronic commercial transactions between Internet retailers and vendors, comprising the steps of:

allowing vendors to select Internet retailers permitted to offer for sale products of the vendors and to establish rules of exchange by which selected Internet retailers are permitted to sell products of the vendors; and

monitoring the manner by which the selected Internet retailers sell products of the vendors to on-line customers to ensure compliance with the established rules of exchange and thereby inhibit Internet retailers from selling products in a manner that potentially causes brand erosion and/or channel conflicts with conventional retailers of products of the vendors.

In still yet another aspect of the present invention there is provided a method for electronic commerce between branded vendors and Internet retailers comprising the steps of:

allowing Internet retailers to display products of different vendors for sale through electronic storefronts;

allowing Internet retailers to manage purchases of the products offered for sale by on-line customers on behalf of the vendors; and

communicating the purchases to a pooled repository holding the products of the different vendors to allow the purchases to be fulfilled.

In still yet another aspect of the present invention there is provided a method of managing inventory in a common pooled repository, said inventory including products from a plurality of different vendors, said method comprising the steps of:

establishing minimum and maximum threshold levels for each product held in said common pooled repository;

as product in said repository is shipped to fulfill product orders and as product is received from vendors to replenish inventory, comparing the level of each product with the established threshold levels; and

when a product level falls below the established minimum threshold level, generating an order for more of that product.

In still yet another aspect of the present invention there is provided a system to enable Internet retailers to sell products of different vendors on-line through electronic storefronts comprising:

a facility storing an inventory of products received from a plurality of different vendors; and

an electronic transaction system (ETS) including a global product catalog listing the products in said inventory, said ETS being accessible to said Internet retailers to enable said Internet retailers to view products listed in said global catalog and to select products in said global catalog that said Internet retailers wish to offer for sale, information concerning selected products being downloaded to the Internet retailers for display on their electronic storefronts, said ETS receiving orders for products made through electronic storefronts of said Internet retailers and conveying said orders to said facility to enable said facility to assemble and ship the products in the orders from the inventory thereby to fulfill the orders.

In still yet another aspect of the present invention there is provided an electronic transaction system (ETS) to facilitate interaction between product vendors and Internet retailers wishing to offer products of vendors on-line through electronic storefronts, said ETS comprising:

a global product catalog listing the products of said vendors;

means for enabling Internet retailers to view products listed in said global catalog and to select products in said global catalog that said Internet retailers wish to offer for sale;

means for downloading information concerning selected products to the Internet retailers for display on their electronic storefronts; and

means for receiving orders for products made through the electronic storefronts and conveying said orders to a facility to enable said facility to assemble and ship the products in the orders from the inventory thereby to fulfill the orders.

The fulfillment and electronic transaction system of the present invention provides a new distribution channel for vendors that is simple and easy to use. Vendors need only ship their products directly to a centralized facility. The vendors' products are stored in a common pooled repository on a consignment basis and are posted electronically in the system. As a result, a common pool for multiple vendors' products is created. Each vendor can choose to make any Internet retailer their sales agent. As a sales agent for a vendor, the Internet retailer is permitted to sell the vendor's products upon agreeing to rules of exchange established by the vendor, which determine how the products are to be offered for sale by the Internet retailer. Each vendor can also choose to make any Internet retailer a reseller of its products.

Internet retailers are able to choose from available vendor products posted in the system that they are permitted to sell. A database stores pictures, price lists and other information associated with vendors' products posted in the system to assist Internet retailers in merchandising and matching vendors' products to the buying profiles of their customers.

When an Internet retailer receives an order from a customer for one or more products stored in the common pooled repository, the order is received by the system and processed. During processing, the ordered products are assembled from the common pooled repository and shipped directly to the customer in a single shipment when possible. The financial transaction between the Internet retailer, vendor(s), shipper and other service providers involved in the transaction is also settled efficiently and accurately.

Details of on-line sales are captured by the fulfillment and electronic transaction system providing vendors and Internet retailers with information that allows the generation of detailed sales, inventory, financial and merchandising reports. These reports assist both vendors and Internet retailers in understanding their customers thereby allowing vendors and Internet retailers to react to their customers' needs and improve sales.

On-line customers benefit from purchasing vendor products in this manner because a wide selection of multiple vendors' products are available and due to the fact that orders of products from multiple vendors arrive in a single shipment from the common pooled repository. As a result, the cost of multiple shipments is eliminated. Also, on-line customers benefit since returns only need to be delivered to a single location, namely the common pooled repository.

The present invention empowers branded vendors on the Internet. Branded vendors are able to maintain the integrity of their brand marketing when branded products are sold over the Internet by Internet retailers. This is accomplished through a principal/agent relationship whereby a branded vendor appoints Internet retailers as sales agents who, as part of their agency, agree to sell the vendor's products in compliance with rules of exchange established by that vendor. This of course removes the vendors' fears of brand erosion and channel conflict thereby opening a significant, yet largely untapped retail channel for branded products. Internet retailers also benefit since they remain free from the operational burden and cost of having to maintain and distribute an inventory of goods received from multiple branded vendors, yet are able to offer their customers a wider selection of branded products, than would otherwise be available to them.

### BRIEF DESCRIPTION OF THE DRAWINGS

An embodiment of the present invention will now be described more fully with reference to the accompanying drawings in which:

FIG. 1a is a schematic diagram of a distributed wide area network including a system for facilitating interaction between vendors and Internet retailers in accordance with the present invention;

FIG. 1b is a schematic diagram of an electronic transaction system (ETS) forming part of the system of FIG. 1;

FIG. 2 is a login page presented to Internet retailers and vendors wishing to access the ETS;

FIG. 3a is a home page available to a vendor accessing the ETS;

FIGS. 3b and 3c are search pages available to a vendor accessing the ETS;

FIGS. 4a to 4g are product related pages available to a vendor accessing the ETS;

FIGS. 5a to 5g are inventory related pages available to a vendor accessing the ETS;

FIGS. 6a and 6b are profile related pages available to a vendor accessing the ETS;

FIGS. 6c to 6f are Internet retailer and deal maintenance pages available to a vendor accessing the ETS;

FIGS. 6g to 6l are additional profile related pages available to a vendor accessing the ETS;

FIG. 7a is a home page available to an Internet retailer accessing the ETS;

FIGS. 7b and 7c are search pages available to an Internet retailer accessing the ETS;

FIGS. 7d to 7f are product related pages available to an Internet retailer accessing the ETS;

FIGS. 8a to 8d are catalog related pages available to an Internet retailer accessing the ETS;

FIGS. 9a to 9d are order related pages available to an Internet retailer accessing the ETS;

FIGS. 9e and 9f are customer related pages available to an Internet retailer accessing the ETS;

FIG. 9g is a profile related page available to an Internet retailer accessing the ETS;

FIGS. 10a and 10b are operations related pages available to an Internet retailer accessing the ETS;

FIG. 11 is a flow chart showing the steps performed by the ETS during processing of a customer order;

FIG. 12 is a flow chart showing the steps performed by the ETS when a vendor adds a new product or updates a product available to Internet retailers; and

FIG. 13 is a flow chart showing the steps performed by the ETS when product inventory in the common pooled repository requires replenishing.

### DETAILED DESCRIPTION OF THE PREFERRED EMBODIMENT

The present invention relates to a system operated by a third party to facilitate interaction between on-line Internet retailers/web merchants (collectively referred to as “Internet retailers” herein) and vendors and allow branded vendors to setup, monitor and manage principal/agent relationships with multiple Internet retailers.

Vendors, who have established a relationship with the system operator and are registered in the system, that wish to permit Internet retailers to sell their products over the Internet, ship their products to a facility run by the system operator. Typically, the vendors ship their products to the facility in standard, single SKU containers, although it will be appreciated that vendors can ship products to the facility in any desired quantity. Through the system, the vendors determine the Internet retailers that are permitted to sell the vendors' products and the rules of exchange that govern such sales. This enables vendors to appoint Internet retailers as either sales agents or resellers. The system operator physically stores the products received from all of the vendors in a common pooled repository and lists the products in an inventory database of an electronic transaction system (ETS). In this manner, multiple vendors place an inventory of their products on a consignment basis in a single physical fulfillment center.

The ETS acts as a catalog of vendors' products placed as inventory in the common pooled repository. Internet retailers who have established relationships with the system operator and are registered in the system can view products listed in the inventory database belonging to vendors that have granted sell permission to them. The Internet retailers can select vendors' products in the list that they wish to offer for sale on-line through their electronic storefronts. Graphical representations and product information related to the selected vendors' products is downloaded to the electronic storefronts from the ETS thereby to enable Internet retailers to offer the selected products for sale.

As mentioned above, through the ETS, vendors establish rules of exchange that govern the manner by which their products must be offered for sale by Internet retailers. Thus, the ETS allows branded vendors and Internet retailers to reach agreements concerning the manner by which branded goods are to be sold through electronic storefronts. Electronic commercial transactions between Internet retailers and their customers are received by the ETS allowing the transactions to be checked for compliance with agreed upon rules of exchange. In this manner, brand integrity can be maintained and channel conflicts between on-line Internet retailers and conventional “bricks and mortar” retailers of brand name goods can be avoided.

When an Internet retailer receives an order from a customer for one or more vendor products, the order is received by the ETS and processed. During processing, the ordered vendor products are assembled from the common pooled repository and the order is shipped directly to the customer in a single shipment when possible. The ETS efficiently and accurately compensates the Internet retailer, the vendor(s), the shipper and all other service providers involved in the transaction.

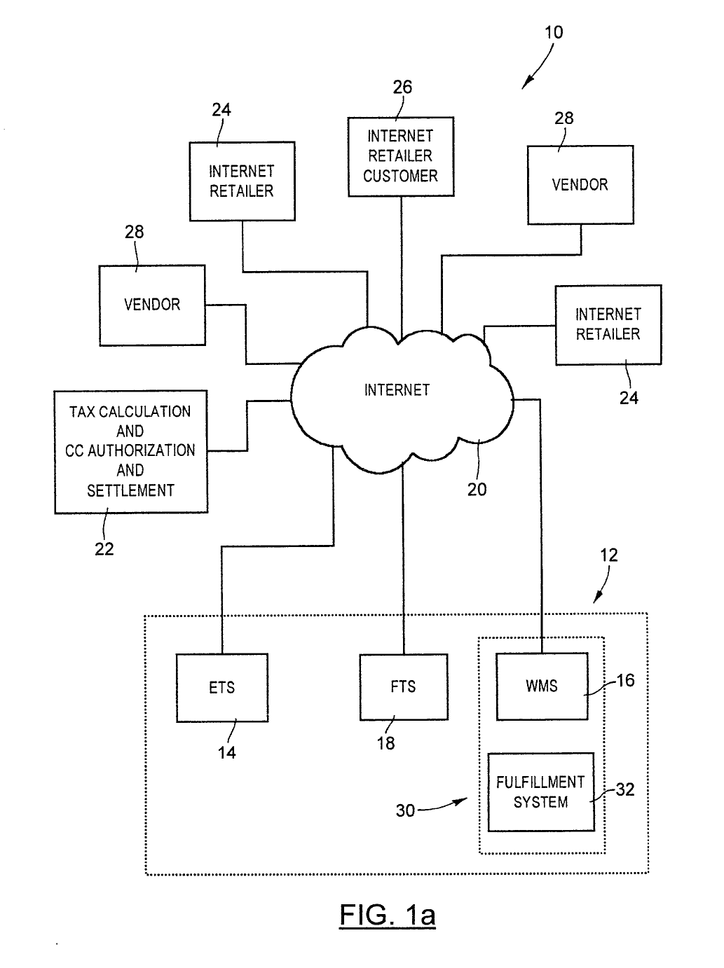

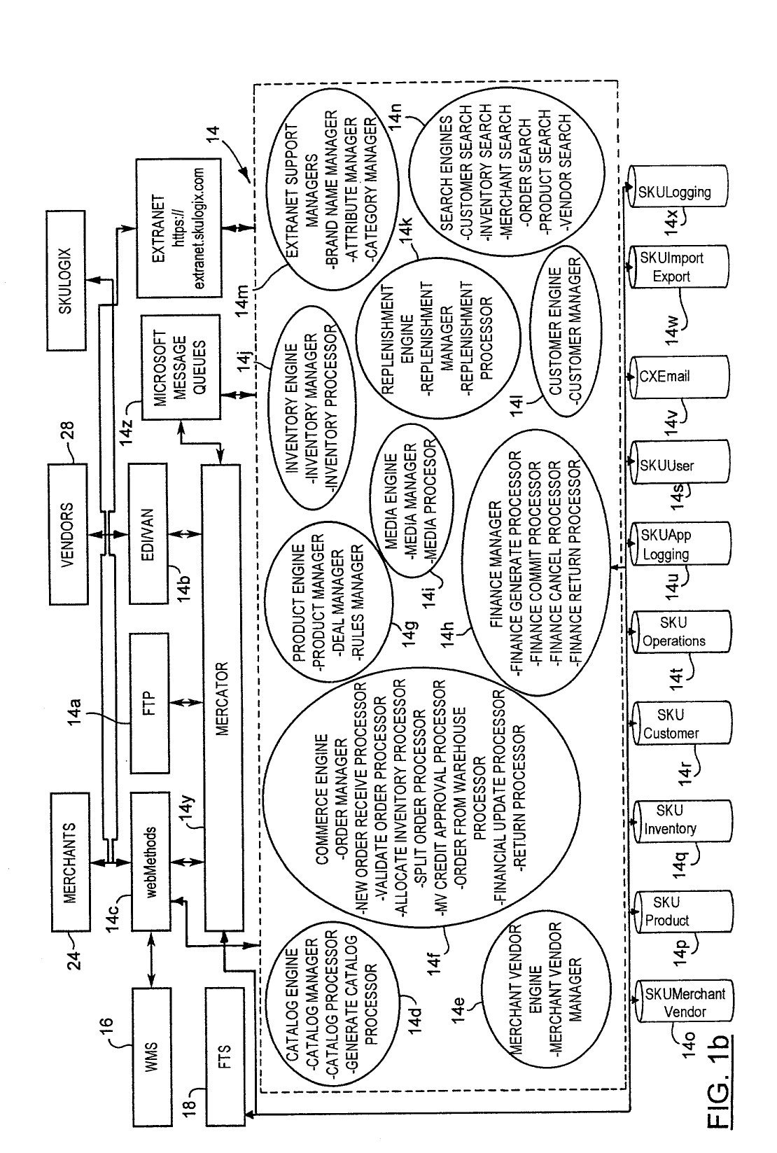

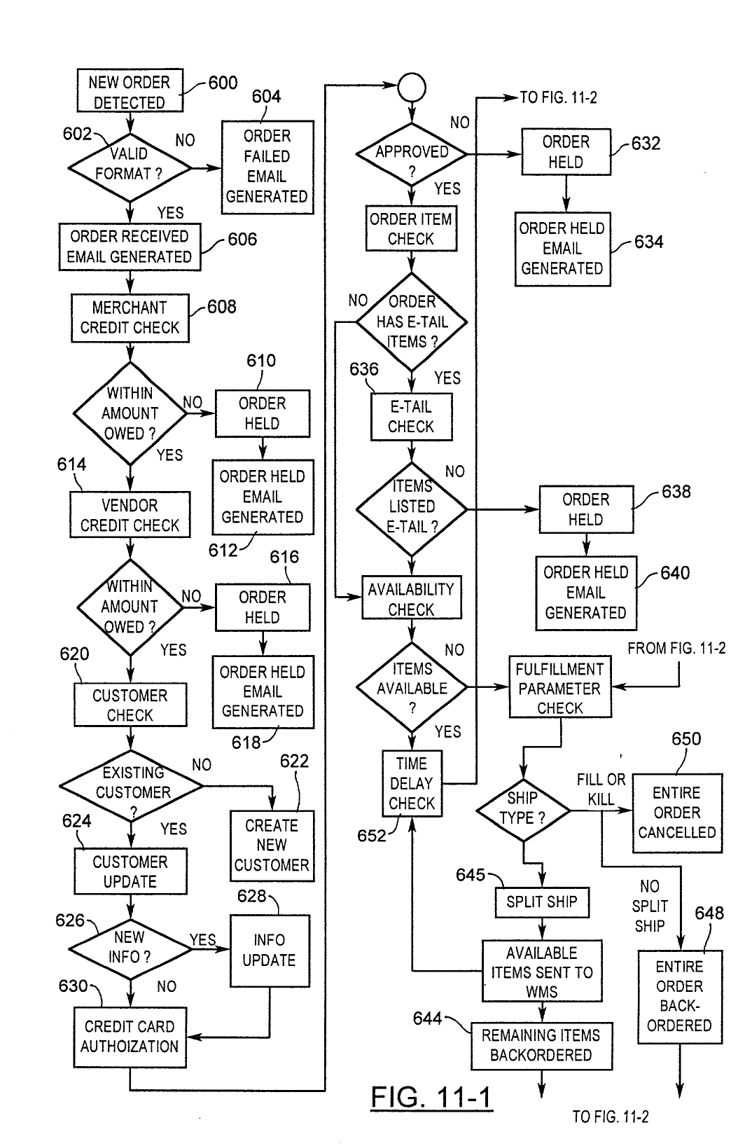

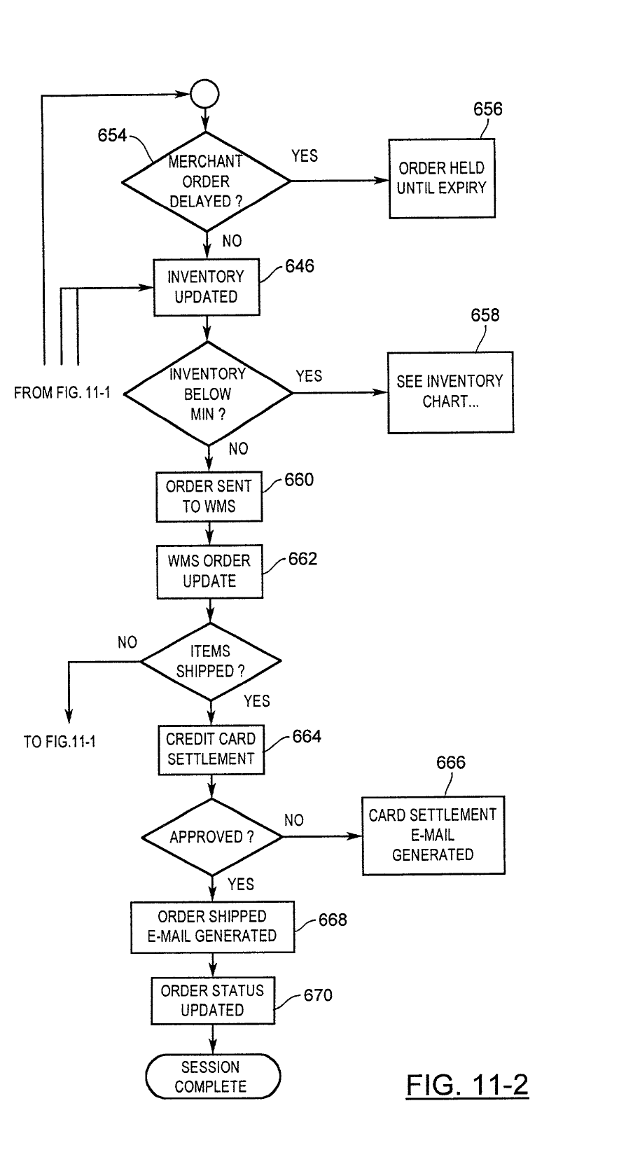

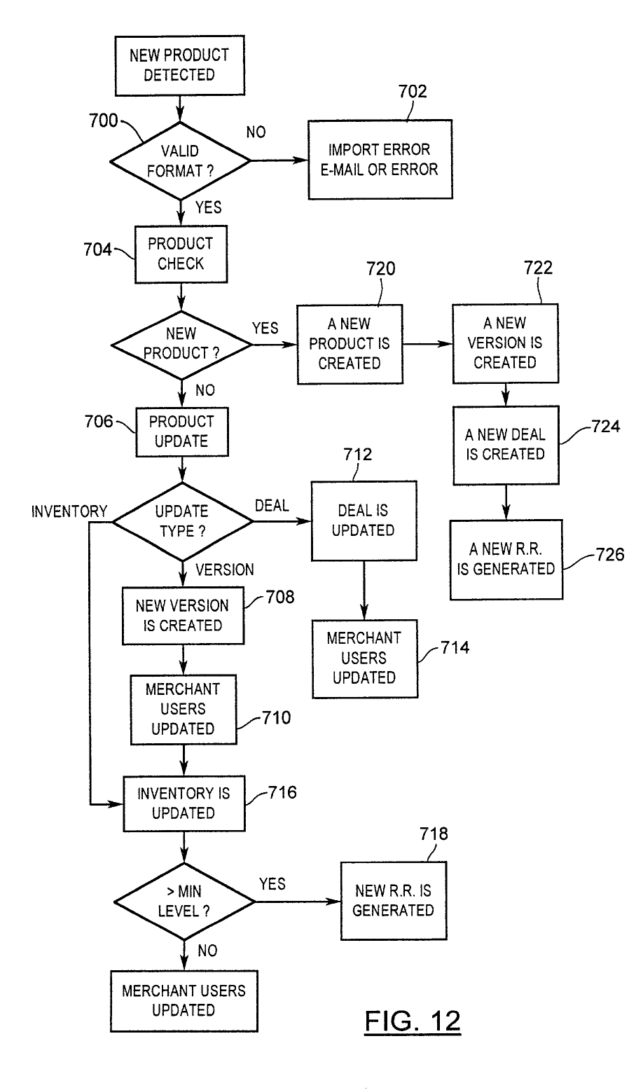

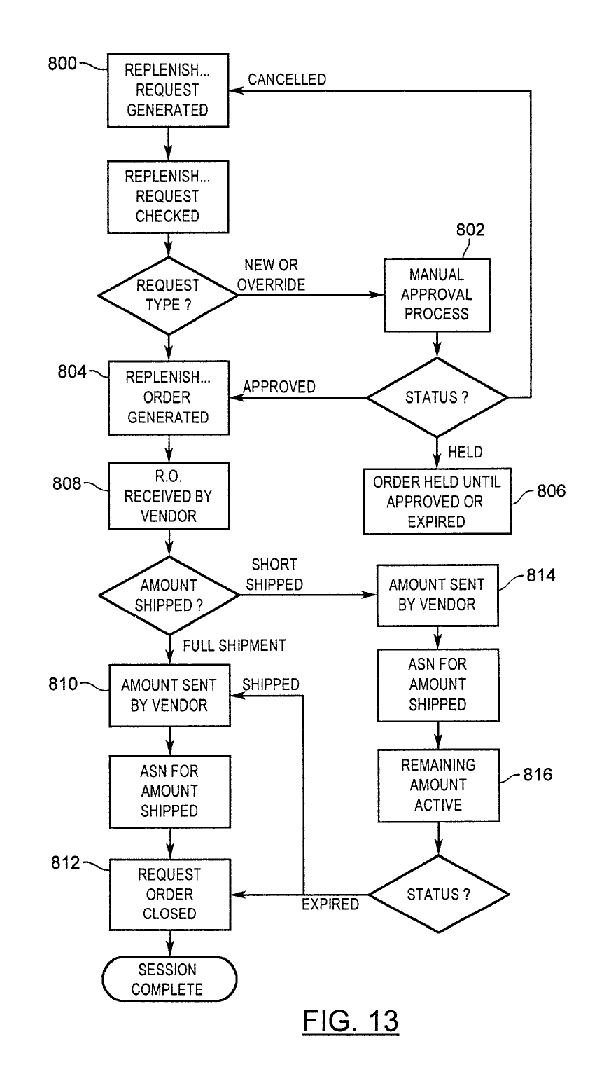

The ETS monitors the inventory in the common pooled repository to ensure reasonable inventory is maintained. Specifically, the ETS determines when the inventory of a vendor product drops below a minimum threshold level and automatically generates and sends a request to the vendor for more of that vendor product. The ETS also determines when the inventory of a vendor product exceeds a maximum threshold level so that appropriate steps can be taken to deal with the excess inventory. Further specifics of the fulfillment and electronic transaction system will now be described more fully with reference to FIGS. 1a to 13.

ETS—Overview

Turning now to FIG. 1a, a distributed wide area network (WAN) is shown and is generally identified by reference numeral 10. A system 12 for facilitating fulfillment of electronic commercial transactions that allows branded vendors to setup, monitor and manage principal/agent relationships with multiple Internet retailers is included in the WAN 10. The system 12 is managed by an operator and includes an electronic transaction system (ETS) 14, a warehouse management system (WMS) 16 and a financial transaction system (FTS) 18.

The ETS 14 communicates with the WMS 16 and the FTS 18 over a communications network such as the Internet 20. As is well known, the Internet provides a backbone of high-speed data communication lines between host computers that route data and messages using the TCP/IP suite of protocols. ETS 14 also communicates with an external tax calculation and credit card authorization/settlement system 22 such as for example CyberSource, and with client computer systems operated by Internet retailers 24, Internet retailer customers 26 and vendors 28 over the Internet 20.

The WMS 16 is associated with a common pooled repository 30 in which products received from vendors 28 are stored. Inventory received by the operator for storage in the common pooled repository is posted to the ETS 14 and stored in an inventory database. A physical fulfillment system 32 located at the common pooled repository 30 facilitates assembly of multiple vendors' products physically stored at the common pooled repository 30 into single shopping baskets to fulfill customer orders received by the ETS 14.

The tax calculation and credit card authorization/settlement system 22 handles financial transactions associated with orders received by the ETS 14. Received orders are not fulfilled until the transactions have been completed and verified. The FTS 18 stores the financial transaction data and is used to generate financial reports.

Turning now to FIG. 1b, the ETS 14 is better illustrated. As can be seen, the ETS 14 includes a file transfer protocol (FTP) server 14a, an electronic data interchange/virtual area network (EDI/VAN) 14b and a webMethods server 14c. The FTP server 14a, EDI/VAN 14b and webMethods server 14c communicate with the client computer systems operated by the Internet retailers 24 and vendors 28. The webMethods server 14c also communicates with the WMS 16 so that orders received by the ETS 14 can be assembled at the common pooled repository 30 and shipped to customers.

The ETS 14 also includes a plurality of server-based application engines 14d to 14n, a plurality of databases 14o to 14x and Mercator graphical tools 14y. The application engines 14d to 14n communicate with message queues 14z that receive messages from the application engines and the FTP, EDI/VAN and webMethod servers 14a to 14c respectively. As is known, the Mercator graphical tools 14y map fields between different applications fields allowing the applications to exchange data.

In the present embodiment, the application engines include a catalog engine 14d, an Internet retailer/vendor engine 14e, a commerce engine 14f, a product engine 14g, a finance engine 14h, a media engine 14i, an inventory engine 14j, a replenishment engine 14k, a customer engine 14l, an extranet support engine 14m and search engines 14n. The databases 14o to 14x include an Internet retailer/vendor database 14o, a product database 14p, an inventory database 14q, an Internet retailer customer database 14r, a user database 14s, and operations, application logging, e-mail, import/export and logging databases 14t to 14x respectively.

During communications between the ETS 14 and client computer systems operated by Internet retailers 24 and vendors 28 over the Internet 20, the ETS 14 sends Hypertext Markup Language (HTML) code to the client computer systems causing their web browsers to display web pages to the users. This enables Internet retailers 24 and vendors 28 to access the ETS 14 through a web-based graphical user interface.

Initially Internet retailers 24 and vendors 28 must register in the system 12. During the registration process, the Internet retailers 24 and 28 provide the operator with particulars concerning their organization so that the information can be entered in the ETS 14 through the Internet retailer/vendor engine 14e and stored in the Internet retailer/vendor database 14o.

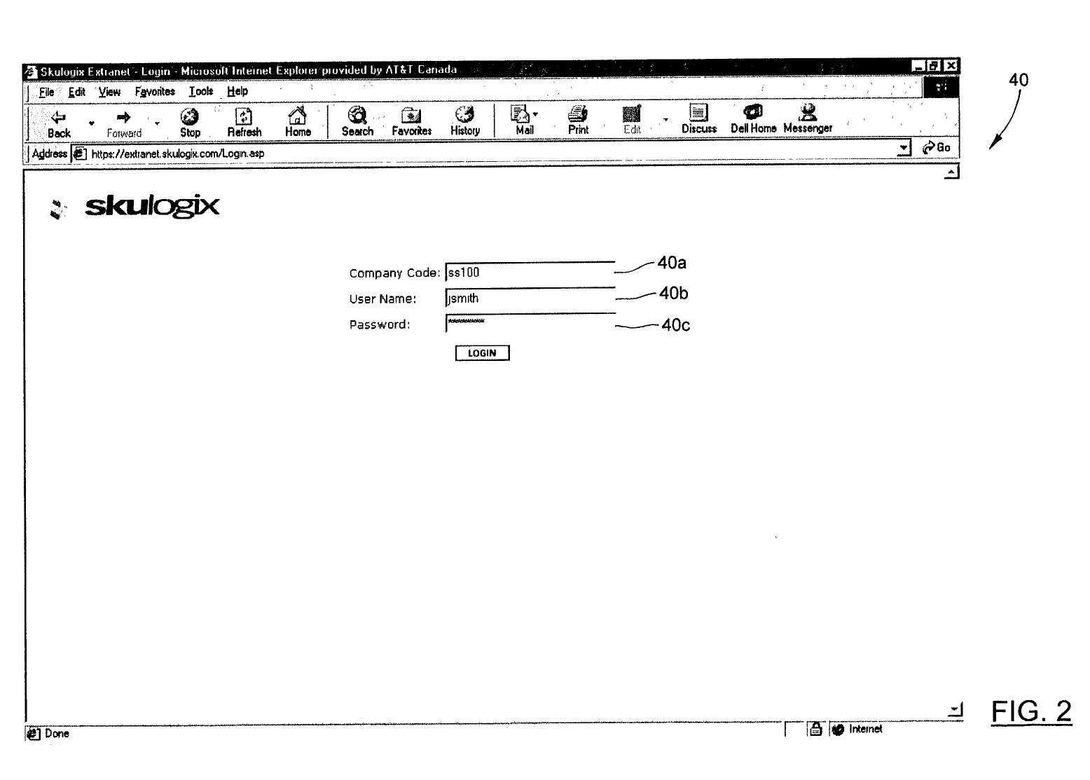

Internet retailers 24 and the vendors 28 that are registered in the system 12 are assigned user identifications (IDs) and passwords. In order to access the ETS 14, an Internet retailer or vendor enters the uniform resource locator (URL) assigned to the ETS into the web browser. This causes the ETS 14 to send a login page to the Internet retailer or vendor as shown in FIG. 2. The login page 40 includes a company code field 40a, a user name field 40b and a password field 40c. Entry of the appropriate information into the fields 40a to 40c and submission of this information to the ETS 14 allows the Internet retailer or vendor to complete the login process giving the Internet retailer or vendor access to the ETS 14.

A vendor 28 wishing to offer products to Internet retailers 22 for sale through their electronic storefront, provides the ETS 14 with product detail information and the quantity and type of the products to be shipped to the operator for storage in the common pooled repository 30 on a consignment basis (i.e. advance shipping details). The product detail information received by the ETS 14 is handled by the product engine 14g and stored in the product database 14p. Specifically, the product engine 14g lists the products in a global product catalog and in a vendor product catalog within the product database 14p. The global product catalog as its name suggests lists all vendors' products stored in the common pooled repository 30. The vendor product catalog lists all of that vendor's products stored in the common pooled repository 30. Thus, a vendor product catalog exists in the product database 14p for each vendor who is registered in the ETS 14 and supplies products to the system operator for storage in the common pooled repository 30. The vendor product catalogs are continuously updated as vendors deliver new products to the common pooled repository 30 and discontinue existing products.

In addition to listing the vendor's products in the global product catalog and associated vendor product catalog, detailed information concerning the vendor's products, on a product level and on a SKU level, is stored in the product database 14p. The detailed information includes but is not limited to product descriptions and images, quantities and pricing policies for the products. Further details of the product information entered into the product database 14p will be described.

Also, as part of vendor's first use of the ETS, the vendor 28 establishes Internet retailers 24 that are permitted to sell the vendor's products. This is achieved by assigning product visibility designations to the vendor's products and, in the case of certain product visibility designations, specifically identifying Internet retailers that are permitted to sell the vendor's products. Further specifics of the product visibility designations will be described.

Minimum and maximum inventory threshold levels for the vendor's products are also established so that appropriate amounts of the vendor's products can be maintained in the common pooled repository 30. When the level of a vendor product in the common pooled repository 30 drops below the minimum threshold, the replenishment engine 14k of the ETS 14 automatically generates an inventory replenishment request (IRR) requesting the vendor to supply more product to raise the inventory level to the maximum threshold level. IRRs generated for each vendor are collected by the replenishment engine 14k to form an inventory replenishment order (IRO). Each IRO is automatically delivered to the appropriate vendor at agreed upon times. The vendor 28 can send a request to the ETS 14 asking the operator to take more inventory if no IRO has been generated by the ETS 14. IRRs and IROs generated by the replenishment engine 14k are also stored in the inventory database 14q.

When the vendor's products are received at the common pooled repository 30, the shipment details are entered into the WMS 16 by the system operator. The shipment details are then conveyed to the ETS 14 so that the actual quantity and type of products received can be compared with the advance shipping details. The inventory engine 14j in turn reconciles this information and updates the inventory database 14q if necessary.

Registered Internet retailers accessing the ETS 14 can search the global product catalog looking for products that that they would like to offer for sale through their electronic storefronts using one of the search engines 14n. During searches of the global product catalog, only products in the global product catalog that the Internet retailers 24 have permission to sell, as determined by the product visibility designations, are available for view. If the Internet retailer has sell permission and would like to select products for sale through their electronic storefront, the Internet retailer must negotiate with the vendor for either authorized reseller status or sales agent status. This process is handled by the product engine 14g. The status of the Internet retailer in relation to a vendor determines in the ETS 14, the terms of any sale transaction (“rules of exchange”) initiated by that Internet retailer for products of the vendor, including the financial settlement between the parties involved in the transaction.

When the Internet retailer 24 selects a product from the global product catalog that they would like to offer for sale through their electronic storefront, the selected product is listed in an Internet retailer product catalog stored in the product database 14p that is associated with the Internet retailer. Thus, each Internet retailer registered in the ETS 14 has an associated Internet retailer product catalog listing all of the products the Internet retailer has selected from the global product catalog. The Internet retailer product catalogs are continuously updated as Internet retailers select new products to offer for sale and delete existing products. Information concerning the products in the Internet retailer product catalog is downloaded to the Internet retailer's client computer system to allow the Internet retailer to advertise the products for sale through their electronic storefronts. However, prior to downloading the product information, the Internet retailer is required to confirm its understanding that rules of exchange apply to its ability to sell the selected products. Upon receiving the confirmation from the Internet retailer, the product information is downloaded to the Internet retailer.

When an Internet retailer 24 becomes an authorized reseller for a vendor, the Internet retailer can buy the vendor's products at a wholesale price and is free to sell the vendor's products at whatever price the Internet retailer decides, so long as the Internet retailer complies with other aspects of the rules of exchange. When an Internet retailer becomes a sales agent for a vendor, the Internet retailer may sell the vendor's products on behalf of the vendor, so long as the Internet retailer complies with, among other things, the pricing policies that form part of the rules of exchange established by the vendor. If desired, the rules of exchange can be adjusted per product, per SKU or per Internet retailer, allowing special deals to be struck between vendors and Internet retailers on either a broad basis or on a product-by-product basis. For example, if a particular Internet retailer acting as a sales agent for a vendor outperforms others, the vendor could reward that performance by reducing the pricing of certain products for that Internet retailer, or by increasing that Internet retailer's sales commission on certain products. By monitoring the sale of its products through various Internet retailers on a continuous basis, a vendor can make appropriate deals with Internet retailers to adjust its product pricing to follow Internet retail market conditions.

When an on-line Internet retailer customer 26 accesses the electronic storefront of an Internet retailer 24 and wishes to order products stored in the common pooled repository 30 through the ETS 14 for the first time, the customer is requested to submit contact, personal, shipping and credit card information. This information is handled by the customer engine 14l of the ETS 14 and is stored in the customer database 14r. The customer data in the customer database 14r is available to the Internet retailer and thus, as a result, the Internet retailer secures customer data.

When the Internet retailer customer 26 orders products though the electronic storefront, an order is generated and is sent to the ETS 14 for processing by the commerce engine 14f. Initially, the inventory database 14q is examined to determine if sufficient inventory exists in the common pooled repository 30 and if not, whether the Internet retailer 24 permits split shipping or back orders. If insufficient inventory exists in the common pooled repository and the Internet retailer does not permit back orders or split shipping, the order is terminated. If sufficient inventory exists in the common pooled repository 30 or if insufficient inventory exists but the Internet retailer 24 permits split shipping or backorders, the order is processed. During processing, the ETS 14 examines the terms under which the products are being offered for sale by the Internet retailer 24 to ensure compliance with the established rules of exchange. If the rules of exchange are being complied with, the finance engine 14h of the ETS 14 sends the transaction data to the tax calculation and credit card authorization and settlement system 22 so that the financial transaction can be settled. Once settled, the finance engine 14h conveys the transaction data to the FTS 18 and notifies the commerce engine 14f, which in turn sends the order to the WMS 16 so that the ordered products may be assembled from the inventory in the common pooled repository 30. Ordered products are then assembled using the fulfillment system 32 and the order is shipped directly to the customer from the common pooled repository 30 in a single shipment. The ETS 14 then accurately compensates the Internet retailer, the vendor(s), the shipper and other service providers involved in the transaction. Further specifics concerning the processing of customer orders will be described.

All of the product, order, inventory, financial settlement and other related information is stored by the ETS 14 in the databases. This information is available to the operator and to Internet retailers 24 and vendors 28 who have been granted access rights to the information. Through the graphical user interface of the ETS 14, Internet retailers 24 and vendors 28 can view, modify and add information that relates to them. In the case of vendors 28, through the graphical user interface, vendors can view, edit and delete the product information stored in the product database 14p that is associated with their products. As a result, vendors can update product information, alter pricing policies and product visibility designations and track the changes made. Vendors can also view the status of their inventory stored in the common pooled repository 30. In addition, vendors can view the Internet retailers who have permission to sell their products and arrange deals with these Internet retailers or can search for new Internet retailers.

In the case of Internet retailers 24, through the graphical user interface, Internet retailers can search the global product catalog for new products and can view their existing Internet retailer product catalogs. Internet retailers can also view the status of orders made through their electronic storefronts and review customer data.

Further specifics of the ETS graphical user interface will now be described.

Graphical User Interface—Vendor Access

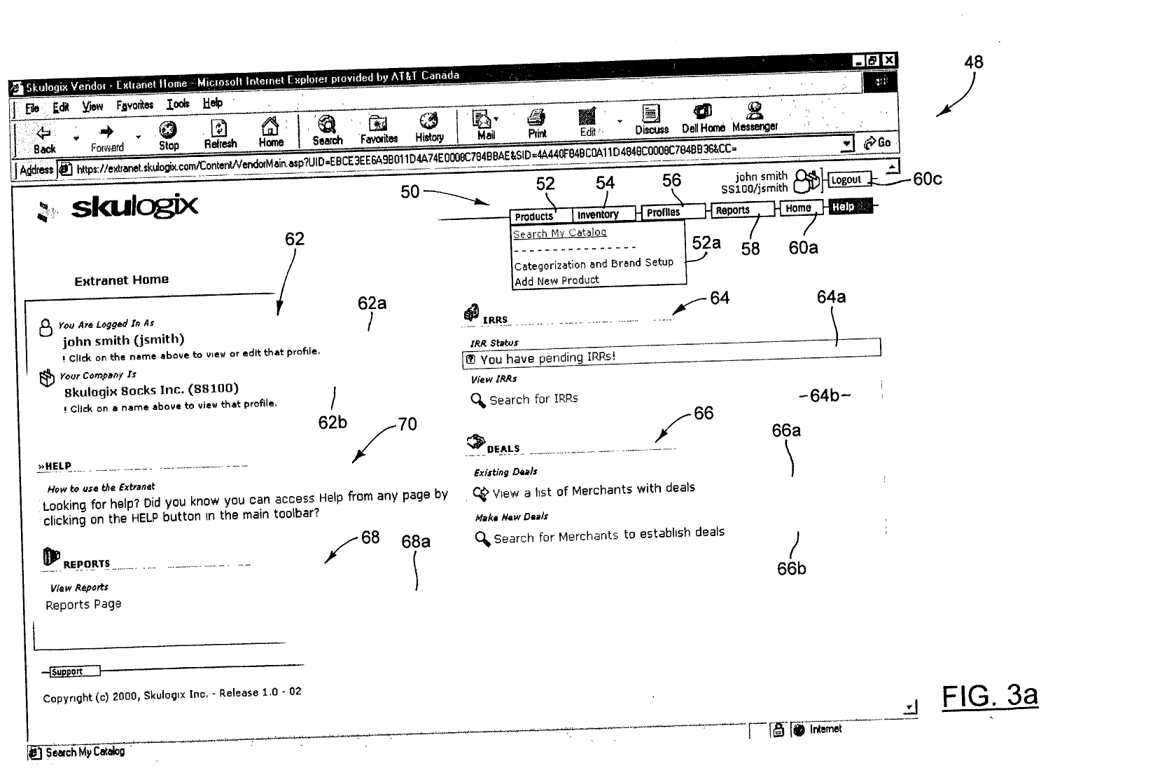

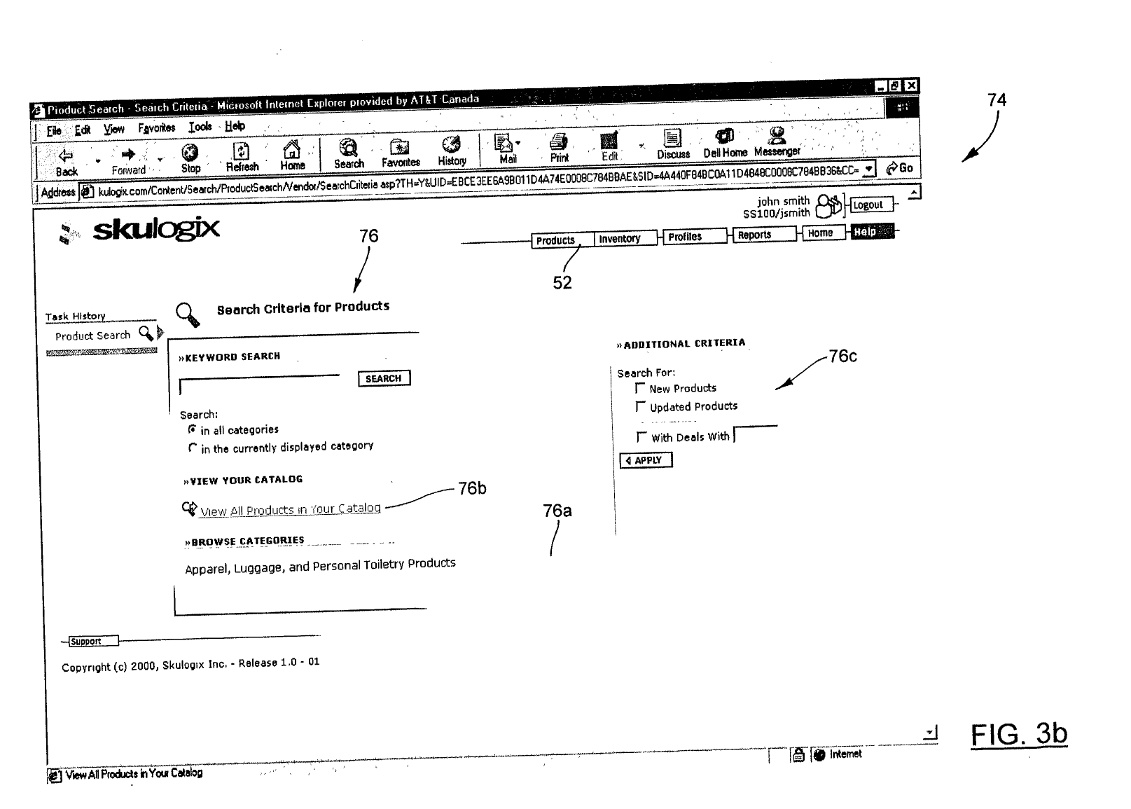

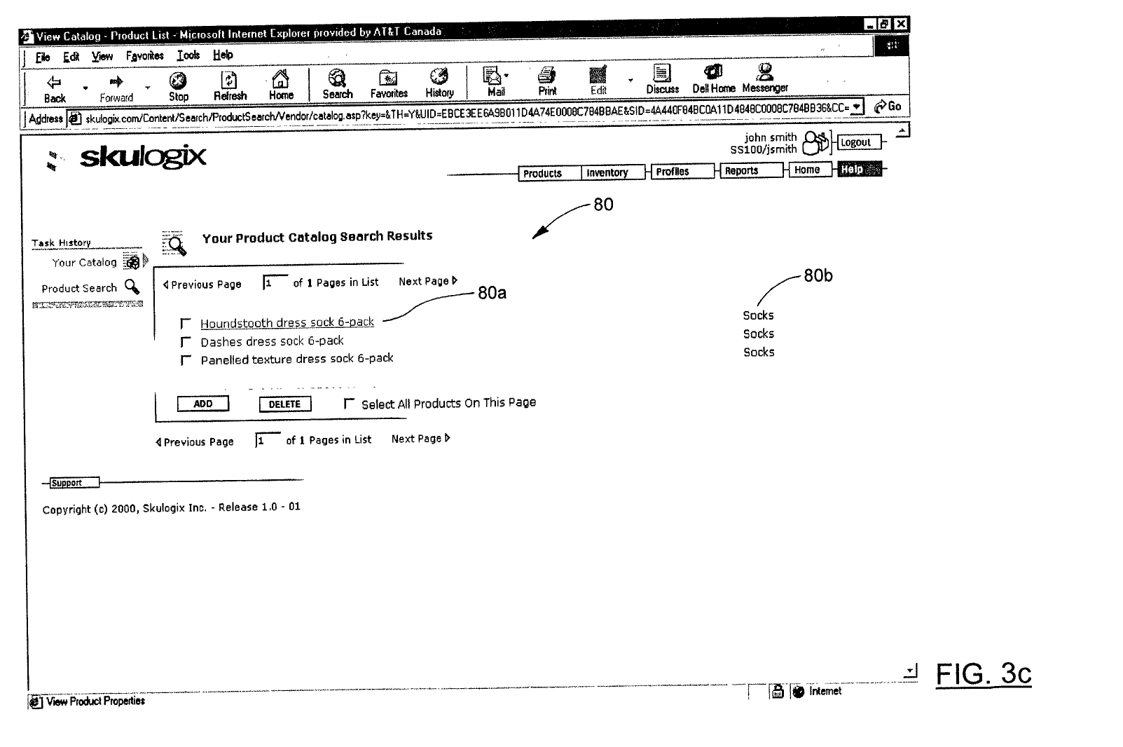

When a vendor completes the login process, the vendor is presented with a home page 48 having a tool bar 50 adjacent the upper right-hand corner of the home page as shown in FIG. 3a. The tool bar 50 includes a plurality of selectable tool bar options. The tool bar options include a products option 52, an inventory option 54, a profiles option 56, a reports option 58, and conventional home, help and logout options 60a to 60c respectively. Moving the cursor over any one of the products, inventory, profiles or reports options 52 to 56 respectively exposes a drop down menu that presents the selections available under the selected option.

The home page 48 also includes a vendor information section 62, an inventory replenishment request (IRR) section 64, a deals sections 66, a reports section 68 and a help section 70.

The vendor information section 62 includes fields 62a and 62b that display the name of the user who completed the login process and the name of the vendor. The user's name and the vendor's name are displayed as web page controls linked to profile pages associated with the user and the vendor. Selecting the user's name exposes the user's profile page allowing the user's profile to be viewed and edited. Selecting the vendor's name exposes the vendor's profile page allowing it to be viewed.

The IRR section 64 includes an IRR status field 64a and a view IRR field 64b. The IRR status field 64a displays a web page control that provides an indication as to whether the vendor has any pending IRRs. Selection of the web page control opens a page that displays the pending IRRs. The view IRR field 64b displays a web page control that is linked to a search engine. The search engine allows the vendor to search the inventory database 14q for IRRs that have been filled or are pending.

The deals section 66 includes an existing deals field 66a and a make new deals field 66b. The existing deals field 66a displays a web page control that opens a page listing all of the Internet retailers 24 with whom the vendor has deals. The make new deals field 66b displays a web page control that is linked to a search engine. The search engine allows the vendor to search the Internet retailer/vendor database 14o for Internet retailers registered in the ETS 14 so that the vendor may establish new deals with Internet retailers.

The reports section 68 includes a view reports field 68a. The view reports field displays a web page control that opens pages displaying sales, inventory, financial and merchandising logs of interest to the vendor.

Products Option

Selection of the products option 52 from the tool bar 50 exposes a drop down menu 52a including a search my catalog option, a categorization and brand set-up option and an add new product option as shown in FIG. 3a. Each option is displayed as a web page control linked to an underlying page. Selecting the search my catalog option opens a page 74 displaying a product search engine 76 as shown in FIG. 3b. The product search engine 76 allows the vendor to search their vendor product catalog in the product database 14p by keyword. The search can be performed across all categories or limited to a selected category highlighted in a category field 76a.

All of the products in the vendor's product catalog can be displayed by selecting the “view all products in your catalog” web page control 76b. Searching can be further refined using additional criteria fields 76c. Specifically, the additional criteria fields 76c allow searches to be limited to new products, updated products and/or products associated with Internet retailers with whom the vendor has deals.

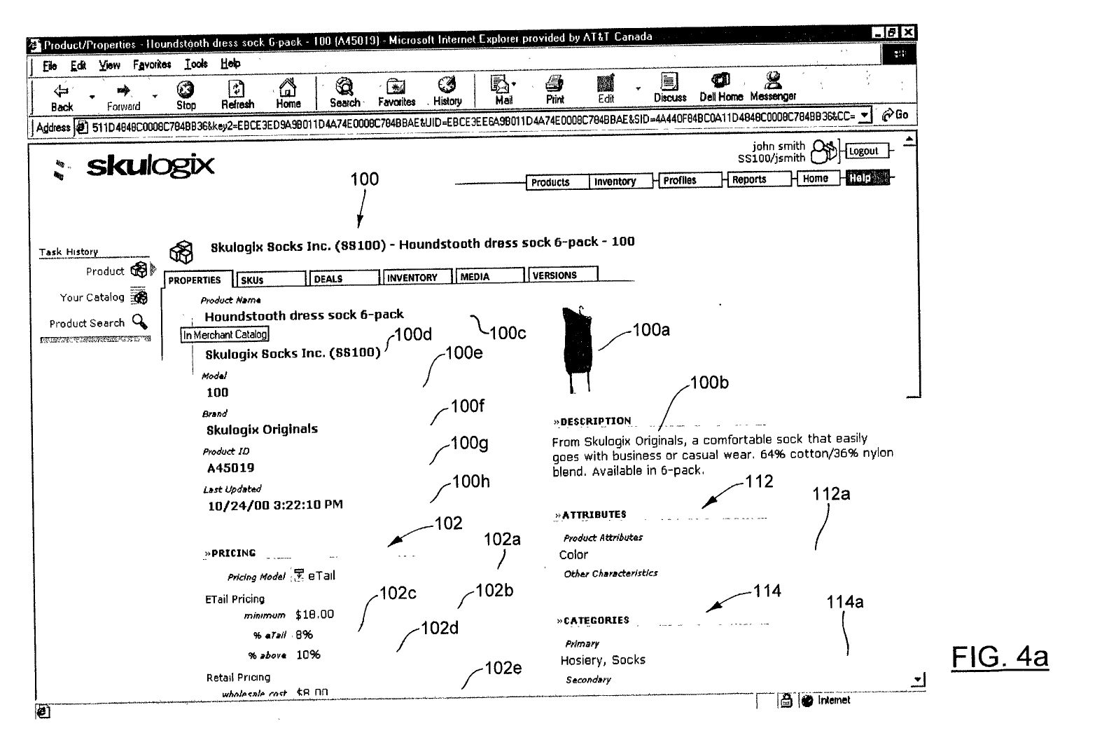

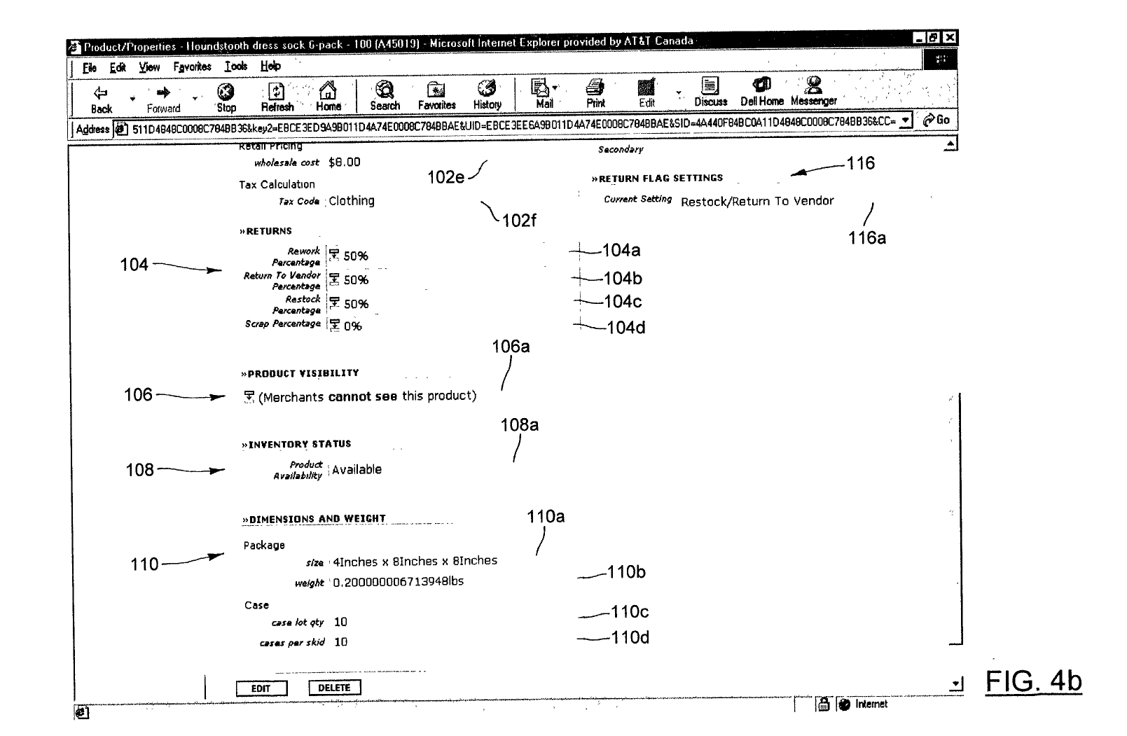

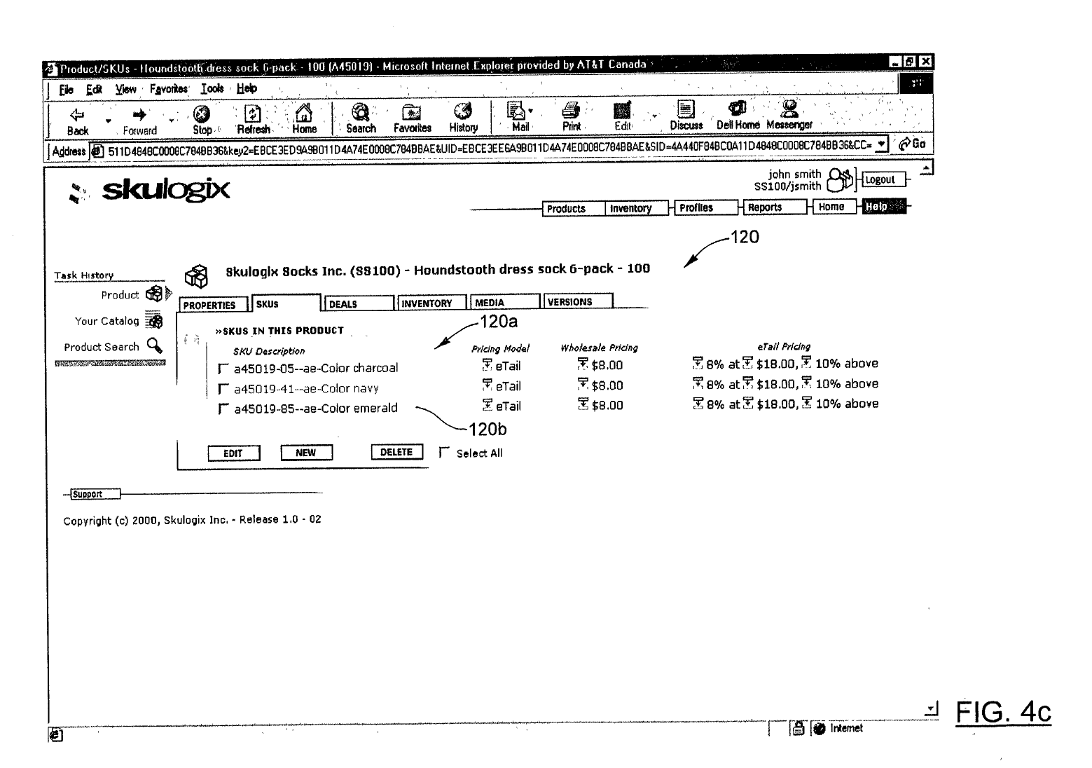

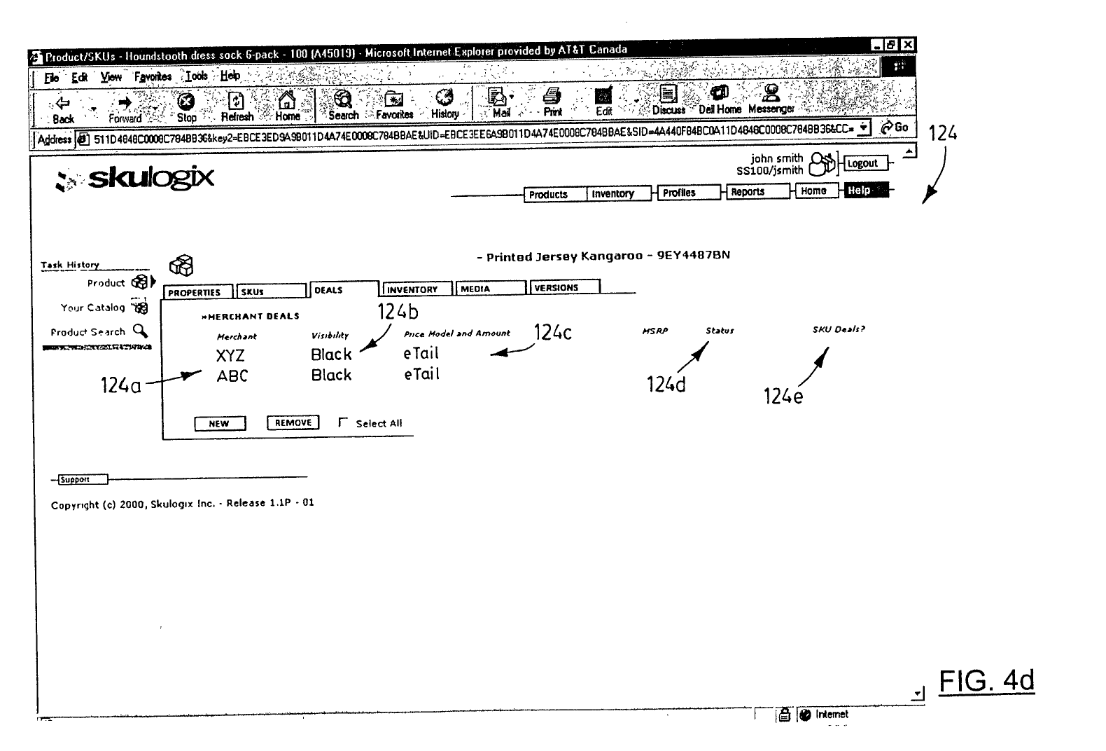

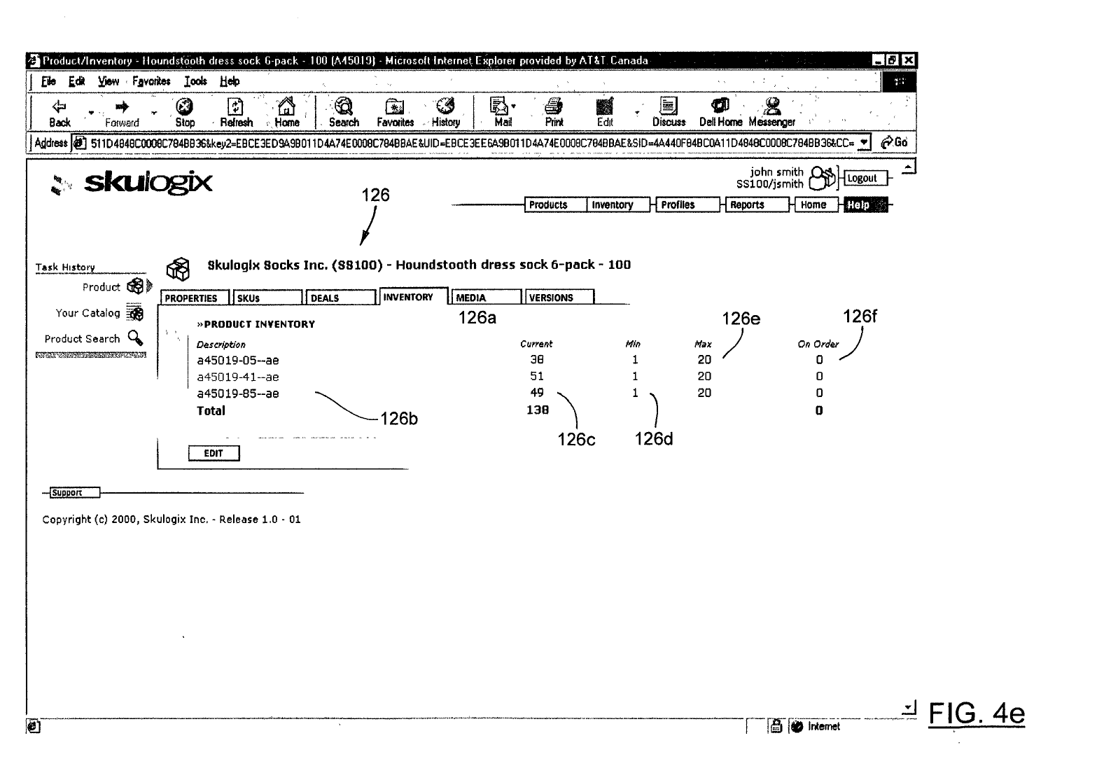

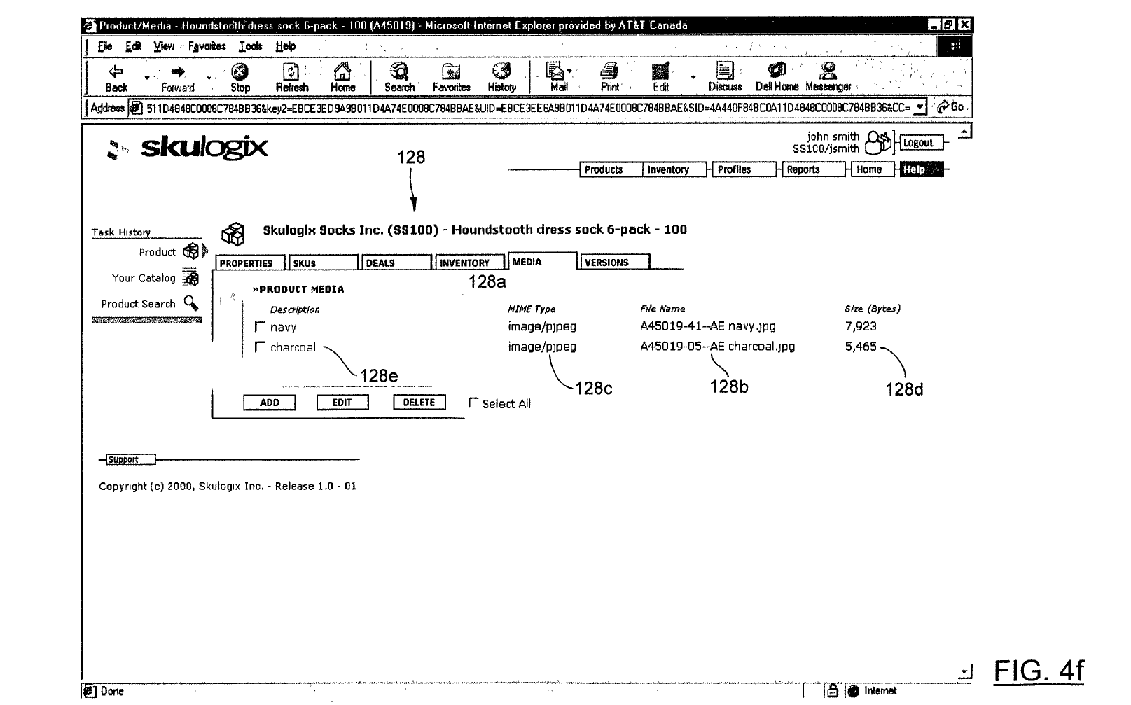

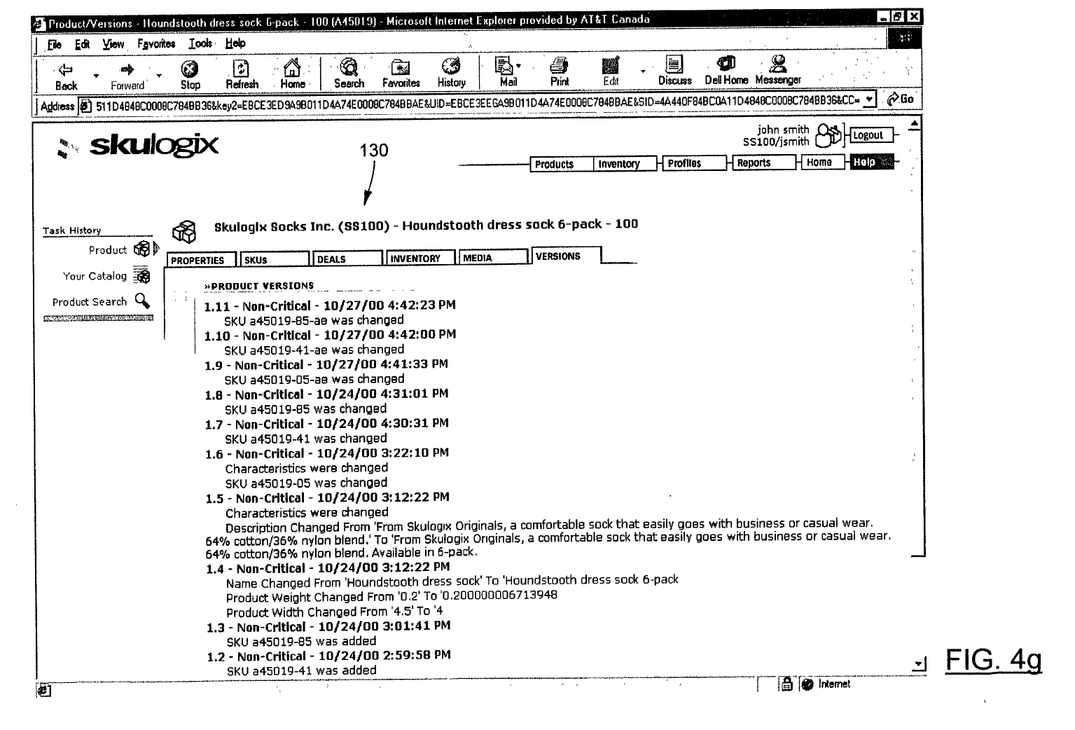

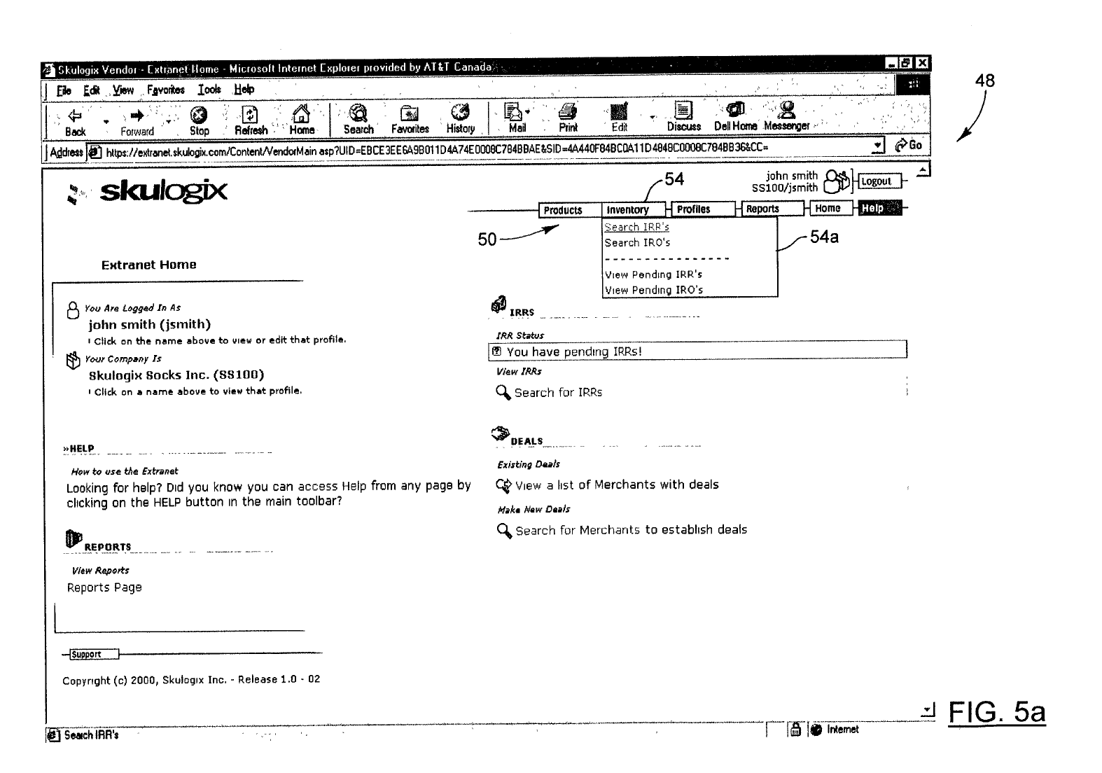

FIG. 3c shows the vendor's product catalog 80 as displayed in response to selection of the “view all products in your catalog” web page control 76b. The products in the vendor's product catalog are presented in a list and are identified by name 80a and category 80b. The names 80a are presented as web page controls that are linked to underlying product information pages. For example, FIGS. 4a and 4g show the product information pages associated with the first product in the vendor's product catalog 80. These pages expose information relating to the product that is stored in the product database 14p. In the present embodiment, the product information pages include a properties page 100, a SKUs page 120, a deals page 124, an inventory page 126, a media page 128 and a versions page 130. Each page can be exposed by selecting the tab at the top of the respective page.

As shown in FIGS. 4a and 4b, the properties page 100 displays an image 100a of the product, if available, together with a description of its characteristics 100b. The properties page 100 also includes fields 100c to 100h displaying the product name, the vendor's name, the product model number, the product brand name, the product ID number and when the product information pages were last updated. Properties page 100 also includes a pricing section 102, a returns section 104, a product visibility section 106, an inventory status section 108, a dimensions and weight section 110, an attributes section 112, a categories section 114 and a return flag settings section 116.

Pricing section 102 includes a pricing model field 102a that displays the pricing model under which the product is to be sold by Internet retailers. The pricing model can be set by the vendor either to etail or retail. If the pricing model is etail, Internet retailers who are permitted to sell the product do so as sales agents on behalf of the vendor. If the pricing model is retail, Internet retailers who are permitted to sell the product do so as resellers of the product. The pricing section 102 also includes etail pricing fields 102b, to 102d, a retail pricing field 102e and a tax calculation field 102f.

The etail pricing fields 102b to 102d include the lowest permitted selling price for the product (minimum) established by the vendor, the percentage of the sale that an Internet retailer receives for selling the product at the lowest permitted selling price (% etail), and the percentage commission of the amount over the lowest permitted selling price that the Internet retailer receives when products are sold above the lowest permitted selling price (% above). The retail pricing field 102e indicates the wholesale cost of the product paid to the vendor by the Internet retailer if the Internet retailer sells the product. The tax calculation field 102f indicates the tax code used to calculate the amount of sales tax to be charged when the product is sold.

The returns section 104 includes a number of fields that display as a percentage of etail price, the cost to be charged to the vendor by the operator for handling returned products if an etail pricing model is selected. Specifically, the returns section 104 includes a rework percentage field 104a, a return to vendor percentage field 104b, a restock percentage field 104c and a scrap percentage field 104d.

The product visibility section 106 includes a field 106a that displays the product visibility designation assigned to the product by the vendor. In the present embodiment, products can be designated as white, grey or black. If a product is designated black, the product information pages associated with the product can only be seen by Internet retailers 24 who have permission to sell the product. If a product is designated grey, the product information pages associated with the product can be seen by all Internet retailers 24. However, only Internet retailers who have permission to sell the product can select the product for incorporation into their Internet retailer product catalog. If the product is designated white, the product information pages associated with the product can be seen by all Internet retailers. Also, any Internet retailer may select the product for incorporation into its Internet retailer product catalog.

Inventory status section 108 includes a field 108a that displays an indication as to whether the product is stored as inventory in the common pooled repository 18.

Dimensions and weight section 110 includes a number of fields 110a to 110d that display information relating to product packaging. In the example shown, the fields 110a to 110d display the size and weight of the product package, the case lot quantity and the case per skid quantity.

Attribute section 112 includes fields 112a that display primary attributes of the product such as product colour and other characteristics.

The categories section 114 includes fields 114a that display the primary and secondary categories in which the product is categorized. In the present embodiment, products are categorized following UNSPEC standards.

Return flag settings section 116 includes a field 116a that displays the manner by which the operator is to handle returned products. The information displayed in the field 116a therefore determines the field in the returns section 104 that is used by the operator to charge the vendor for handling product returns.

The SKUs page 120 as shown in FIG. 4c presents a list 120a of the SKUs associated with the product, that are currently held in the common pooled repository 18. The SKUs in the list are identified by SKU description 120b and are displayed as web page controls linked to SKU pages. The SKU pages are similar to the product information pages but present information related to the SKUs. The pricing model (either etail or retail) selected for the product, the wholesale cost for the product that is displayed in the retail pricing field 102e and the minumum % etail, and % above values that are displayed in the etail pricing fields 102b to 102d respectively, are also displayed beside each SKU description.

The deals page 124 as shown in FIG. 4d presents a list 124a of the Internet retailers that have deals set up with the vendor concerning the product. The Internet retailers in the list 124a are displayed as web page controls linked to Internet retailer detail pages. In addition to the Internet retailers, the deals page 124 identifies the product visibility designations 124b assigned to the product, the pricing model and amount 124c established for the Internet retailers, the status of the deals 124d and whether any deals exist with the Internet retailers for the product at the SKU level 124e.

The inventory page 126 as shown in FIG. 4e presents a list 126a of the SKUs associated with the product that are currently held in the common pooled repository 18 and listed in the inventory database 14q. The list identifies each SKU by description 126b. The current number of product units remaining in each SKU 126c, the minimum and maximum inventory threshold levels 126d and 126e set for each product and the number of units of each product 126f that are on order, are displayed beside each SKU description 126a. The color of the current number of product units 126c changes when the number of product units remaining in a SKU drops below the minimum inventory threshold level 126d

The media page 128 as shown in FIG. 4f presents a list 128a of the media files associated with the product such as image/JPEG files, text and/or audio/video files. The media files are identified by file name 128b, file type 128c, file size 128d and description 128e and are handled by the media engine 14i. The descriptions are presented as web page controls. Selection of a web page control in the list opens a popup window in which the media file is displayed.

The versions page 130 as shown in FIG. 4g presents a summary of changes that have been made to the product information pages allowing the vendor to track changes to the product information pages. The summary indicates whether the changes that have been made to the product information pages are critical or non-critical.

When a vendor updates the product information pages, if the updates are designated as critical i.e. pricing and/or term data is changed, Internet retailers who have the product in their Internet retailer product catlaog are notified and are required to update their Internet retailer product catalog within a specified time frame. Sales of the product using the old and new catalog are permitted within this time frame. After the specified time frame expires, sales of the product using the old catalog are not permitted. Further specifics concerning the updating of product information pages will be described.

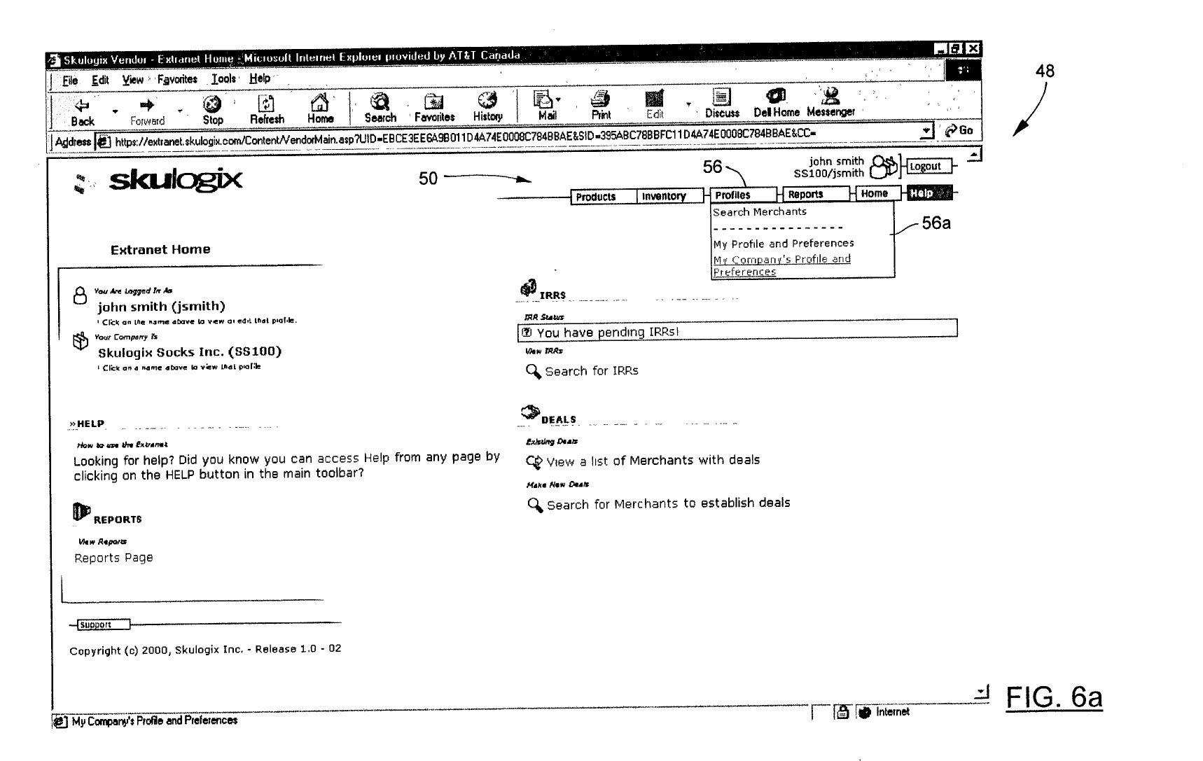

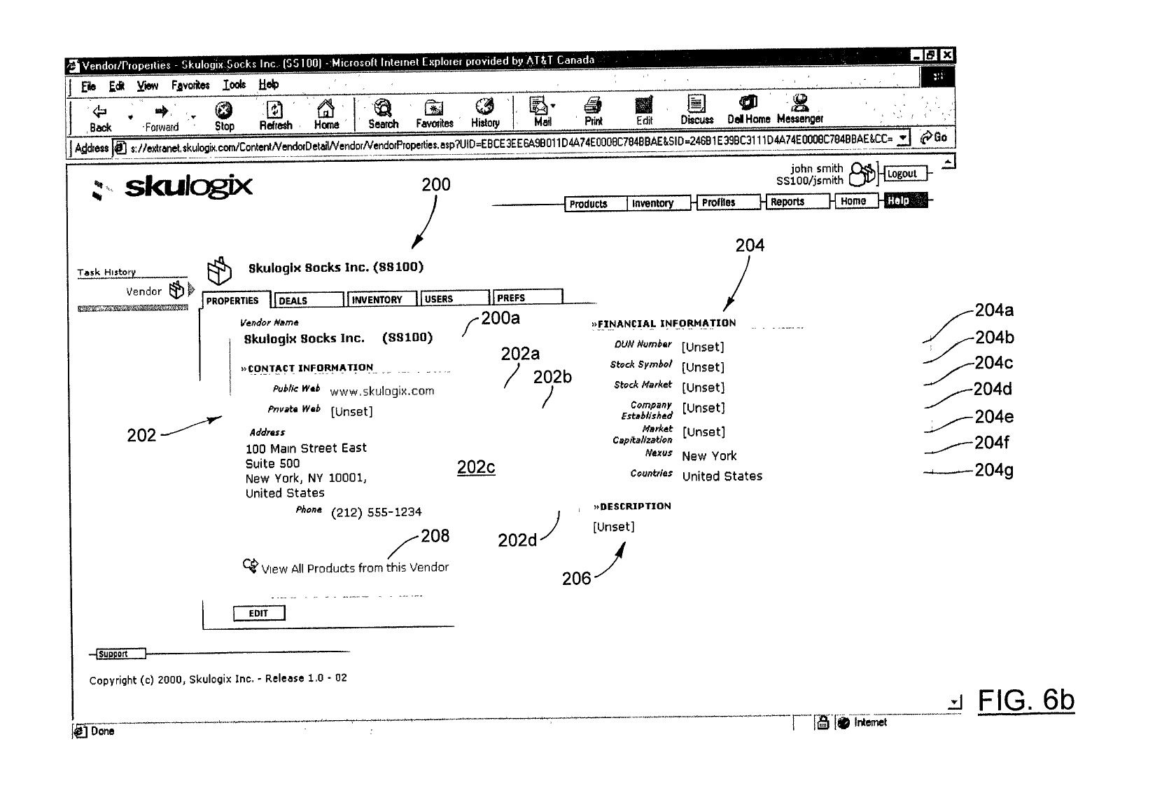

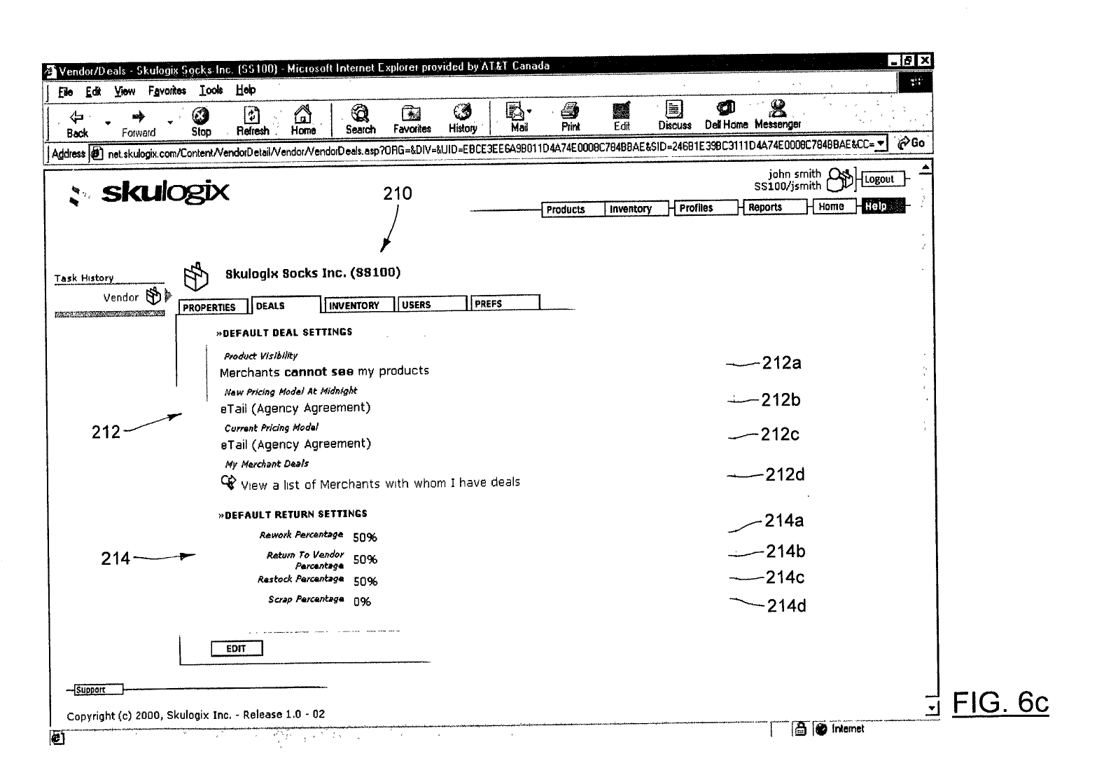

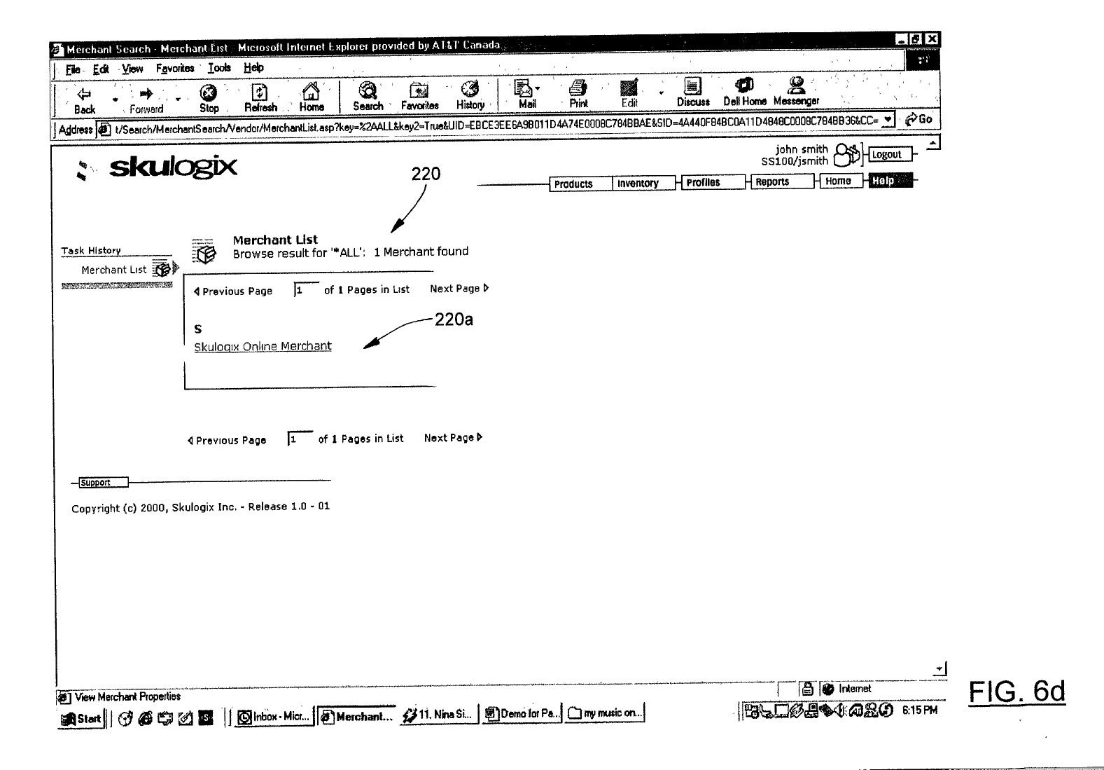

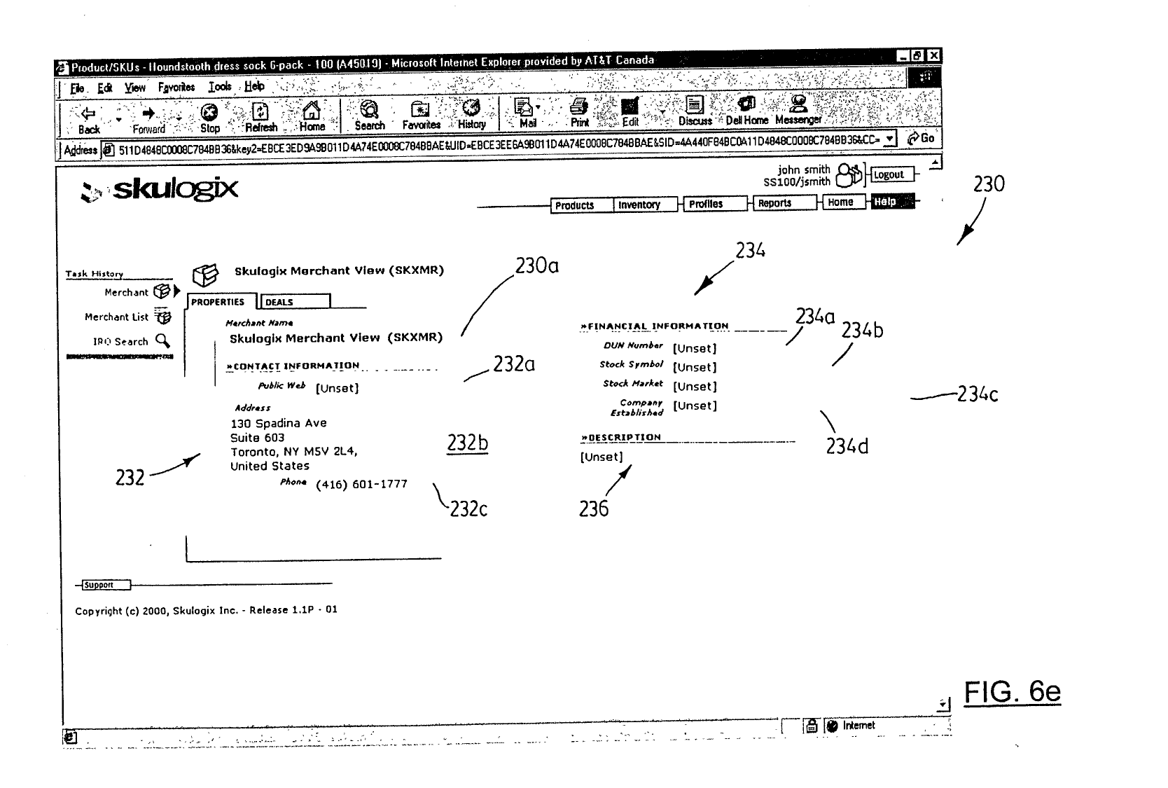

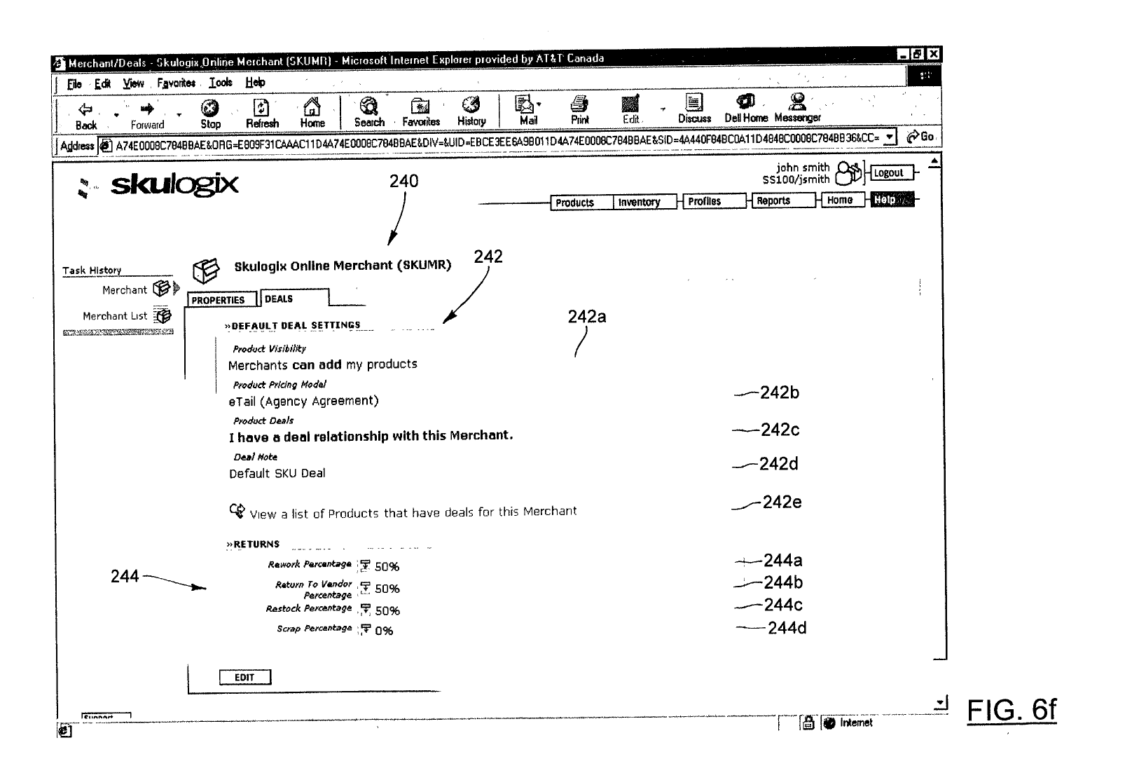

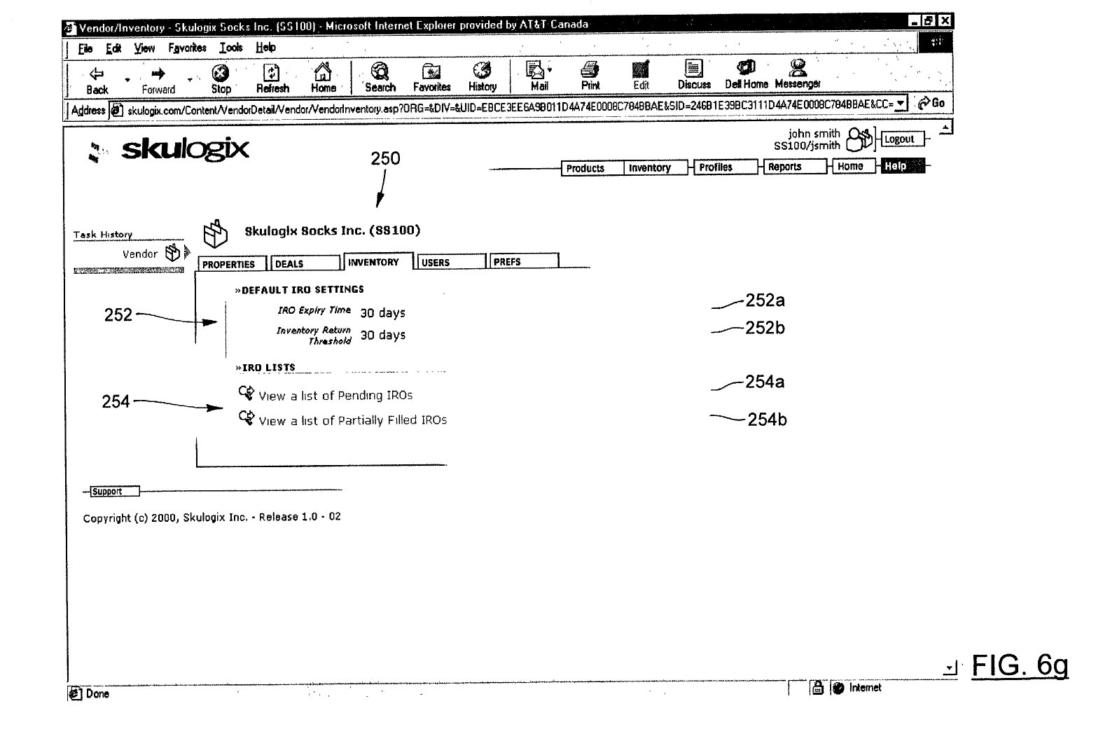

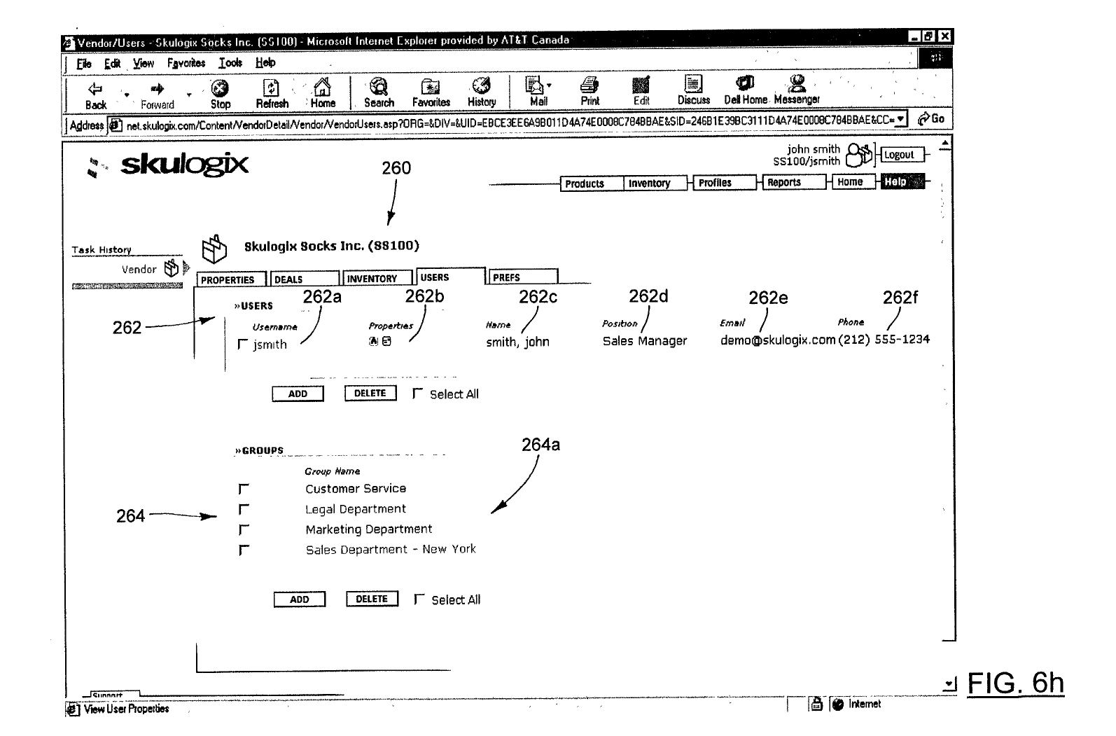

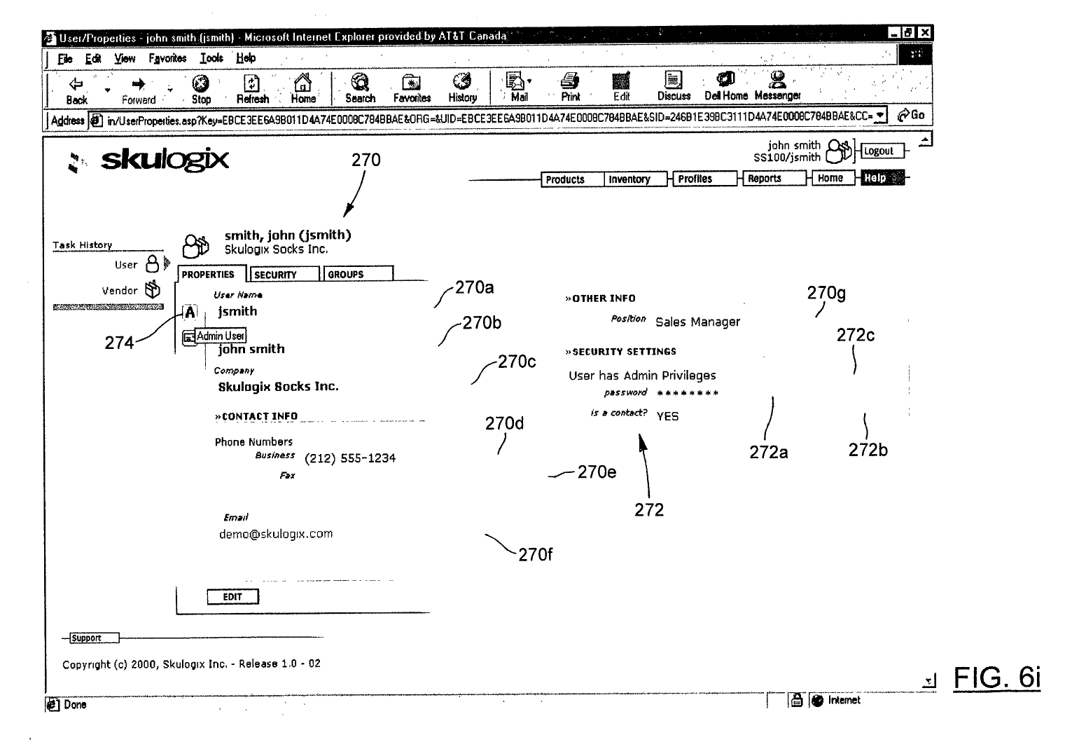

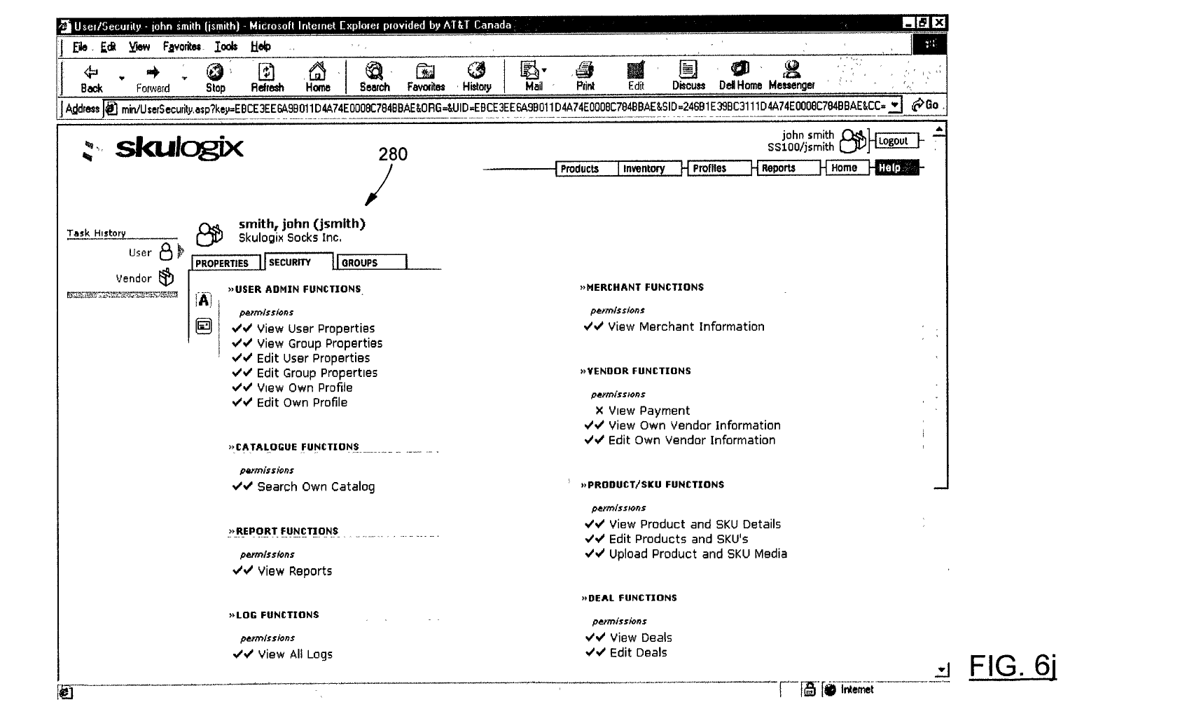

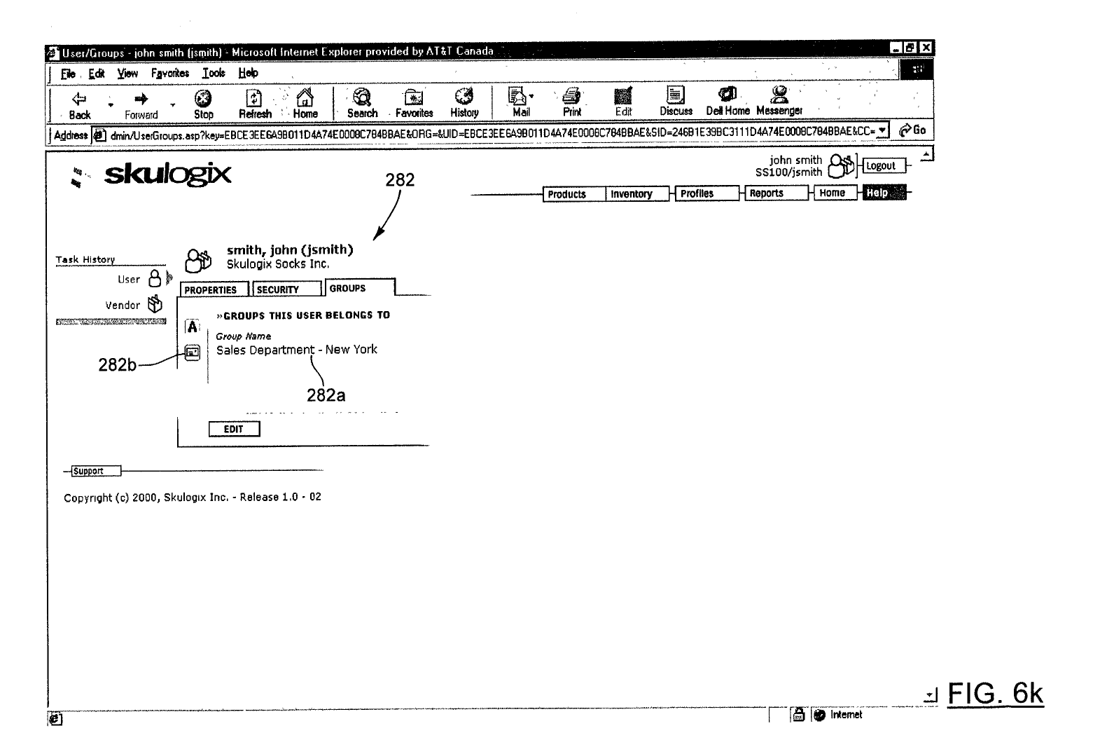

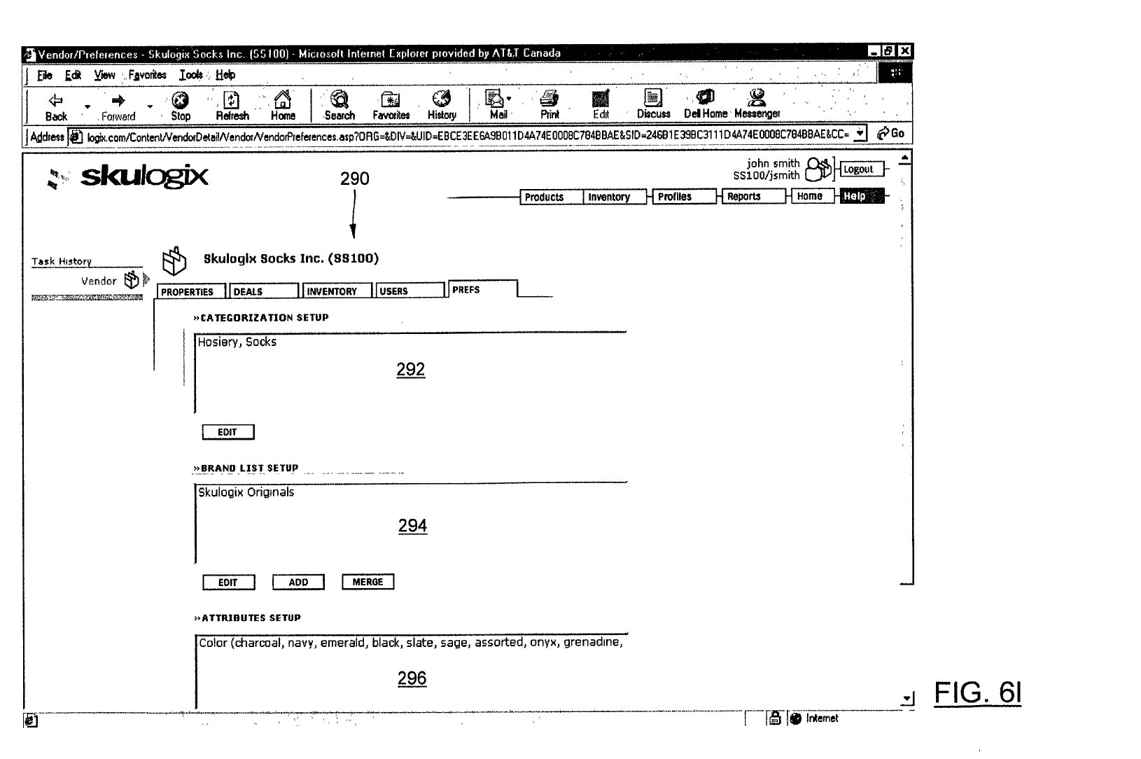

Selecting the categorization and brand set up option, opens a page (see FIG. 6l) that allows the vendor to categorize products and assign the products brand names.

Selecting the add new products option, opens blank product information pages allowing the vendor to add a new product to its vendor product catalog. New products added to the vendor product catalog that have not been received by the system operator are identified as being unavailable in the inventory status field 108a.

Inventory Option

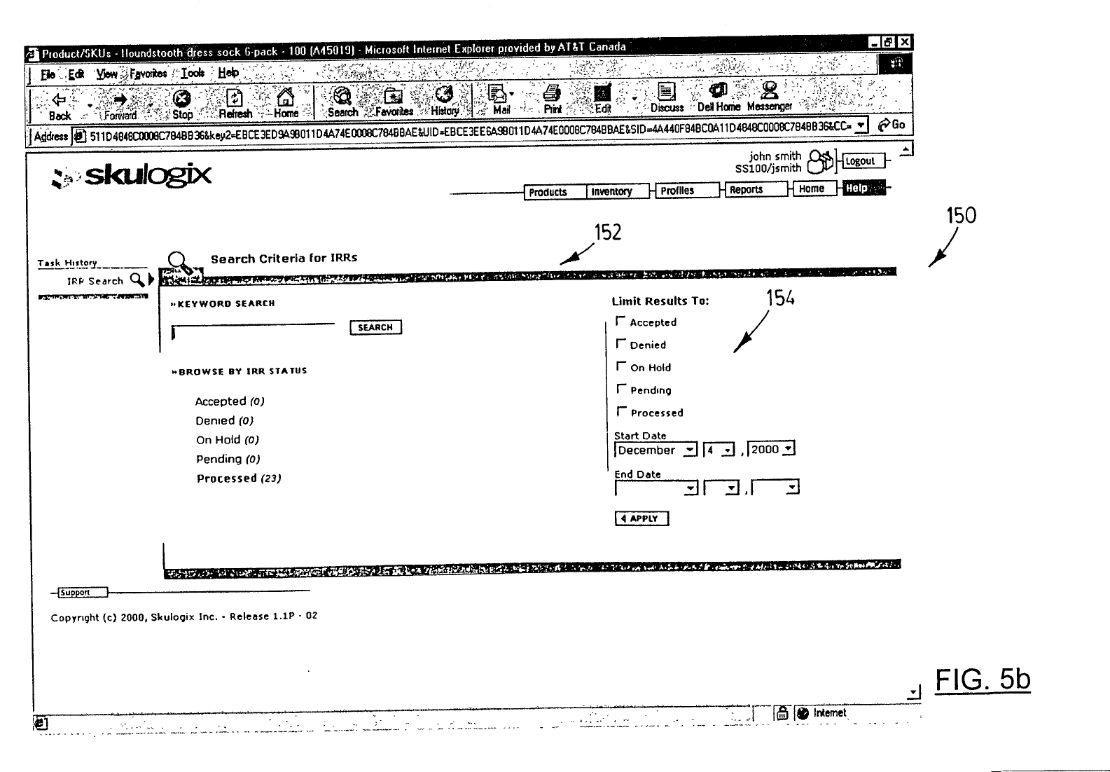

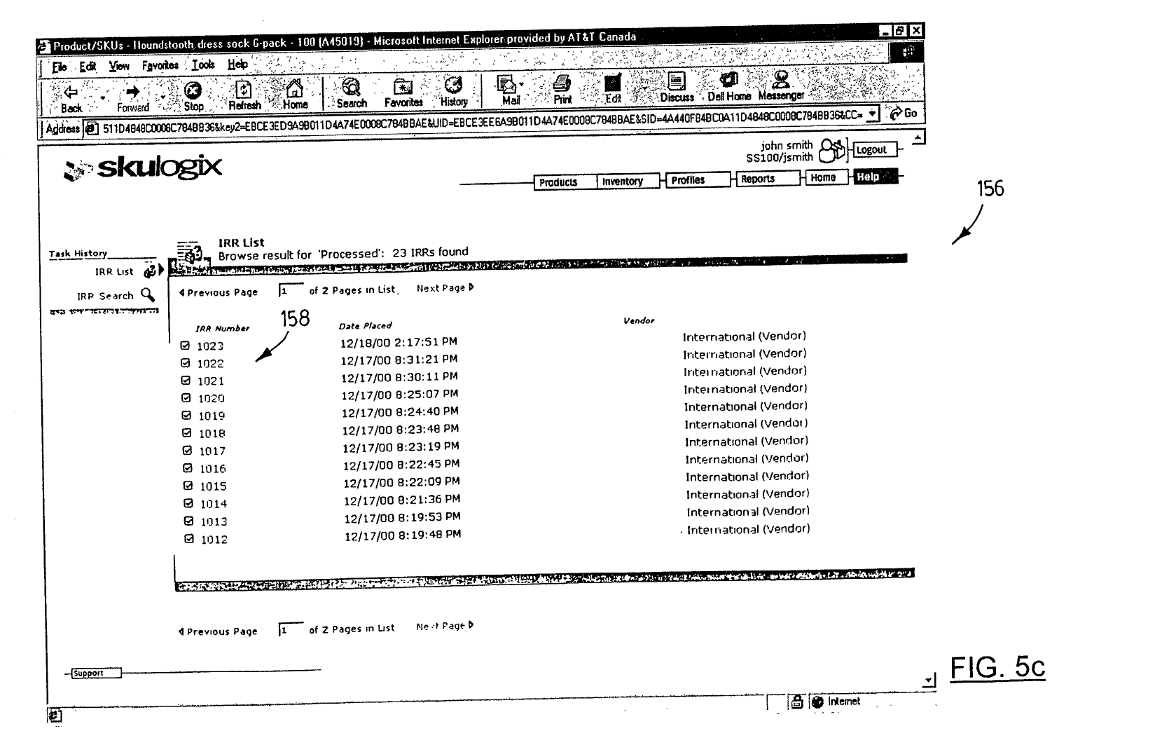

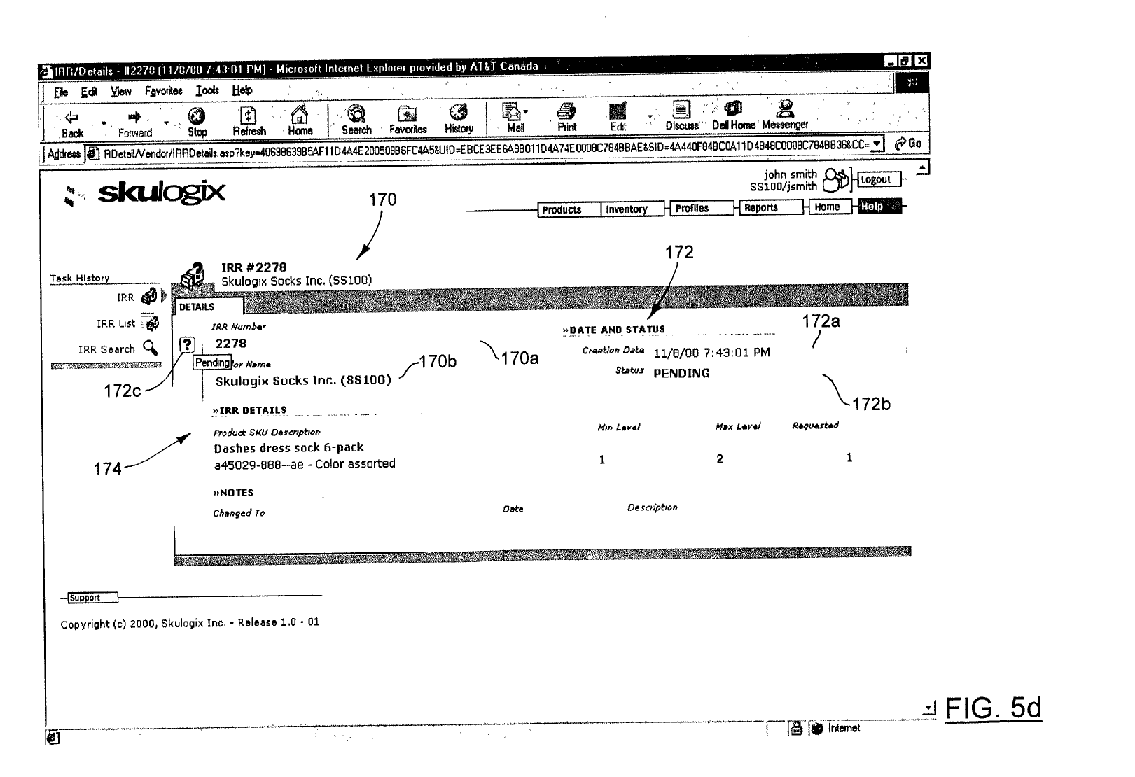

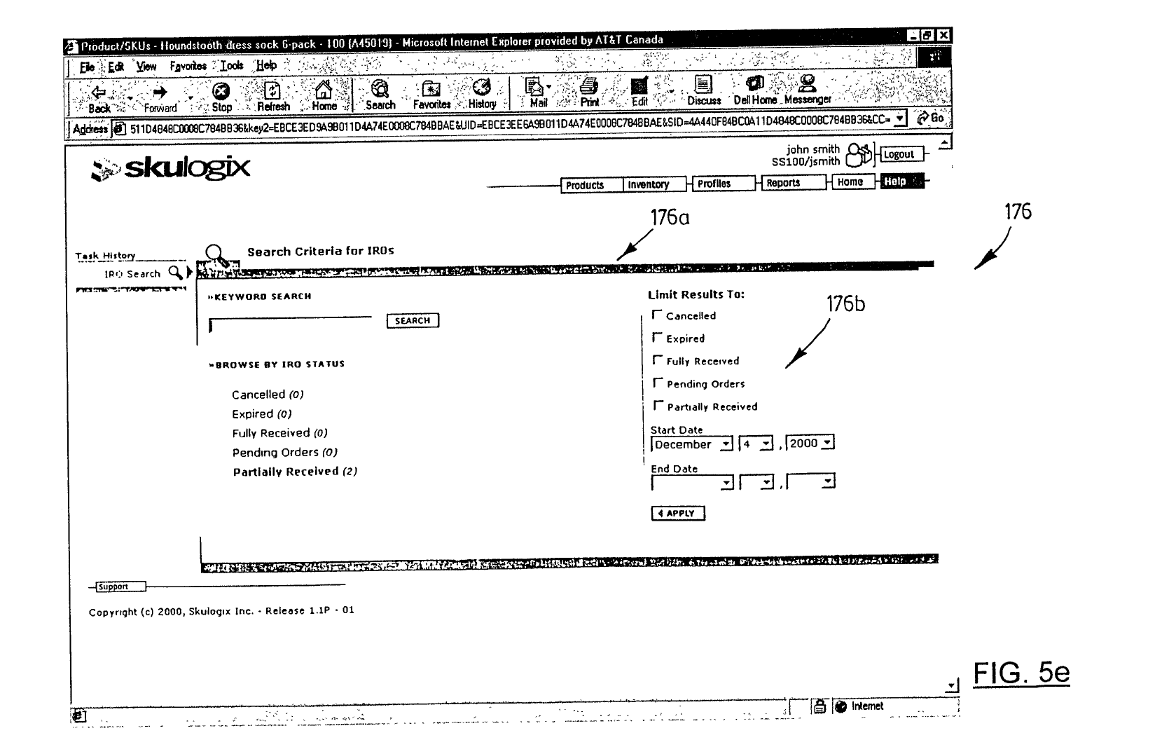

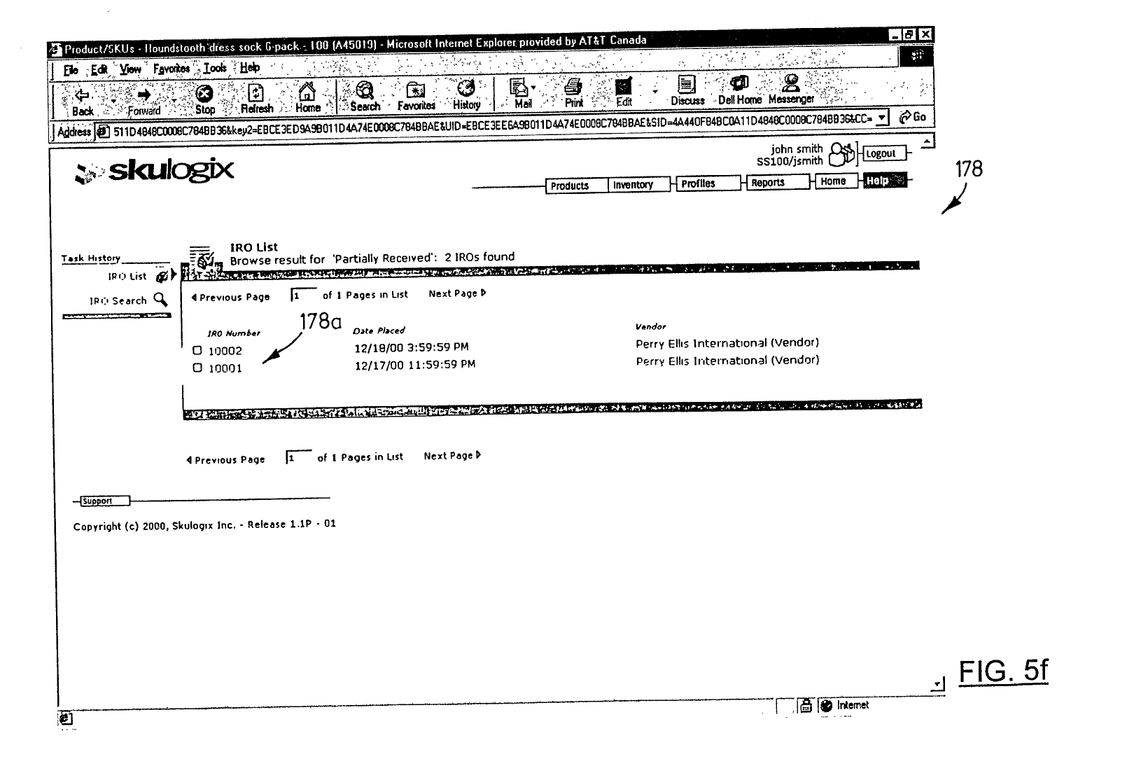

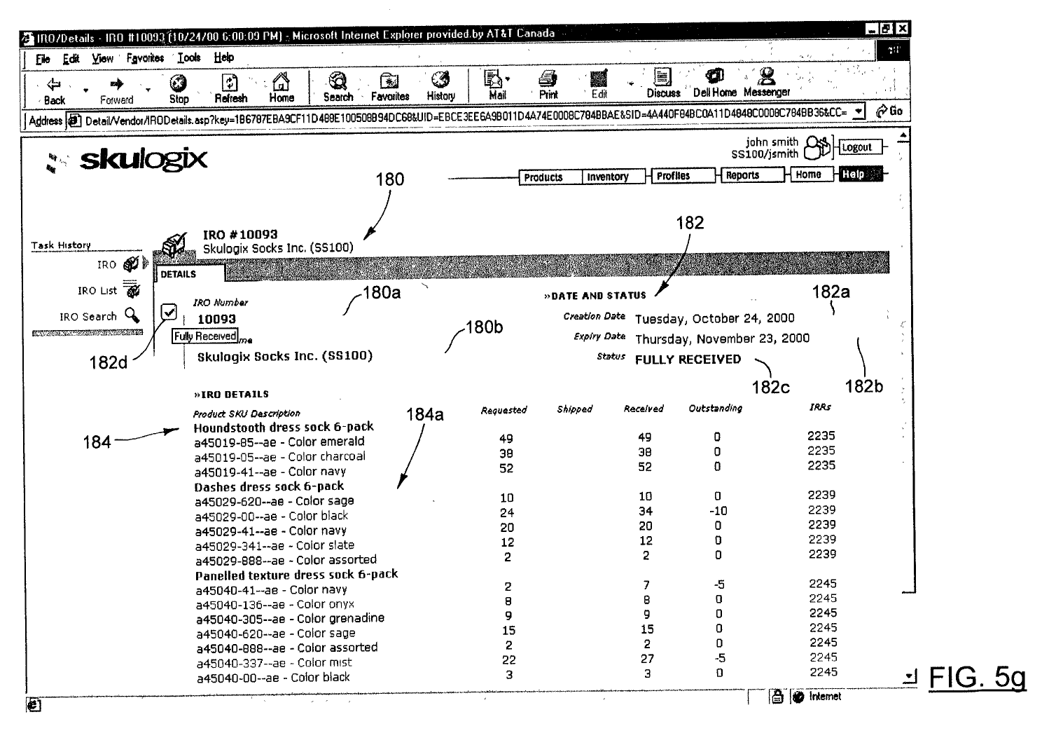

Selection of the inventory option 54 exposes a drop down menu 54a including a search IRRs option, a search IROs option, a view pending IRRs option and a view pending IROs option as shown in FIG. 5a. Each option in the drop down menu 54a is displayed as a web page control linked to an underlying page. Selecting the search IRR option, opens a page 150 displaying an IRR search engine 152 as shown in FIG. 5b. The IRR search engine 152 allows the vendor to search for IRRs in the inventory database 14q by keyword. IRRs can also be searched by status. Additional criteria fields 154 allow keyword searches to be refined based on status and/or date. FIG. 5c shows a page 156 presenting a list 158 of IRRs as displayed in response to selection of the “processed” category in the browse section of the IRR search engine 152. The IRRs in the list 158 are presented as web page controls linked to associated IRR detail pages.

An example of an IRR detail page 170 is shown in FIG. 5d. As can be seen, the IRR detail page 170 includes fields 170a and 170b that identify the IRR by number and vendor. The IRR detail page 170 also includes a date and status section 172 and an IRR details section 174. Date and status section 172 includes fields 172a and 172b that display the time and date the IRR was created and the status of the IRR. An icon 172c adjacent the IRR number field 170a provides a symbolic indication of the IRR status. The IRR details section 174 identifies the product by name and SKU, and indicates the minimum and maximum number of SKUs of the product that can be requested and the number of SKUs that are requested in the IRR.

Selecting the search IRO option, opens a page 176 displaying an IRO search engine 176a as shown in FIG. 5e. The IRO search engine 176a, similar to the IRR search engine, allows the vendor to search for IROs in the inventory database 14q by keyword. IROs can also be searched by status. Additional criteria fields 176b allow keyword searches to be refined based on status and/or date. FIG. 5f shows a page 178 presenting a list 178a of IROs as displaying in response to selection of the “partially received” category in the browse section of the IRO search engine 176a. The IROs in the list 178a are presented as web page controls linked to associated IRO detail pages.

An example of an IRO detail page 180 is shown in FIG. 5g. As can be seen, the IRO detail page 180 includes fields 180a and 180b that identify the IRO by number and vendor. The IRO detail page 180 also includes a date and status section 182 and an IRO details section 184. Date and status section 182 includes fields 182a, 182b, and 182c that display the date the IRO was created, the date the IRO expires and the status of the IRO. An icon 182d adjacent the IRO number field 182a provides a symbolic indication of the IRO status. The IRO details section 184 presents a list 184a of the product SKUs forming the IRO. The product SKUs are identified by product name and SKU description. For each product SKU in the list, the number of units of each product requested, the number of units shipped, the number of units received, the number of units outstanding and the IRR number are displayed.

Selecting the view pending IRRs option opens a page (not shown) showing a list of pending IRRs that is similar to that shown in FIG. 5c while selecting the view pending IROs option opens a page (not shown) showing a list of pending IROs that is similar to that shown in FIG. 5f. Selecting an IRR from the list of pending IRRs opens an IRR detail page similar to that shown in FIG. 5d. Selecting an IRO from the list of pending IROs opens an IRO detail page similar to that shown in FIG. 5g.

Profiles Option

Selection of the profiles option 56 from the tool bar 50 exposes a drop down menu 56a including a “search merchants” option, a “my profile and preferences” option and a “my company's profile and preferences” option as shown in FIG. 6a. Each option in the drop drown menu 56a is presented as a web page control that is linked to an underlying page.

Selecting the “my company's profile and preferences” option opens vendor detail pages that display vendor information stored in the Internet retailer/vendor database 14o. In the present embodiment, the vendor detail pages include a properties page 200, a deals page 210, an inventory page 250, a users page 260 and a preferences page 290. Each page can be exposed by selecting the tab at the top of the respective page.

The properties page 200 as shown in FIG. 6b includes a vendor name field 200a, a contact information section 202, a financial information section 204 and a description section 206. Contact information section includes fields 202a to 202d displaying a public web address, a private web address, a post office address and a telephone number. The financial information section 204 includes a number of fields 204a to 204f for displaying financial information concerning the vendor. The financial information section can also be used to set credit limits for the vendor. The description section 206 provides a description of the vendor's business. The properties page 200 also includes a web page control 208 that opens a page displaying the vendor's catalog.

The deals page 210 as shown in FIG. 6c includes a default deal settings section 212 and a default return settings section 214. The default deal settings section 212 includes a product visibility field 212a, a new pricing model at midnight field 212b and a current pricing model field 212c. The values entered in the product visibility and current pricing model fields are used to populate the corresponding fields displayed on product properties pages associated with products where a deal has been reached between the vendor and an Internet retailer. A web page control 212d that opens a page displaying the vendor's Internet retailer deal list is also provided in the default deal section 212. The new pricing model at midnight field 212b is used to change the current pricing model listed in field 212c. Changes to the pricing model become effective at midnight.

The default return settings section 214 includes fields 214a to 214d corresponding to those displayed on the product properties pages. Similarly, the values entered in these fields are used to populate the corresponding fields displayed on product properties pages associated with products where a deal has been reached between the vendor and an Internet retailer.

Selection of the web page control 212d, opens an Internet retailer list page 220 that presents a list 220a of the Internet retailers with whom the vendor has deals as shown in FIG. 6d. Thus, web page control 212d is similar to the web page control presented in field 66a. The name of each Internet retailer is presented in the list as a web page control that is linked to Internet retailer detail pages. The Internet retailer detail pages include a properties page 230 and a deals page 240. Each page can be exposed by selecting the tab at the top of the respective page.

The properties page 230 as shown in FIG. 6e includes an Internet retailer name field 230a, a contact information section 232, a financial information section 234 and a description section 236. Contact information section 232 includes fields 232a to 232e for displaying a public web address, a post office address and a telephone number. The financial information section 234 includes a number of fields 234a to 234d for displaying financial information of the Internet retailer. The description section 236 provides a description of the Internet retailers business.

The deals page 240 as shown in FIG. 6f includes a default deal settings section 242 and a returns section 244. The default deal settings section 242 includes a product visibility field 242a, a product pricing model field 242b, a product deals field 242c and a deal note field 242d. The setting of the product visibility field 242a determines whether the Internet retailer is permitted to add the vendor's product to their Internet retailer product catolog. The setting of the pricing model field 242b displays the pricing model selected for the deal relationship between the vendor and the Internet retailer. The product deals field 242c provides a text indication that a deal exits with the Internet retailer. The deal note field 242d provides information concerning the type of deal that exists. The default deals setting section 242 also includes a web page control 242e that opens a page presenting a list of all the vendor's products in the vendor product catalog that have deals for the Internet retailer.

The returns section 244 includes fields 244a to 244d similar to fields 214a to 214d shown in FIG. 6c.

The inventory page 250 as shown in FIG. 6g includes a default IRO settings section 252 including an IRO expiry time field 252a and an inventory return threshold field 252b. The value in the IRO expiry time field 252a determines the maximum length of time an IRO is permitted to remain pending before it is cancelled. The value in the inventory return threshold field 252b determines the maximum length of time inventory is permitted to remain in the common pooled repository 18. The inventory page 250 also includes two IRO list web page controls 254a and 254b. When web page control 254a is selected, a page is opened that presents a list of pending IROs and when web page control 254b is selected, a page is opened that presents a list of partially filled IROs.

The users page 260 as shown in FIG. 6h expose information stored in the users database 14s and includes a users section 262 and a groups section 264. The users section 262 presents a list of users within the vendor's organization who are permitted access to the ETS 14. Each user in the list is identified by username 262a, properties 262b, name 262c, position 262d, e-mail address 262e and telephone number 262f. The symbols shown in the properties field 262b associated with each user identify the security level assigned to the user and the group(s) within vendor's organization to which that user belongs.

The groups section 264 presents a list 264a of the groups within vendor's organization and allows users within the vendor's organization to be displayed in the users section 262 on a group level.

The usernames 262a in the user section 262 are presented as web page controls linked to user profile pages. FIGS. 6i to 6k show the user profile pages associated with the user identified in the users section 262 of the users page 260.

The user profile pages include a properties page 270, a security page 280 and a groups page 282. The properties page 270 includes a user name field 270a, a name field 270b, a vendor organization field 270c, contact information fields 270d and 270e, an e-mail address field 270f and a position field 270g. The properties page 270 also includes a security settings section 272 including a user password field 272a and a contact field 272b. The security settings section 272 indicates the security level assigned to the user in a text field 272c above the password field 272a. An icon 274 adjacent the user name field 270a provides a visual indication of the security level assigned to the user.

The security page 280 as shown in FIG. 6j identifies the permissions assigned to the user with respect to administration, catolog, report, log, Internet retailer, vendor, product/SKU and deal functions.

The groups page 282 as shown in FIG. 6k identifies by name 282a and icon 282b the group(s) to which the user belongs.

The preferences page 290 as shown in FIG. 6l includes a categorization setup section 292, a brand list setup section 294 and an attributes setup section 296. The categorization setup section 292 identifies the UNSPEC categories of the products offered by the vendor. The brand list setup section 294 identifies the brand name assigned to the products in the categorization setup section 292. The attributes section 296 identifies the attributes of the products in the categorization setup section 292. The information entered in these sections is used to populate the brand, primary product attributes and primary category fields in the product properties pages.

Graphical User Interface—Internet Retailer Access

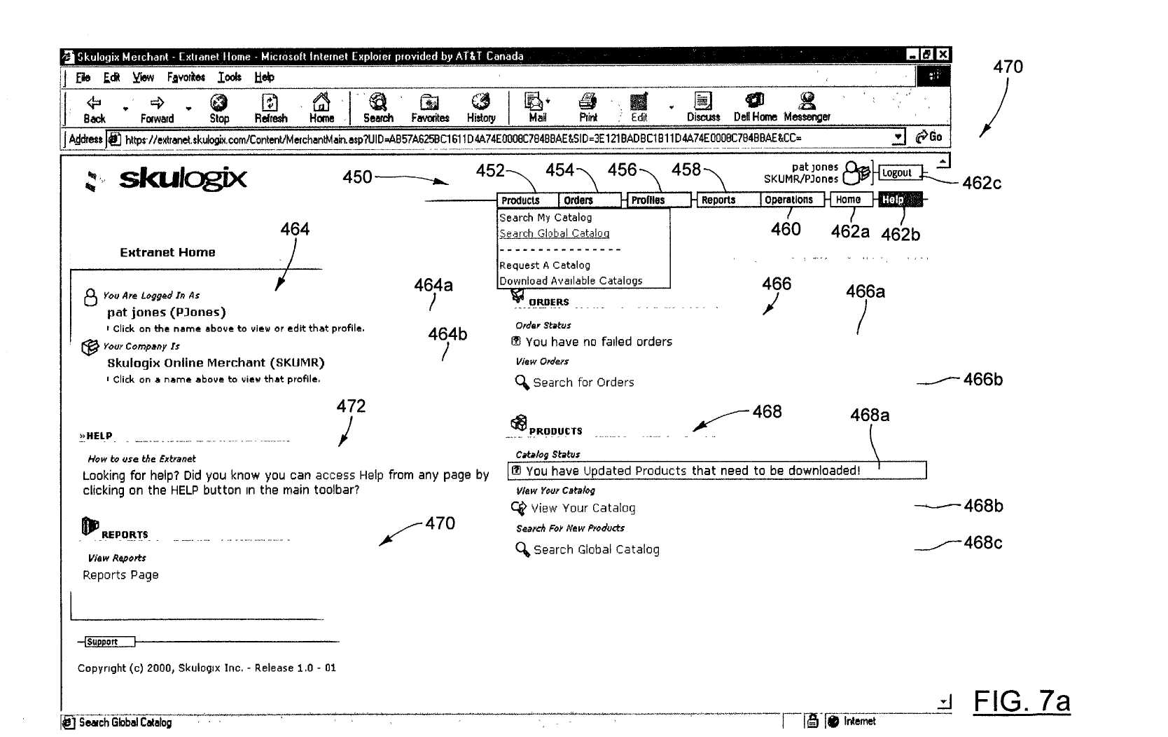

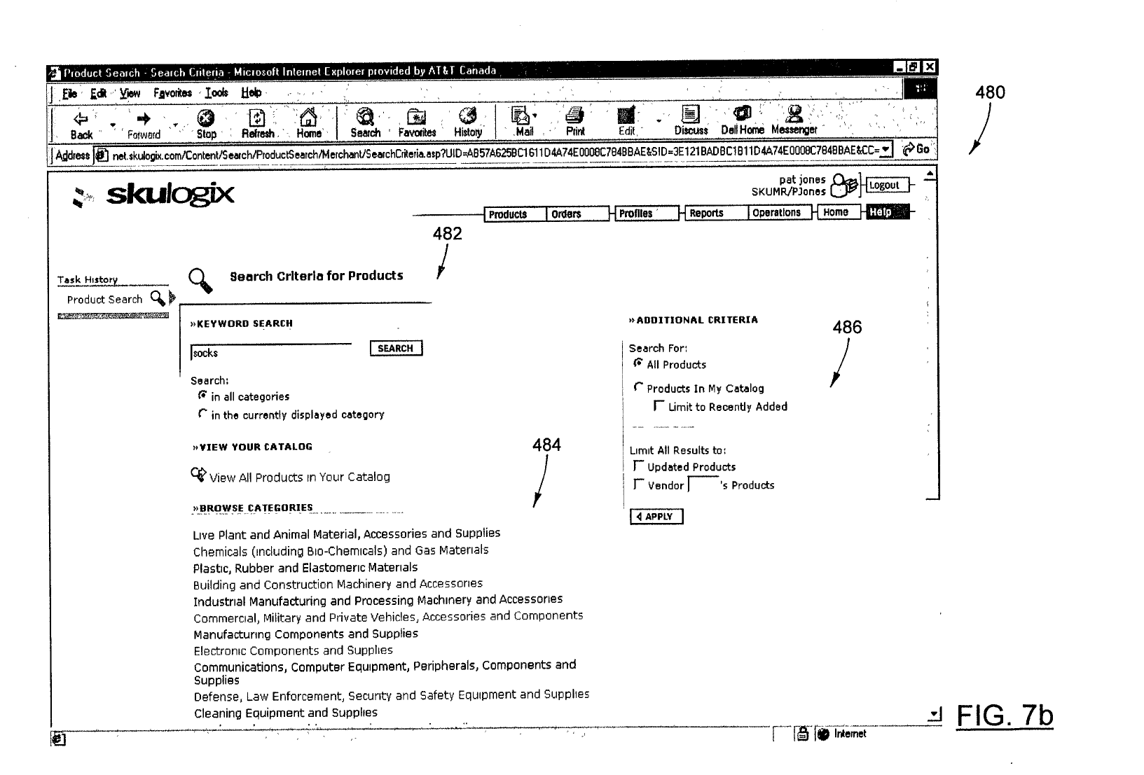

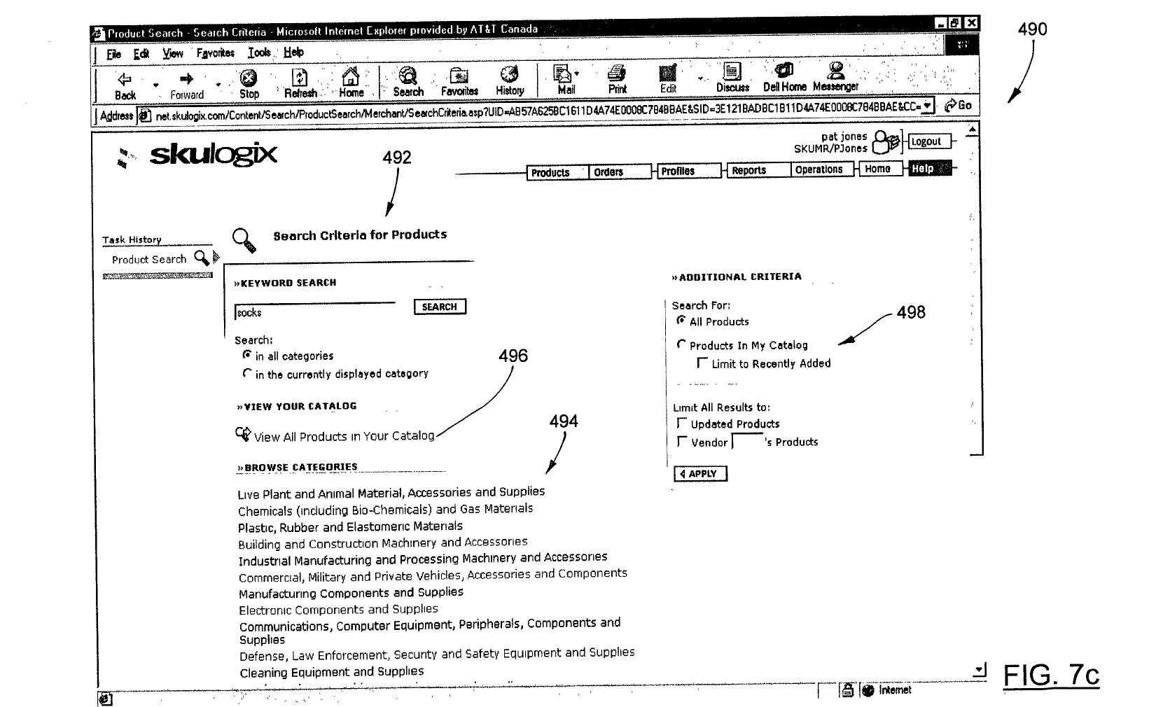

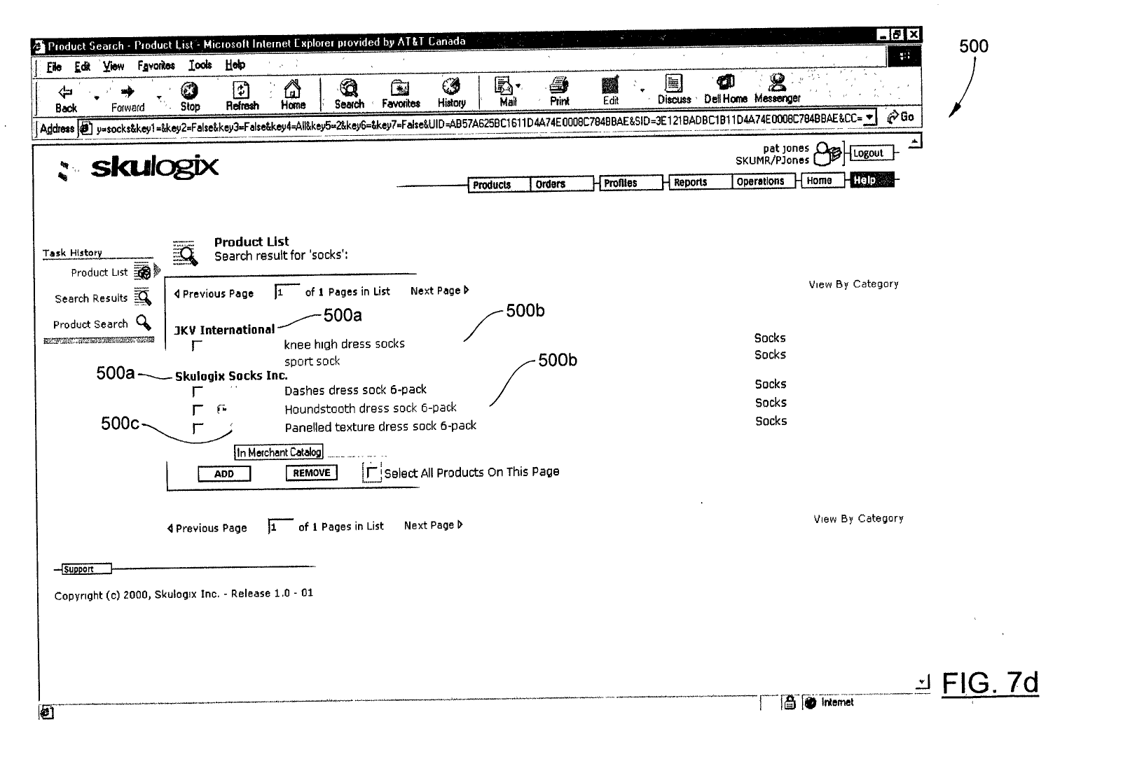

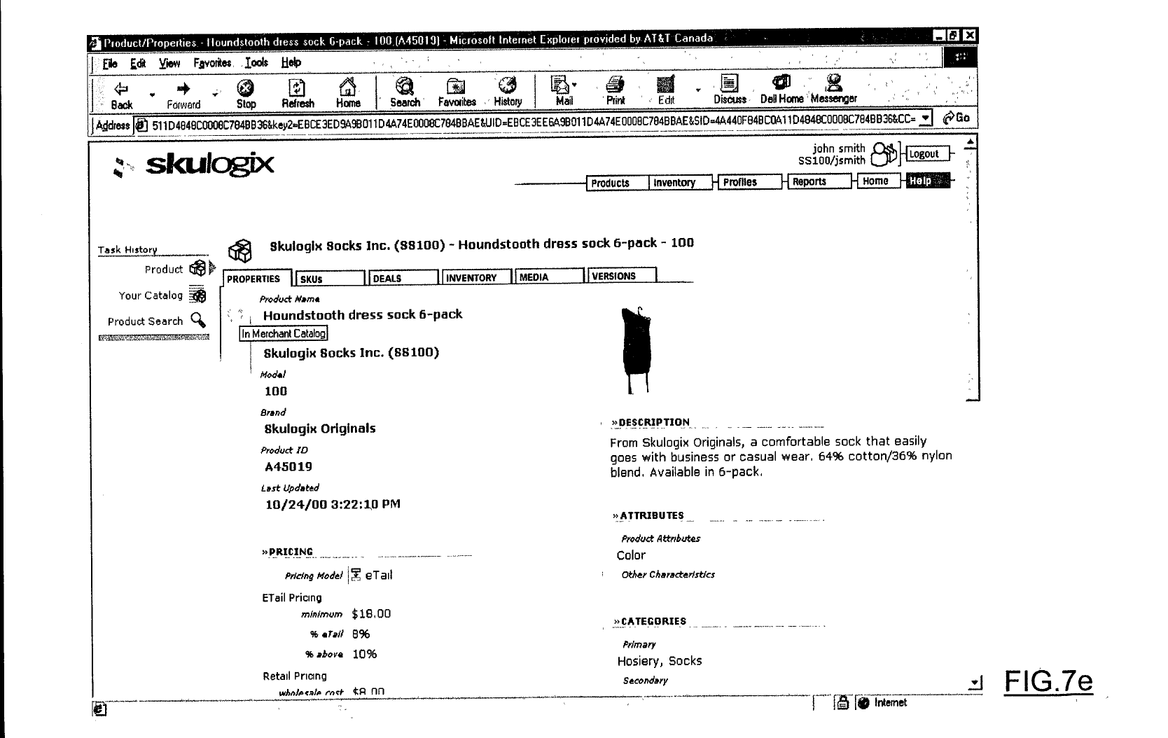

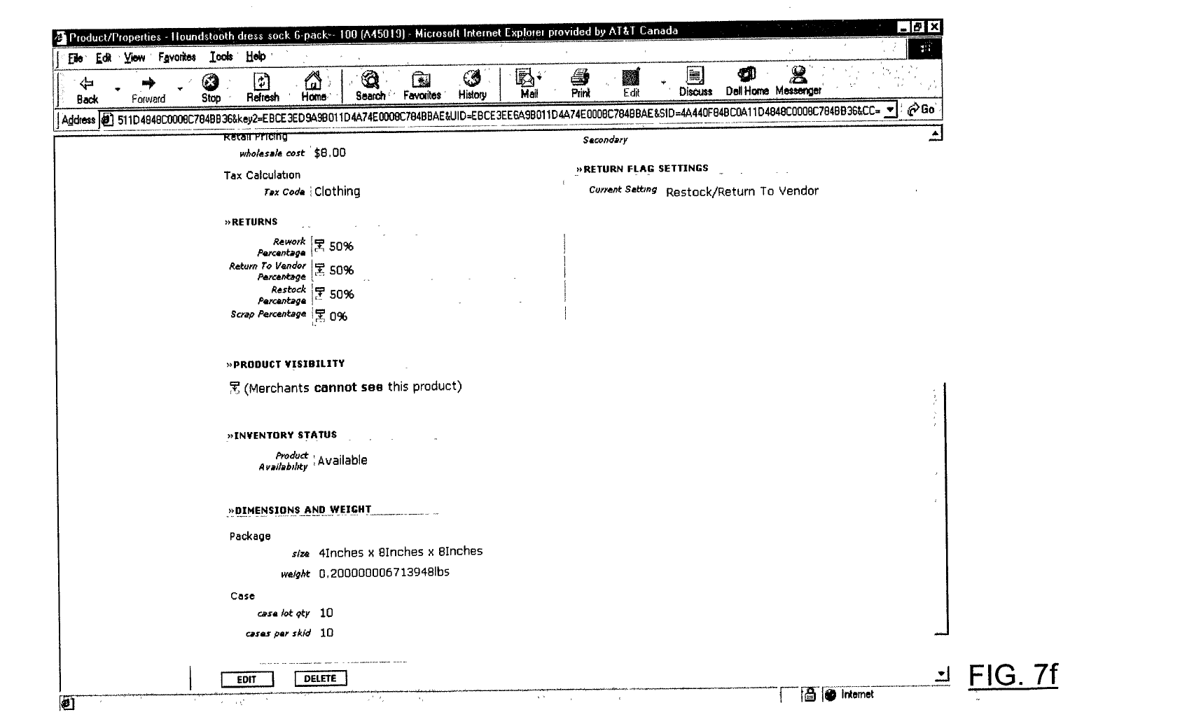

When an Internet retailer completes the login process, the Internet retailer is presented with a home page 448 having a tool bar 450 adjacent the upper right-hand corner of the home page 448 as shown in FIG. 7a. The tool bar 450 includes a plurality of selectable tool bar options. The tool bar options include a products option 452, an orders option 454, a profiles option 456, a reports option 458, an operations option 460 and conventional home, help and logout options 462a to 462c respectively. Selecting any one of the products, inventory, profiles or reports options exposes a drop down menu that presents the selections available under the selected option.

The home page 448 also includes an Internet retailer information section 464, an orders section 466, a products section 468, a reports section 470 and a help section 472.

The Internet retailer information section 464 includes fields 464a and 464b that display the name of the user who completed the login process and the name of the Internet retailer. The user's name and the Internet retailer's names are displayed as web page controls linked to profile pages associated with the user and the Internet retailer. Selecting the user's name exposes the user's profile page allowing the user's profile to be viewed and edited. Selecting the Internet retailer's name exposes the Internet retailer's profile allowing it to be viewed.

The orders section 466 includes an order status field 466a and a view orders field 466b. The order status field 466a displays a web page control that provides an indication as to whether the Internet retailer has any failed orders. Selection of the web page control opens a page that presents a list of failed orders. The view orders field 466b displays a web page control that is linked to a search engine. The search engine allows the Internet retailer to search the inventory database 14q for orders that have been fulfilled, are pending or have failed.

The products section 468 includes a catalog status field 468a, a view your catalog field 468b and a search for new products field 468c. The catalog status field 468a provides an indication as to whether the Internet retailer product catalog includes products associated with product information pages that have been updated by the vendor. The view your catalog field 468b displays a web page control that opens a page listing all of the products in the Internet retailer product catalog stored in the product database 14p. The search for new products field 468c displays a web page control that is linked to a search engine. The search engine allows the Internet retailer to search for all products listed in the global product catalog that have been designated as white or grey and for products that have been designated as black but for which the the Internet retailer has been identified by the vendor as being authorized to sell the products.

Products Option

Selection of the products option 452 exposes a drop down menu 452a including a search my catalog option, a search global catalog option (which is equivalent to selecting the web page control 468c), a request a catalog option and a download available option as shown in FIG. 7a. Each option in the drop down menu 452a is displayed as a web page control linked to an underlying page. Selecting the search my catalog option opens a page 480 displaying a search engine 482 as shown in FIG. 7b The search engine allows the Internet retailer to search their Internet retailer product catalog for products by keyword across all categories or in the category highlighted in the browse section 484 of the search engine. Additional search criteria fields 486 allow keyword searches to be further refined. Selecting a displayed category in the browse section 484 of the search engine 482 displays the underlying UNSPEC subcategory. The page 480 also includes a “view all products in your catalog” web page control 488. Selection of the web page control 48 allows all of the products in the Internet retailer product catalog to be displayed.

Selecting the search global catalog option opens a page 490 displaying a search engine 492 as shown in FIG. 7c. The search engine 492 allows the Internet retailer to search the global product catalog by keyword for vendors' products that have been posted to the ETS 14. The search can be performed across all categories or limited to highlighted categories displayed in a category section 494.

All of the products in the Internet retailer product catalog can be displayed by selecting an “view all products in your catalog” web page control 496. Searching can be further refined using additional criteria fields 498. The additional criteria fields allow searches to encompass all products or to be limited to products in the Internet retailer product catalog, updated products and/or products associated with a specified vendor.

FIG. 7d shows the results of a search for a specific product performed using the search engine of FIG. 7c as presented on a product list page 500. The product list page 500 identifies the names 500a of the vendors selling the products and the names 500b of the products. If a displayed product has been designated as white, then the product can be selected by the Internet retailer for incorporation into the Internet retailer product catalog. Icons 500c provide a visual indication if the product is in the Internet retailer product catalog. The product names 500a are presented as web page controls that open product information pages. These product information pages are similar to the product information pages shown in FIGS. 4a, 4b, 4c, 4e and 4f but exclude vendor sensitive information. For example, FIGS. 7e and 7f show the properties pages associated with a product selected from a product list.

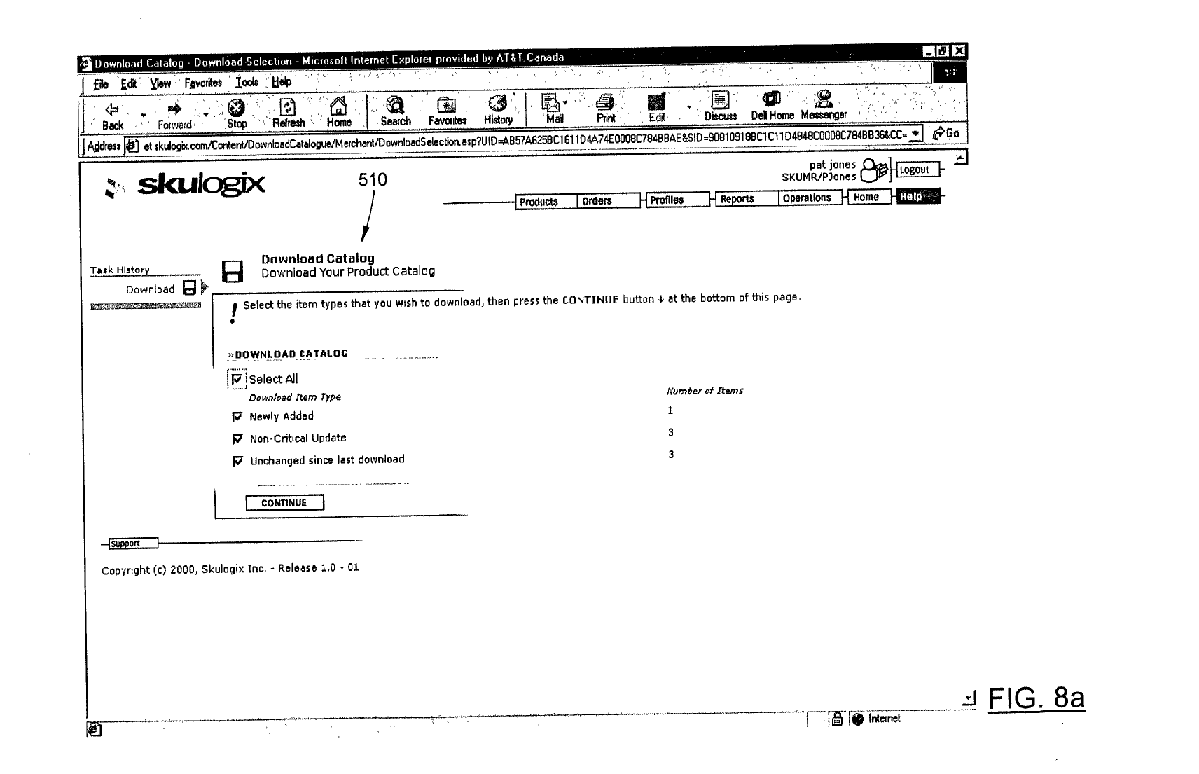

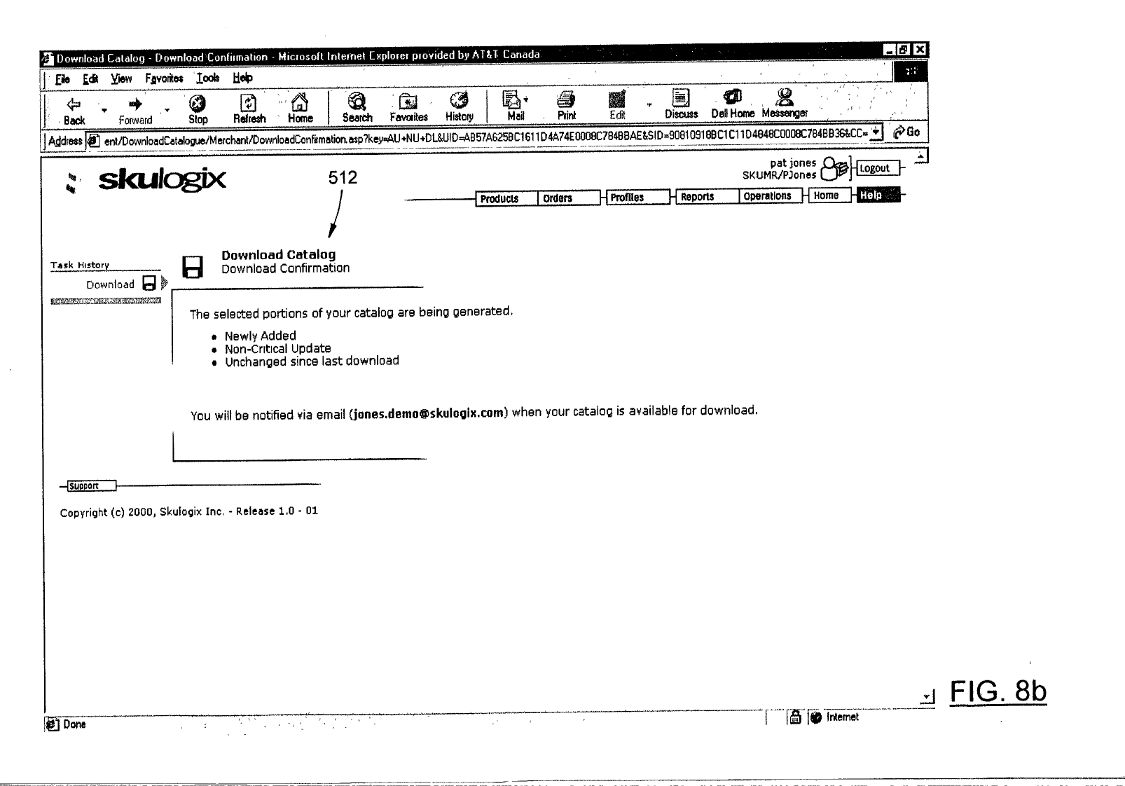

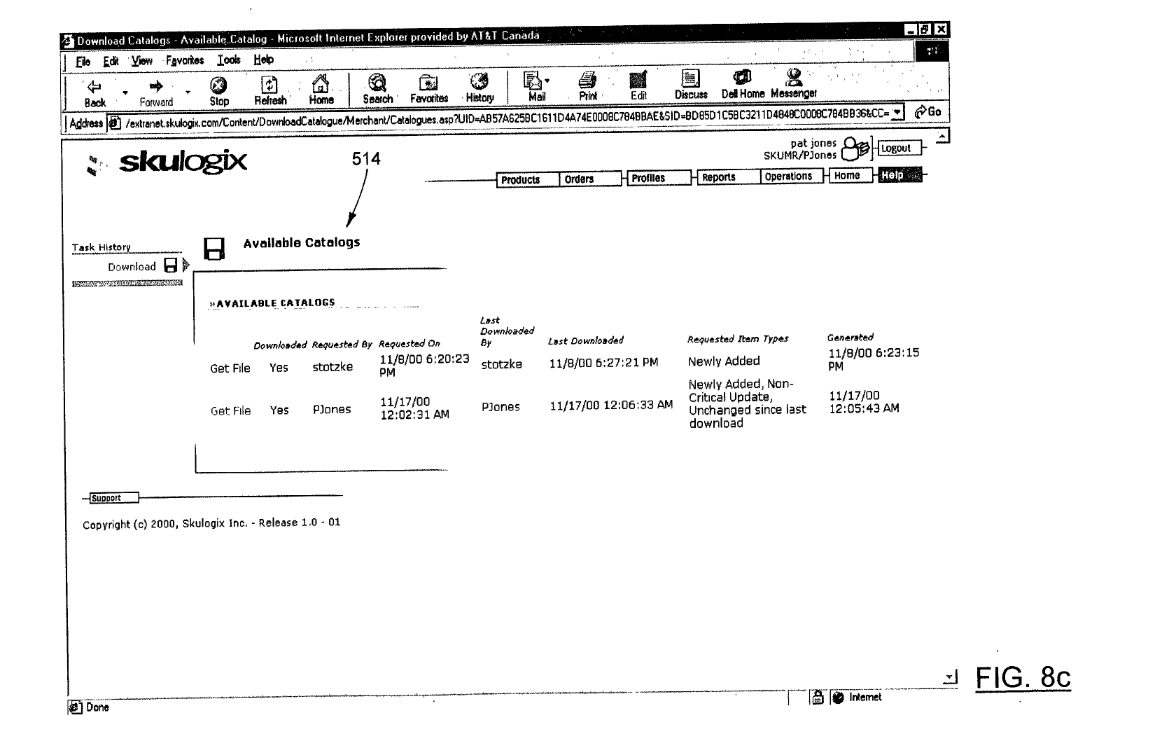

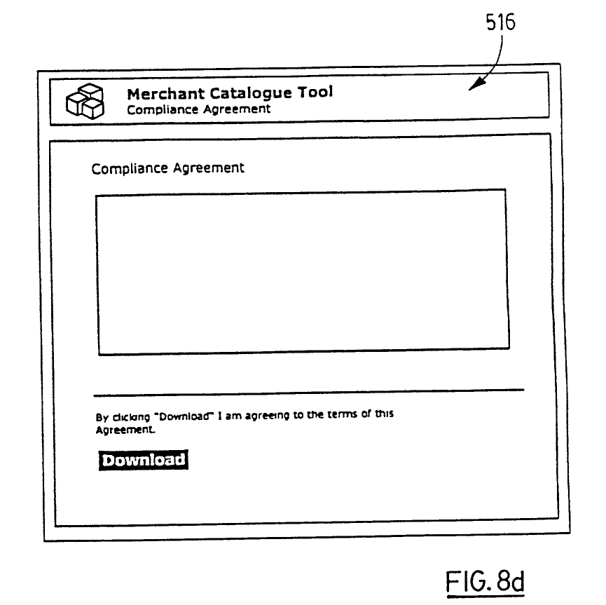

Selection of the request a catalog option opens a download catalog page 510 as shown in FIG. 8a. The download catalog page 510 identifies the number of new products added to the Internet retailer product catalog, the number of products existing in the Internet retailer product catalog where critical updates have been made to the product information pages associated with the products by vendors, the number of products existing in the Internet retailer product catalog where non-critical updates have been made to the product information pages associated with the products by vendors, and the products existing in the Internet retailer product catalog whose associated product information changes have not been changed since the last catalog download. Selected categories or all categories can be selected for download. Once selected, a page 512 is presented to the Internet retailer identifying the catalog categories being prepared for download as shown in FIG. 8b. Selection of the download available catalogs option opens an available catalogs page 514 presenting a list of available catalogs that can be downloaded as shown in FIG. 8c. Selection of the get file web page control causes the ETS 14 to download the catalog to the Internet retailer's client computer system in XML format so that the product may be advertised for sale by the Internet retailer through their electronic storefront.

Once the information to be downloaded is selected, the Internet retailer is presented with a request 516 (see FIG. 8d) to confirm the Internet retailer's understanding that rules of exchange apply to the products they wish to offer for sale on their electronic storefront. The compliance agreement sets out the minimum price the Internet retailer is able to sell the product if the Internet retailer is appointed as a sales agent and other terms surrounding the sale of the product set by the vendor. Selecting the download button 516a is considered acceptance of the terms of the rules of exchange. The above described operations are handled by the catalog engine 14d.

Orders Option

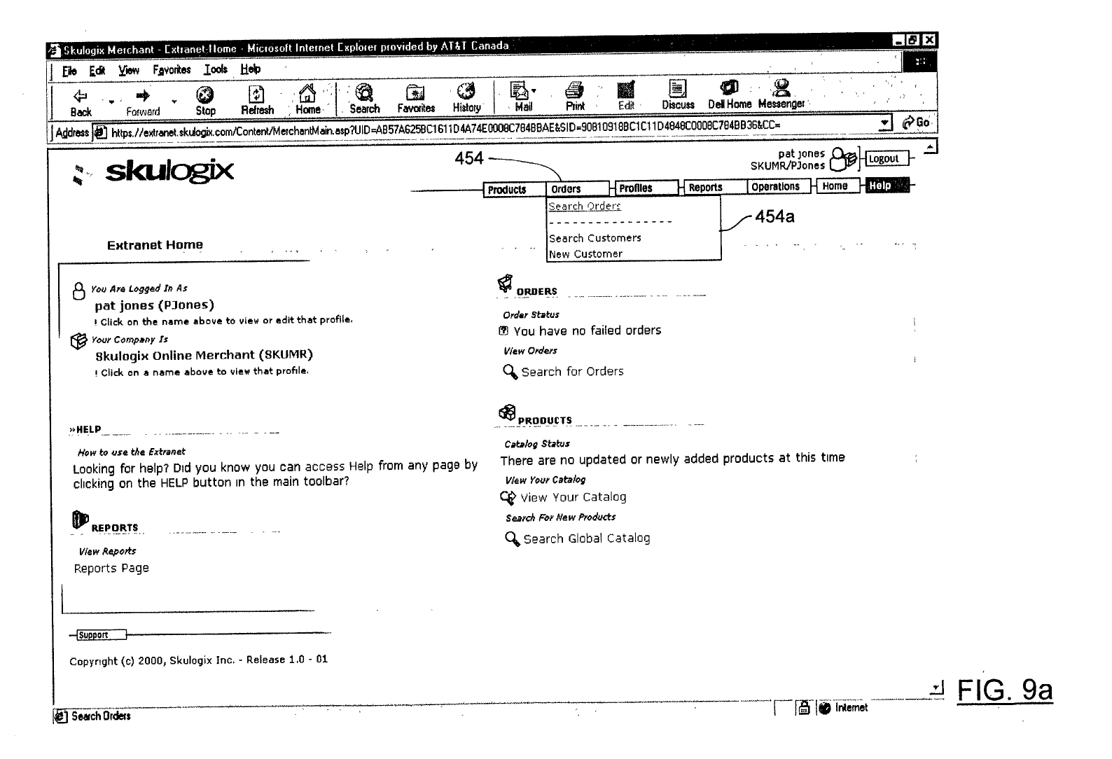

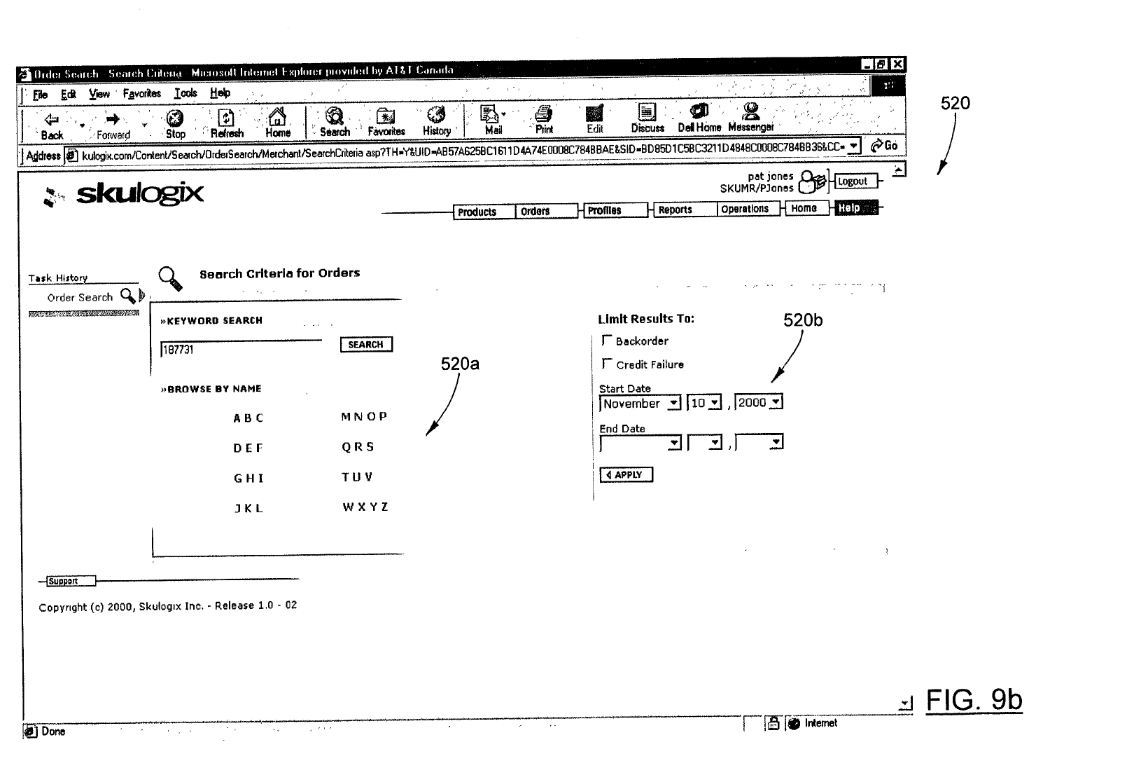

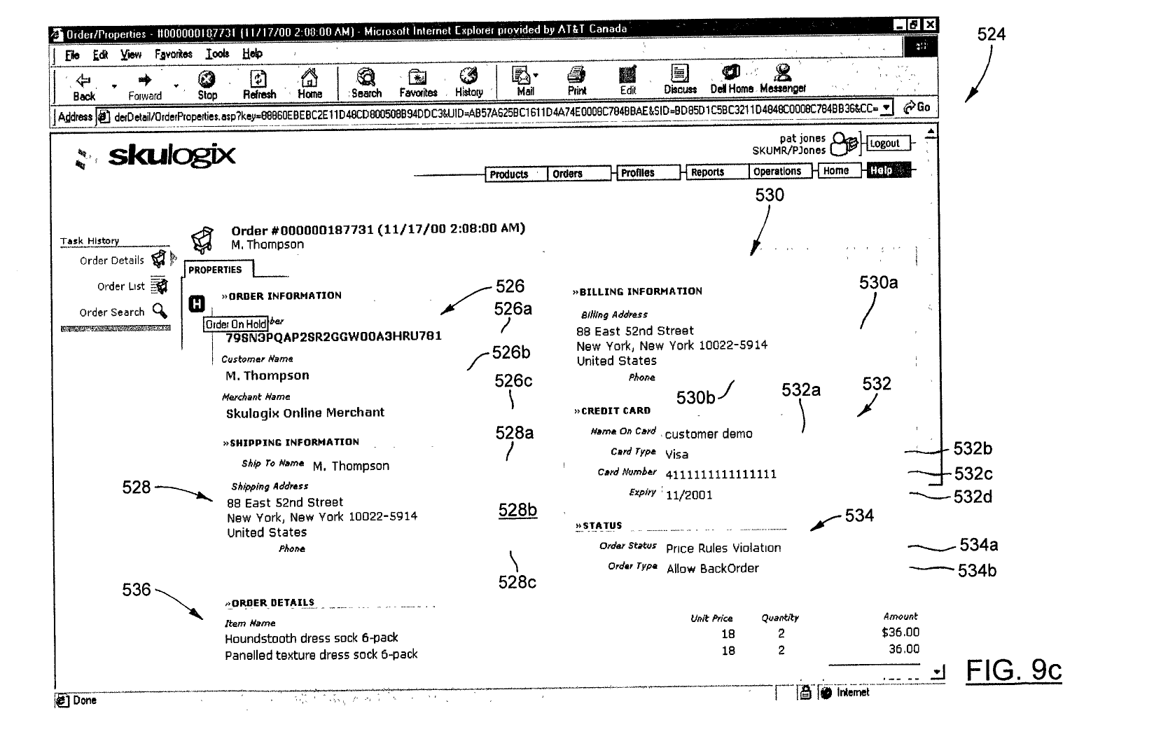

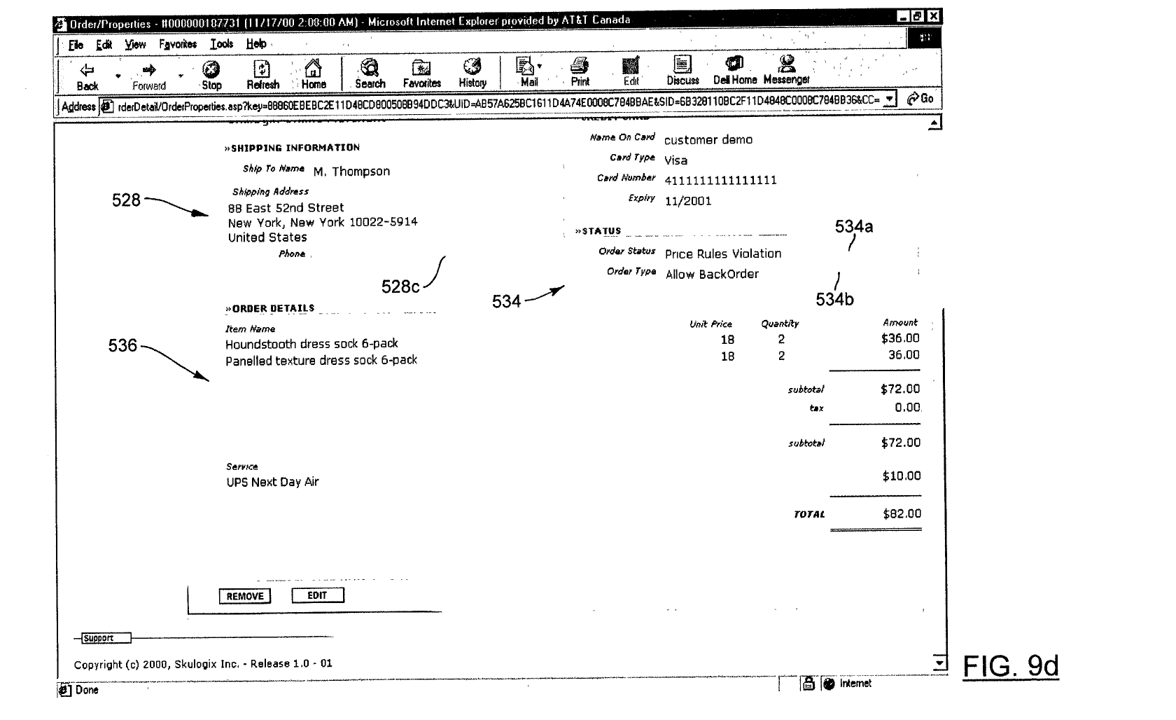

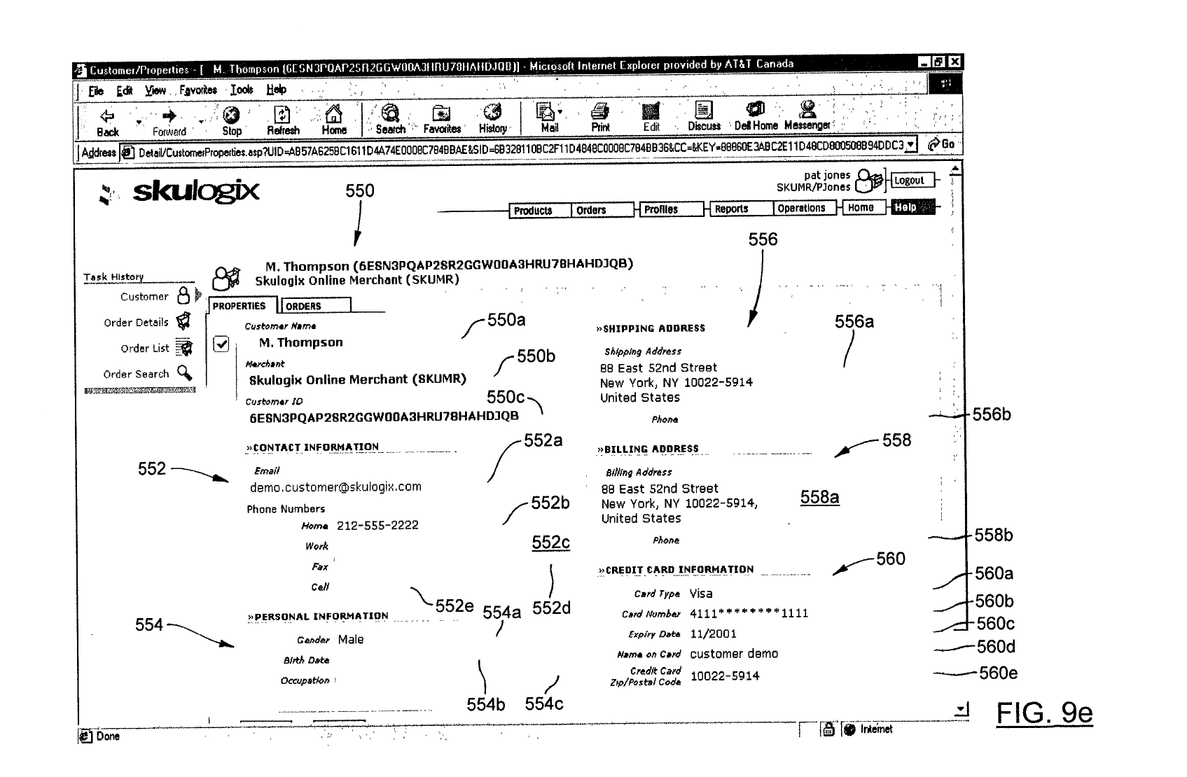

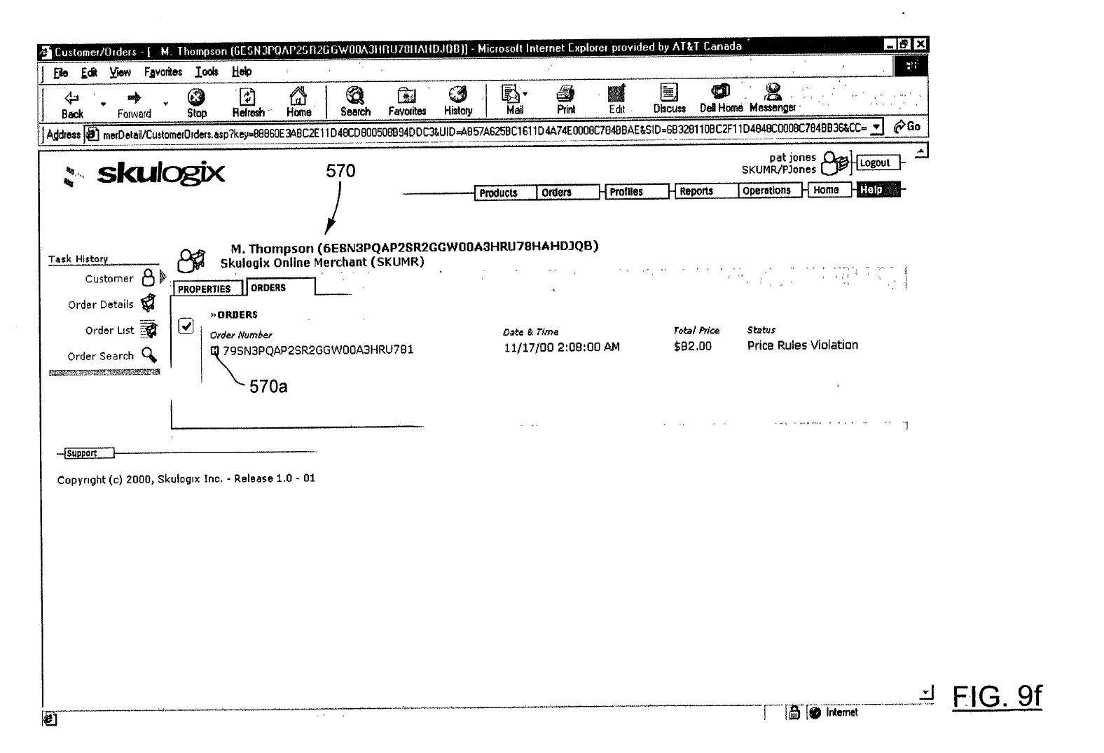

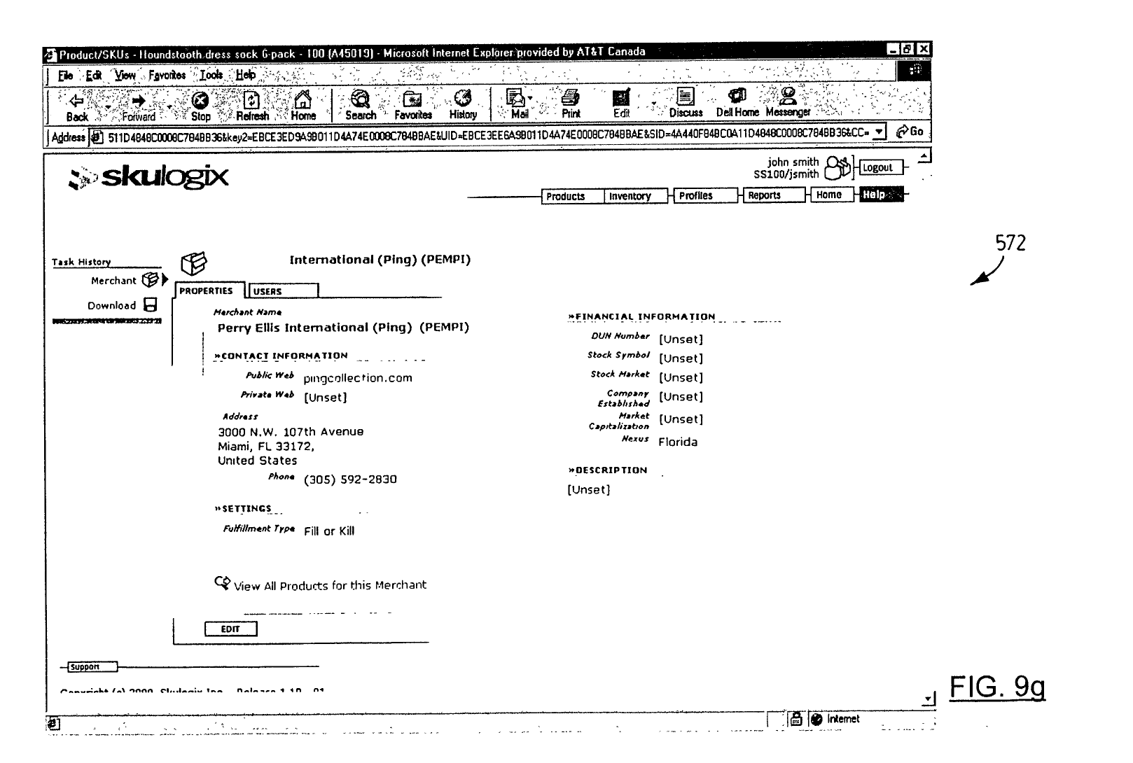

Selection of the orders option exposes a drop down menu 454a including a search orders option, a search customers option, and a new customers option as shown in FIG. 9a. Each option is displayed as a web page control linked to an underlying page.

Selecting the search orders option opens a page 520 displaying a search engine as shown in FIG. 9b. The search engine allows the Internet retailer to search product orders made by customers by keyword. Searches for orders can also be performed alphabetically by customer name using a browse by name function 520a. Additional criteria fields 520b can be used to limit the search to orders that are on backorder, orders that failed due to a customer credit fail and/or orders received during a specified time frame.

FIGS. 9c and 9d show an order page 524 generated in response to an order search performed using the search engine of FIG. 9b. As can be seen, the order page 524 includes an order information section 526, a shipping information section 528, a billing information section 530, a credit card section 532, a status section 534 and an order details section 536. The order information section 526 includes an order number field 526a, a customer name field 526b and an Internet retailer field 526c. The shipping information section 528 includes fields 528a to 528c identifying the name and address of the entity to which the order is to be shipped. The billing information section 530 includes fields 530a and 530b for the address and telephone number of the customer being billed for the order. The credit card section 532 includes fields 532a to 532d for customer credit card information. The status section 534 includes an order status field 534a and an order type field 534b, which display the order status and the order type. The orders detail section 536 identifies the products included in the customer order by name, the unit price charged to the customer, the number of products purchased by the customer and the total amount charged to the customer including shipping costs.

The customer's name presented in the customer name field 526b is presented as a web page control that is linked to customer profile pages. The customer profile pages include a properties page 550 and an orders page 570 as shown in FIGS. 9e and 9f.

The properties page 550 includes a customer name field 550a, an Internet retailer field 550b and a customer number field 550c. The properties page 550 also includes contact information, personal information, shipping and billing address and credit card information sections 552 to 560 respectively. The contact information section 552 includes fields 552a to 552e for an e-mail address, and telephone and facsimile numbers. The personal information section 554 includes fields 554a to 554c for gender type, birth date and occupation. The shipping and billing address sections 556 and 558 include address and telephone number fields 556a, 556b, 558a and 558b. The credit card information section 560 include fields 560a to 560e for receiving custom credit card information.

The orders page 570 displays a list of orders made by the customer by order number. The date and time of each order, the order amount and the status of each order is also shown. An icon 570a provides a visual indication of the order status.

Profiles Option

Selection of the profiles option 458 from the tool bar 450 exposes a drop down menu including a “my company's profile and preferences” option that is presented as a web page control linked to underlying pages. Selecting the “my company's profile and preferences” option opens Internet retailer detail pages presenting Internet retailer information stored in the Internet retailer/vendor database 14o. In the present embodiment, the Internet retailer detail pages include a properties page and a users page. Each page can be exposed by selecting the tab at the top of the respective page. The properties page 572 as shown in FIG. 9g is similar to page 230 and includes an Internet retailer name field, a contact information section, a financial information section and a description section. In addition, the properties page includes a settings section that allows the Internet retailer to determine their order fulfillment type. The order fulfillment type may for example be set either to Fill or Kill, Split Ship or Entire Order

Operations Option

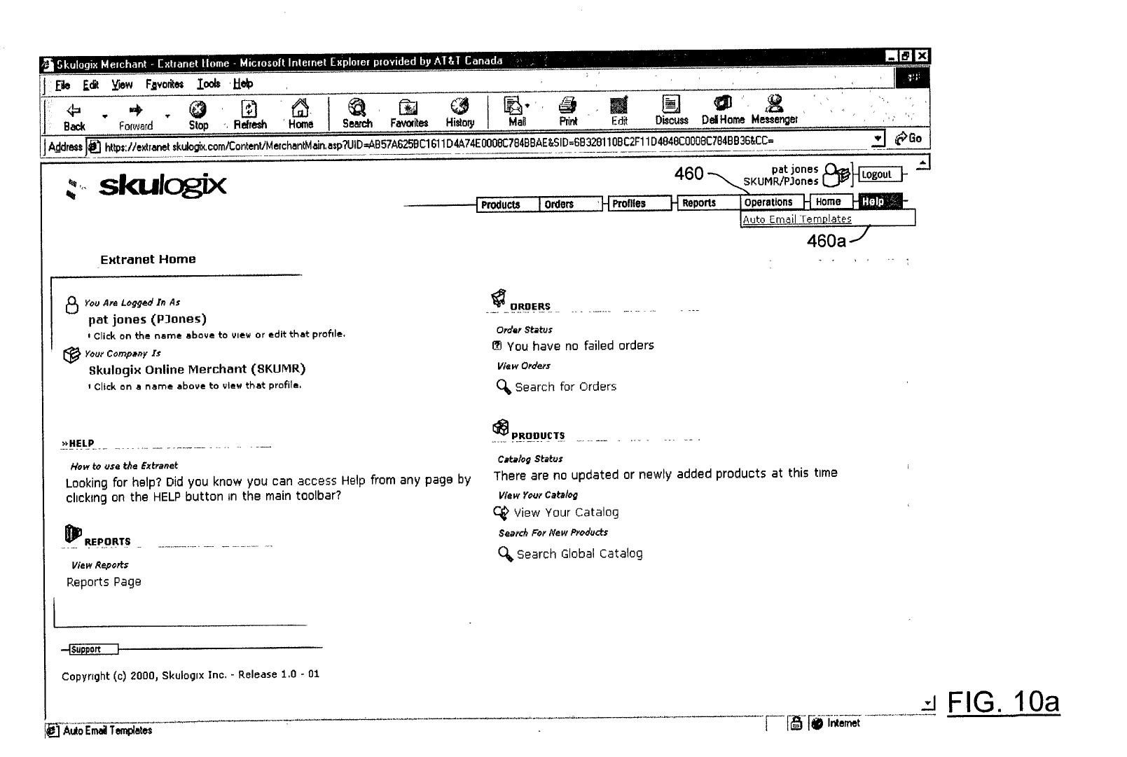

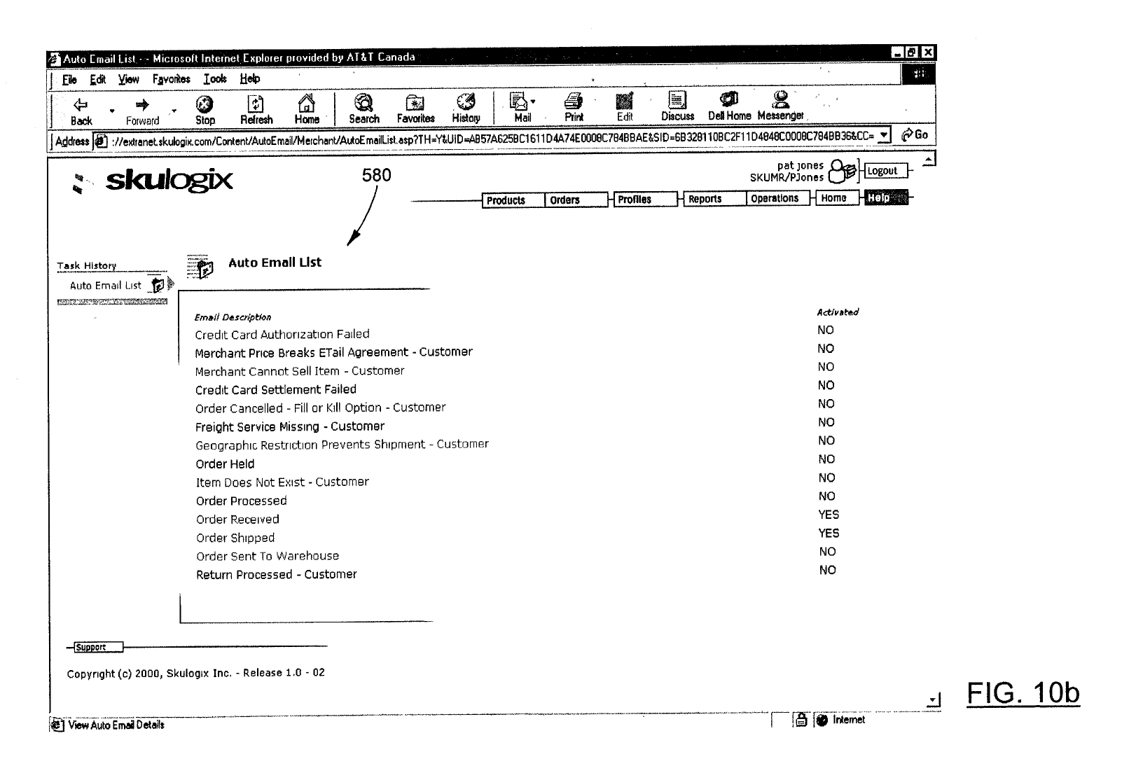

Selection of the operations option from the toolbar 450 exposes a drop down menu 460a (see FIG. 10a) including an auto e-mail template option that is displayed as a web page control linked to an underlying page. Selecting the auto e-mail template option, opens a page 580 (see FIG. 10b) displaying a list of canned e-mail responses that can be generated by the ETS when certain actions occur and an indication as to whether the e-mail responses are active. The canned e-mail responses are displayed as web page controls linked to associated e-mail message pages (not shown). Opening an e-mail message page allows the active state of the e-mail response to be changed and allows the text of the e-mail response to be edited.

Task History

During ETS access by an Internet retailer or vendor, as the Internet retailer or vendor navigates through the ETS 14, a history of the pages of the ETS that are viewed is dynamically built by the ETS and is presented as a stack of icons beside the current page being viewed. The icons in the stack can be selected to allow the user to navigate back and forth quickly to previously viewed pages.

ETS Operation—Customer Order—Processing

When the ETS 14 detects an order made by a customer through an Internet retailer's electronic storefront (block 600), the commerce engine 14f parses the order and checks the order for appropriate formatting (block 602). If the order is not in the correct format, the ETS 14 sends an e-mail message to the appropriate user in the Internet retailer's organization (block 604).

If the order is in the correct format, an e-mail is sent to the customer confirming receipt of the order (block 606) and an Internet retailer credit check is performed (block 608). If the amount owing is greater than the preset amount for that Internet retailer, the order is held (block 610) and the Internet retailer, and/or the customer, if the appropriate canned e-mail response is active, are notified by e-mail that the order has been held (block 612).

If the amount owing by the Internet retailer is less than the preset amount, the amount owing by the vendor(s) supplying the product(s) is checked (block 614). If the amount owing by a vendor is greater than the preset amount for that vendor, the product(s) belonging to that vendor included in the order is held (block 616). The vendor, and the customer, if the appropriate canned e-mail response is active, are notified by e-mail that product(s) have been held from the order (block 618).

If none or only part of the order is held, the ETS 14 examines the customer data to determine whether the customer exists in the customer database 14r (block 620). If the customer does not exist, a new customer entry is created requiring the customer to submit the required information (block 622). If the customer exists, the customer data is updated if necessary and an entry is added to the logging database (blocks 624, 626 and 628).

The customer's credit card information is then conveyed to the tax calculation and credit card authentication and settlement system 22 for authorization for the purchase price of the order (block 630). If credit card authorization is denied, the order is held and the Internet retailer and customer, if appropriate, is notified by e-mail (blocks 632 and 634). An entry is also added to the logging database.

If credit card authorization is given, items in the order are checked to determine item pricing and designated pricing model (block 636). For items where the Internet retailer acts as a sales agent, the item pricing is checked to validate the pricing for minimum etail. If the pricing for an item is below minimum etail, the ETS 14 checks to determine if there is an exception for that item at the SKU level, if a deal exists for the Internet retailer at the product level, or if a deal exists for the Internet retailer at the SKU level (block 638). If there is no exception or deal, the status of the order is changed to held since this signifies an Internet retailer's non-compliance with the accepted rules of exchange and the customer, if appropriate, and Internet retailer are notified by e-mail (blocks 638 and 640). An entry is also added to the logging database. If there is an exception or deal, the items are validated at the Internet retailer etail.

Once the items have been validated, the items are checked for availability in the common pooled repository 30 (block 642). If one or more of the items is not available, different steps are taken depending on the manner in which the Internet retailer permits shipping of orders. If the Internet retailer permits split shipping of orders (block 645), a backorder is created for the unavailable item(s) (block 644). The backordered amount of the item is listed as allocated in the inventory database (block 646). If items remain in the order, the taxation and shipping amounts for the order are recalculated.

If the Internet retailer does not permit split shipping of orders, a backorder for the entire order is created (block 648) and the backordered amount of the items is listed as allocated in the inventory database (block 646).

If the Internet retailer's order indicates “Fill or Kill” shipping, the entire order is canceled (block 650).

If the entire or part of the order can be shipped (if the Internet retailer permits split shipping), the order is checked for a time delay (block 652) before the order is sent to the WMS 16. If the order has no time delay or if the time delay expires, the order is sent immediately to the WMS for fulfillment and an entry is added to the logging database. Otherwise, the order is held until the time delay expires at which time, the order is sent to the WMS 16 for fulfillment and an entry is added to the logging database (blocks 654 and 656). Once the order has been sent, the ETS 14 updates the inventory database 14q for that product (block 646). If the number of items for the product falls below the minimum threshold inventory level, an IRR is generated by the replenishment engine 14k(block 658).

When the WMS 16 receives the order (block 660), the WMS 16 sends an update on the status of the order (block 662). If the entire or part of the order can be shipped (if the Internet retailer permits split shipping), the amount of the order to be shipped is settled on the customer's credit card (block 664) and an entry is added to the logging database. If the credit card settlement fails, the customer is notified by e-mail and the status of the order is changed to validation failed (block 666). The customer CSR group is also updated by e-mail and an entry is added to the logging database.

If the order amount is settled, the vendor product(s) in the order are assembled at the common pooled repository 30 using the fulfillment system 32 and the order is shipped to the customer. An e-mail is also sent to the customer confirming that the order has been shipped (block 668). The status of the order is then changed to fulfilled (block 670).

If a backorder is generated, it is treated the same as a new order, and when the inventory for the missing item(s) arrives at the common pooled repository 30, the backorder is processed in the manner described above.

ETS Operation—Product Information Updates

When a vendor adds a new product to its vendor product catalog or updates existing product information, the product engine 14g parses the product information file and checks for the product information file for formatting (blocks 700 and 702). The product data is then checked to determine whether the product already exists in the vendor product catalog (block 704).

If the product already exists in the vendor product catalog, the product data is updated (block 706). If the product file includes a change to the product description, dimensions, and/or special characteristics, a new version of the product information is created (block 708). Internet retailers who have this product in their Internet retailer product catalog are notified of the update (block 710). If the product update file includes a change to pricing and/or term data, a new deal version for the product is created (block 712). Internet retailers who have this product in their Internet retailer product catalog are notified of the update (block 714) and are required to update their catalog within a specified period of time as previously mentioned. If the product information update includes an update to inventory minimum and maximum inventory threshold levels, the inventory database 14q is updated (block 716). If the minimum inventory threshold level is set to a higher level than actually exists in the inventory database, an inventory replenishment request (IRR) for the most recently set maximum level is generated by the replenishment engine 14k (block 718).

If the product does not exist in the vendor product catalog, the product is added to the vendor product catalog (block 720). A new version and a new deal version are created (blocks 722 and 724) and an inventory replenishment request (IRR) for the maximum inventory level for the new product is generated (block 726).

ETS Operation—Inventory Replenishment

When the inventory level for a product/SKU is lower than the set minimum threshold level or a manual override of the minimum/maximum threshold levels is received, an inventory replenishment request is generated by the replenishment engine 14k (block 800). If the product is new or the replenishment request is a result of a manual override, the inventory replenishment request requires manual approval by the system operator (block 802). If the system operator approves the inventory replenishment request, the ETS 14 sends an inventory replenishment order to the vendor (block 804) that includes the IRR at the appropriate time. If the system operator denies the inventory replenishment request, the inventory replenishment request is placed on hold status and the vendor is notified by e-mail (block 806).

When the vendor receives an inventory replenishment order (block 808), the vendor can ship the requested product/SKU to the system operator or can edit the quantity of the inventory replenishment order by changing the quantity per SKU in the replenishment order prior to shipping the product/SKU to the system operator. When the full product/SKU is shipped, the vendor transmits an advance shipping notice to the system operator advising the system of what was shipped (block 810). The ETS 14 in turn updates the status of the inventory database entry to “arriving”. When the inventory arrives at the common pooled repository 30 and the ETS 14 receives the actual shipping details from the WMS 16, the ETS updates the inventory database 14q to identify the product as available, unless the inventory has already been committed to fulfill orders, and closes the request order (block 812). If the inventory has already been committed to customer orders, the orders are fulfilled and the inventory database is updated to identify any remaining inventory as available.

If less than the full product/SKU is shipped (block 814), the ETS 14 identifies the amount of inventory missing (block 816) and confirms with the vendor the amount shipped (block 810). If the missing inventory is not to be delivered, the request order is closed (block 812).

ETS Operation—Payment

When the credit card transaction has been settled, the system operator pays the Internet retailer, the vendor(s), the shipper and any other entity involved in the transaction. If the agreement between the Internet retailer and the vendor is a sales agency agreement, i.e. etail, the system operator calculates the Internet retailer percentage amounts for sale at minimum etail per item. If the agreement between the Internet retailer and the vendor is a wholesale agreement, the system operator calculates the amount the Internet retailer sold vendor product above wholesale. If the agreement between the system operator and the Internet retailer is to pay the amount per order, the amount to be paid for each item in the order based on the agreement is totaled. The amount of profit for each item based on the wholesale model is totaled and both totals are added. The amount the Internet retailer charges the customer for shipping is added. The amount the Internet retailer is paid by the system operator for a multiple vendor shopping basket is added. The system operator's freight charge is subtracted from the final total and the remaining funds are transferred to the Internet retailer. If the remaining funds are less than zero, the system operator invoices the Internet retailer for the charge.

If the agreement between the system operator and the Internet retailer is to pay the amount per month, the amount to be paid for each item based on the agreement is totaled. The amount of profit for each item based on the wholesale model is totaled. Both totals are added together and the system operator's freight charge is subtracted from the final total. The remaining funds are placed in the system operator's account established for that Internet retailer. The monthly balance is paid to the Internet retailer. If the monthly balance is less than zero, the system operator invoices the Internet retailer for the amount owing.

As will be appreciated, the fulfillment and electronic transaction system allows vendors to control the manner by which Internet retailers offer their products for sale overcoming the concerns of price erosion and channel conflict. As a result, the system allows branded vendors and Internet retailers to transact through a principal/agent relationship.

ETS Summary

By introducing the principal/agent relationship as the model for transactions between Internet retailers and branded vendors, the electronic transaction and fulfillment system brings significant benefits. In particular, the system allows branded vendors to use Internet retailers as an Internet distribution channel, but leaves branded vendors in control of the issues that are most critical to their brands. The system allows branded vendors to avoid the problems of price erosion and channel conflict. The system allows vendors to take advantage of customers that have been aggregated by the Internet retailers, without damaging their existing businesses. The system also allows a branded vendor to control its distribution strategy in a coordinated way, by allowing the branded vendor to manage its agency relationships in an efficient manner. By making branded vendors comfortable with selling their goods through Internet retailers, the system gives Internet retailers access to quality brands.

By creating a central, pooled repository of vendor-owned inventory for the purposes of supplying Internet sales, vendors own their products up until the moment the transaction occurs with the customer. This allows an on-line sale to be a transaction directly between a vendor and a customer, with the Internet retailer simply acting as a sales agent on behalf of the vendor.

In this principal/agent transaction, the Internet retailer acts as an agent for the vendor as follows:

the Internet retailer displays to the customer selected vendor products;

the Internet retailer manages the purchase on behalf of the vendor, accepting payment from the customer on behalf of the vendor; and

the Internet retailer communicates the customer's order on behalf of the vendor.

In exchange for performing these services, the Internet retailer receives a commission from the vendor.

This principal/agent relationship has significant benefits for both the vendor and the Internet retailer. The vendor can manage its relationship with the customer in the way the vendor sees fit. At the same time, the vendor specifies the ‘discretionary ambit’ of the Internet retailer, providing the Internet retailer with a specified level of flexibility appropriate to manage the sale.

Together, this relationship allows the vendor to set the minimum price that an Internet retailer can collect for the sale of a product, but allows the vendor to leave the Internet retailer with the discretionary ambit to charge more than this minimum amount. This relationship also allows the vendor to pay the Internet retailer a commission, which is a function of the minimum sale price of the product, and the amount for which the product is sold above that minimum price.

The principal/agent relationship also allows the vendor to set other ‘rules of exchange’, which limit the Internet retailer's ability to promote the vendor's product, or discount the vendor's product in ways considered to be harmful to the vendor's brand. At the same time, the vendor can provide the Internet retailer with the necessary discretionary ambit required to manage the transaction with the customer, and can provide the Internet retailer with the flexibility to provide the normal services that a customer would expect from an Internet retailer.

As will be appreciated, the fulfillment and electronic transaction system allows vendors to use Internet retailers to offer brand name products for sale without worrying about brand erosion and channel conflict. This is in view of the fact that Internet retailers offering vendor products for sale, agree to and abide by pricing controls established by the vendors. Since the fulfillment and electronic transaction system 12 monitors customer orders made through electronic storefronts, the fulfillment and electronic transaction system can ensure that the vendor products are not sold below minimum etail prices unless deals exist between the vendor and the Internet retailer which permit such sales.

Since a common pool of multiple vendor products is maintained in the common pooled repository 30, customers can create a multiple vendor product shopping basket through a single electronic storefront and receive multiple vendors' products in a single shipment. This of course minimizes shipping charges and simplifies the return process.

Although a preferred embodiment of the present invention has been described, those of skill in the art will appreciate that variations and modifications may be made without departing from the spirit and scope thereof as defined by the appended claims.

What is claimed is:

1. A method of fulfilling on-line sale of products through at least one electronic storefront comprising the steps of:
establishing an inventory of products at a single physical location that are offered for sale through an electronic storefront of at least one Internet retailer, said inventory including products received from a plurality of different vendors; and
assembling products from said inventory that are ordered by a customer through an electronic storefront and shipping the products of said order to said customer.

2. The method of claim 1 wherein products of different vendors in the inventory are offered for sale through electronic storefronts of multiple Internet retailers.

3. The method of claim 2 further comprising the step of allowing vendors supplying products for the inventory to chose the Internet retailers that are permitted to offer their products for sale through electronic storefronts.

4. The method of claim 3 wherein Internet retailers offering vendors' products for sale through electronic storefronts are required to accept rules of exchange established by the vendors.

5. The method of claim 4 further comprising the step of allowing vendors to designate chosen Internet retailers as either sales agents or resellers of the vendors' products.

6. The method of claim 5 wherein when a vendor designates an Internet retailer as a reseller, said vendor establishes a price to be paid by the Internet retailer for selling the product.

7. The method of claim 5 wherein when a vendor designates an Internet retailer as a sales agent, the vendor establishes a minimum price at which the Internet retailer must sell the product.

8. The method of claim 7 wherein when said vendor designates said Internet retailer as the sales agent, the vendor further establishes the percentage commission the Internet retailer is paid for selling the product at the minimum price.

9. The method of claim 8 wherein when said vendor designates said Internet retailer as the sales agent, the vendor further establishes the percentage commission the Internet retailer is paid for selling the product above the minimum price.

10. The method of claim 8 further comprising the step of allowing the vendor to establish deals with selected Internet retailers.

11. The method of claim 3 wherein products in said inventory is received from said vendors on a consignment basis.

12. The method of claim 11 further comprising the step of monitoring the levels of products in said inventory.

13. The method of claim 12 wherein during said monitoring step, the level of each product is examined to detect when the level drops below a minimum threshold level.

14. The method of claim 13 further comprising the step of generating an order for more product when the level of a product in the inventory drops below the minimum threshold level.

15. The method of claim 14 wherein said order is generated automatically and is sent to the vendor of the product electronically.

16. The method of claim 14 wherein the order requests enough product to raise the level of the product in the inventory to a maximum threshold level.

17. The method of claim 16 wherein during said monitoring step, the level of each product is also examined to detect when the level exceeds said maximum threshold level.

18. The method of claim 3 wherein products in the inventory are listed in a global catalog that is accessible on-line to Internet retailers, products listed in said global catalog only being accessible to Internet retailers that are permitted to offer the products for sale.

19. The method of claim 18 wherein vendors assign a product visibility designation to each of their products listed in said global catalog, the product visibility designation assigned to a product determining whether Internet retailers can view and/or select that product to offer for sale.

20. The method of claim 19 wherein products selected from said global product catalog by an Internet retailer are added to an Internet retailer product catalog associated with that Internet retailer, said Internet retailer product catalog being downloaded to said Internet retailer so that information concerning said selected products can be presented to on-line customers through the Internet retailer's electronic storefront.

21. The method of claim 20 wherein when a vendor updates information associated with a product listed in the global catalog, that is also listed in an Internet retailer product catalog, a request is generated for the Internet retailer to update their Internet retailer product catalog.

22. The method of claim 21 wherein when critical information associated with said product is updated, the request specifies a time frame by which said Internet retailer must update their Internet retailer product catalog.

23. A method for facilitating electronic commercial transactions between Internet retailers and vendors, comprising the steps of:
allowing vendors to select Internet retailers permitted to offer for sale products of the vendors and to establish rules of exchange by which selected Internet retailers are permitted to sell products of the vendors; and
monitoring the manner by which the selected Internet retailers sell products of the vendors to on-line customers to ensure compliance with the established rules of exchange and thereby inhibit Internet retailers from selling products in a manner that potentially causes brand erosion and/or channel conflicts with conventional retailers of products of the vendors.

24. The method of claim 23 wherein said vendors designate said selected Internet retailers as either sales agents or resellers.

25. The method of claim 24 wherein when a vendor designates an Internet retailer as a reseller, said vendor establishes a price to be paid by the Internet retailer for selling the product.

26. The method of claim 24 wherein when a vendor designates an Internet retailer as a sales agent, the vendor establishes a minimum price at which the Internet retailer must sell the product.

27. The method of claim 26 wherein when said vendor designates said Internet retailer as the sales agent, the vendor further establishes the percentage commission the Internet retailer is paid for selling the product at the minimum price.

28. The method of claim 27 wherein when said vendor designates said Internet retailer as the sales agent, the vendor further establishes the percentage commission the Internet retailer is paid for selling the product above the minimum price.

29. The method of claim 26 further comprising the step of allowing a vendor to establish deals with selected Internet retailers.

30. The method of claim 29 wherein a deal permits a selected Internet retailer to offer a product for sale below said minimum price.

31. The method of claim 29 wherein a deal awards a selected Internet retailer a higher commission for selling said product.

32. A method for electronic commerce between branded vendors and Internet retailers comprising the steps of:
allowing Internet retailers to display products of different vendors for sale through electronic storefronts;
allowing Internet retailers to manage purchases of the products offered for sale by on-line customers on behalf of the vendors; and
communicating the purchases to a pooled repository holding the products of the different vendors to allow the purchases to be fulfilled.

33. The method of claim 32 wherein the products are held in said repository on a consignment basis and wherein purchases are fulfilled when payments are received.

34. A method of managing inventory in a common pooled repository, said inventory including products from a plurality of different vendors, said method comprising the steps of:
establishing minimum and maximum threshold levels for each product held in said common pooled repository;
as product in said repository is shipped to fulfill product orders and as product is received from vendors to replenish inventory, comparing the level of each product with the established threshold levels; and
when a product level falls below the established minimum threshold level, generating an order for more of that product.

35. The method of claim 34 wherein said order is generated automatically and is sent to the vendor of the product electronically.

36. The method of claim 34 wherein the order requests enough product to raise the level of the product in the inventory to the maximum threshold level.

37. A system to enable Internet retailers to sell products of different vendors on-line through electronic storefronts comprising:
a facility storing an inventory of products received from a plurality of different vendors; and
an electronic transaction system (ETS) including a global product catalog listing the products in said inventory, said ETS being accessible to said Internet retailers to enable said Internet retailers to view products listed in said global catalog and to select products in said global catalog that said Internet retailers wish to offer for sale, information concerning selected products being downloaded to the Internet retailers for display on their electronic storefronts, said ETS receiving orders for products made through electronic storefronts of said Internet retailers and conveying said orders to said facility to enable said facility to assemble and ship the products in the orders from the inventory thereby to fulfill the orders.

38. A system according to claim 37 wherein products in said global catalog are only accessible to Internet retailers that are permitted to offer the products for sale.

39. A system according to claim 38 wherein vendors assign a product visibility designation to each of their products listed in said global catalog, the product visibility designation assigned to a product determining whether Internet retailers can view and/or select that product to offer for sale.

40. A system according to claim 39 wherein products selected from said global product catalog by an Internet retailer are added to an Internet retailer product catalog associated with that Internet retailer, said Internet retailer product catalog being downloaded to said Internet retailer.

41. A system according to claim 40 wherein when a vendor updates information associated with a product listed in the global catalog, that is also listed in an Internet retailer product catalog, said ETS generates a request for the Internet retailer to update their Internet retailer product catalog.

42. A system according to claim 41 wherein when critical information associated with said product is updated, the request generated by said ETS specifies a time frame by which said Internet retailer must update their Internet retailer product catalog.

43. A system according to claim 38 wherein said ETS presents a compliance agreement to Internet retailers prior to downloading said product information, said product information being downloaded upon acceptance of said compliance agreement.

44. A system according to claim 43 wherein said compliance agreement includes rules of exchange governing the manner by which Internet retailers are required to sell products of said vendors.

45. An electronic transaction system (ETS) to facilitate interaction between product vendors and Internet retailers wishing to offer products of vendors on-line through electronic storefronts, said ETS comprising:
a global product catalog listing the products of said vendors;
means for enabling Internet retailers to view products listed in said global catalog and to select products in said global catalog that said Internet retailers wish to offer for sale;
means for downloading information concerning selected products to the Internet retailers for display on their electronic storefronts; and
means for receiving orders for products made through the electronic storefronts and conveying said orders to a facility to enable said facility to assemble and ship the products in the orders from the inventory thereby to fulfill the orders.

46. An ETS according to claim 45 wherein products in said global catalog are only accessible to Internet retailers that are permitted to offer the products for sale.

47. An ETS according to claim 46 further including means to allow vendors assign a product visibility designation to each of their products listed in said global catalog, the product visibility designation assigned to a product determining whether Internet retailers can view and/or select that product to offer for sale.

48. An ETS according to claim 47 wherein products selected from said global product catalog by an Internet retailer are added to an Internet retailer product catalog associated with that Internet retailer, said Internet retailer product catalog being downloaded to said Internet retailer.

49. An ETS according to claim 40 further including means for generating a request for the Internet retailer to update their Internet retailer product catalog when a vendor updates information associated with a product listed in the global catalog, that is also listed in an Internet retailer product catalog.

50. An ETS according to claim 49 wherein the means for generating the request specifies a time frame by which said Internet retailer must update their Internet retailer product catalog when critical information associated with said product is updated.

51. An ETS according to claim 46 wherein said means for downloading presents a compliance agreement to Internet retailers prior to downloading said product information, said product information being downloaded upon acceptance of said compliance agreement.

52. An ETS according to claim 51 wherein said compliance agreement includes rules of exchange governing the manner by which Internet retailers are required to sell products of said vendors.
